(19) United States
(12) Patent Application Publication
(10) Pub. No.: US 2024/0188584 A1
(43) Pub. Date: Jun. 13, 2024

(54) FREEZING POINT MODULATION

(71) Applicant: Cambridge Glycoscience Ltd, Cambridge (GB)

(72) Inventors: Thomas J. SIMMONS, Cambridge (GB); Jeremy BARTOSIAK-JENTYS, Chester (GB); Katy SU, Cambridge (GB)

(21) Appl. No.: 18/486,738

(22) Filed: Oct. 13, 2023

Related U.S. Application Data
(63) Continuation of application No. PCT/EP2022/062367, filed on May 6, 2022.
(60) Provisional application No. 63/185,116, filed on May 6, 2021.

(51) Int. Cl. A23G 9/34

(52) U.S. Cl. CPC A23G 9/34

(57) ABSTRACT

Non-colligative freezing point modulator compositions comprising oligosaccharides are provided. Methods for the formation of the compositions, food products, frozen food products, baked goods, or sweeteners, including the enzymatic production of the oligosaccharides, and the uses of the same are also provided.

### CROSS-REFERENCE

This application is a continuation of PCT/EP2022/062367 filed May 6, 2022, which claims the benefit of U.S. Provisional Application No. 63/185,116 filed May 6, 2021, which is incorporated herein by reference.

### REFERENCE TO A SEQUENCE LISTING

The instant application contains a Sequence Listing which has been submitted electronically in XML format and is hereby incorporated by reference in its entirety. Said XML copy, created on Feb. 26, 2024, is named 56406_720_301_SL.xml and is 35,117 bytes in size.

### BACKGROUND

Sugary foods and drinks are an important part of cultural and lifestyle habits across the world, but the sugar they contain has been linked to obesity, diabetes, poor dental health, and disruptive behavior in people. Obesity and diabetes have tripled since the 1970's. In 2016, close to two billion adults were overweight. Over 650 million of these adults were medically obese. Furthermore, about ten percent of world population suffered from diabetes in 2019.

Natural sugar substitutes have emerged as a choice as a sugar replacement in food and beverages. Compared to artificial sweeteners, they do not produce bitter undertones or other unpleasant tastes along with their sweetness, both of which consumers find unappealing. But sugar substitutes may disrupt gut flora, whether they are natural or not.

Methods for manufacturing and formulating ice cream are well known. In general, the methods involve the mixing of ingredients, followed by processing and freezing. Briefly, milk of varying fat proportions and/or hydrated milk powder is combined with cane sugar or derivatives and/or corn syrups, modified food starches, maltodextrins, stabilizing gums, and emulsifiers. Ice cream with high levels of fat also include the addition of cream to the mix. After the ingredients are mixed, the material is pasteurized, homogenized, and chilled. This process material preferably is stored for a period of time ranging from a few hours to 24 hours. After the storage step, a flavoring component is added to the mixture, if desired. If chocolate ice cream is being prepared, cocoa is added in the first mixing step and does not need to be added after the storage. Following the flavoring step, the material is partially frozen, packaged and then completely frozen.

Textural attributes of frozen foods such as ice cream depend on a microcrystalline network of liquid and solid phases. Air bubbles are entrapped in a liquid phase comprising various components such as proteins, fat globules, stabilizers, sugar, soluble and insoluble salts. This complex colloidal system requires the use the stabilizers and emulsifiers to improve the texture by enhancing viscosity and limiting the movement of water molecules. Sugar provides a sweet flavor and improve thickness. Provide herein is a sugar substitute suitable to maintain the textural attributes of frozen foods such as ice cream.

### SUMMARY

In one aspect, described herein are non-colligative freezing point modulator compositions. In some embodiments, the non-colligative freezing point modulator compositions comprise a first oligosaccharide component comprising a cello-oligosaccharide. In some embodiments, the non-colligative freezing point modulator compositions comprise a second oligosaccharide component comprising an oligosaccharide that is not a cello-oligosaccharide. In some embodiments of a non-colligative freezing point modulator, a 20% w/w solution of the non-colligative freezing point modulator in water has a freezing point lower or equal to −3° C. In some embodiments of a non-colligative freezing point modulator, a 20% w/w solution of the non-colligative freezing point modulator in water has a freezing point of lower or equal to −8° C.

In another aspect, described herein are food products (e.g., chilled confections) comprising non-colligative freezing point modulators. In some embodiments, described herein are chilled confections comprising a non-colligative freezing point modulator. In some embodiments, the chilled confection is a frozen whipped cream. In some embodiments, the chilled confection is an ice cream. In some embodiments, the chilled confection has texture that is substantially indistinguishable from a confection wherein the non-colligative freezing point modulator is substituted for sucrose.

In some embodiments of a chilled confection or a non-colligative freezing point modulator, the ratio of the second oligosaccharide to the first oligosaccharide is about 95:5 to 55:45. In some embodiments of a chilled confection or a non-colligative freezing point modulator, the second oligosaccharide is a xylo-oligosaccharide (XOS). In some embodiments of a chilled confection or a non-colligative freezing point modulator, the second oligosaccharide is a fructo-oligosaccharide (FOS). In some embodiments of a chilled confection or a non-colligative freezing point modulator, the second oligosaccharide is a xylo-oligosaccharide and the ratio of xylo-oligosaccharide to cello-oligosaccharide (COS) is about 88:12.

In some embodiments of a chilled confection or a non-colligative freezing point modulator, a 20% w/w solution of the non-colligative freezing point modulator in water has a freezing point lower or equal to −10° C. In some embodiments of a chilled confection or a non-colligative freezing point modulator, a saturated solution of the non-colligative freezing point modulator in water has a freezing point lower or equal to −30° C. In some embodiments of a chilled confection or a non-colligative freezing point modulator, the non-colligative freezing point modulator further comprises an insoluble polysaccharide.

In some embodiments of a chilled confection or a non-colligative freezing point modulator, the non-colligative freezing point modulator further comprises MCC. In some embodiments of a chilled confection or a non-colligative freezing point modulator, the freezing point modulator comprises a mixture of xylo-oligosaccharides, cello-oligosaccharides, and insoluble polysaccharides, in a 75:10:15 xylo-oligosaccharides: cello-oligosaccharides: insoluble polysaccharides ratio. In some embodiments of a chilled confection or a non-colligative freezing point modulator, the insoluble polysaccharides comprise MCC. In some embodiments of a chilled confection or a non-colligative freezing point modulator, the non-colligative freezing point modulator is substantially free of antifreeze proteins.

In some aspects, described herein are methods and compositions that are suitable as a sugar replacement in frozen foods without compromising the textural attributes of the frozen food (e.g., ice cream). Described herein are compositions comprising a mixture of oligosaccharides that surprisingly have improved and tunable properties that make them useful as ingredients in frozen food products (e.g., ice cream). Furthermore, described herein are economical and efficient methods of preparing or manufacturing frozen food products comprising one or more oligosaccharides and one or more polysaccharides. These processes can be used to create different formulations comprising different types and amounts of the one or more oligosaccharides and the one or more polysaccharides to produce the desired properties.

In some aspects, described herein are compositions comprising a first oligosaccharide component, the first oligosaccharide component comprising cello-oligosaccharide(s) having degree(s) of polymerization (DP) of two to six. The composition can be a chilled confection. The composition can comprise a second oligosaccharide component, the second oligosaccharide component comprising second oligosaccharide having degree(s) of polymerization (DP) of two to 12 that is not cello-oligosaccharide. The composition can comprise an aqueous medium. The weight ratio of the cello-oligosaccharide component to other oligosaccharides can be between 1:99 and 50:50. The composition can have a temperature of less than 0° C. (e.g., −3° C.). The composition can have a temperature of less than −2.5° C., −5° C., −7.5° C., −10° C., −12.5° C., −15° C., or −17.5° C. The second oligosaccharide can be selected from the group consisting of (i) xylo-oligosaccharide having a DP of two to 12, (ii) mannan-oligosaccharide having a DP of two to 12, (iii) fructo-oligosaccharide having a DP of two to 12, (iv) galacto-oligosaccharide having a DP of two to 12, (v) malto-oligosaccharide having a DP of two to 12 and (vi) mixed-linkage glucan-oligosaccharide having a DP of two to 12. The second oligosaccharide can be sucrose, lactose and/or maltose. The composition can comprise a third oligosaccharide component, the third oligosaccharide component comprising a third oligosaccharide having a DP of two to 12, the third oligosaccharide not being cello-oligosaccharide and not being the same oligosaccharide as the second oligosaccharide. The weight ratio of the first oligosaccharide to the second oligosaccharide can be 95:5 to 5:95.

The composition can comprise 1% to 80% w/w saccharide. The composition can comprise greater than 1% w/w saccharide, greater than 2% w/w saccharide, greater than 3% w/w saccharide, greater than 4% w/w saccharide, greater than 5% w/w saccharide, greater than 10% w/w saccharide, greater than 15% w/w saccharide, greater than 20% w/w saccharide, greater than 25% w/w saccharide, greater than 30% w/w saccharide, greater than 35% w/w saccharide, greater than 40% w/w saccharide, greater than 45% w/w saccharide, or greater than 50% w/w saccharide, greater than 55% w/w saccharide, greater than 60% w/w saccharide, greater than 65% w/w saccharide, greater than 70% w/w saccharide, greater than 75% w/w saccharide, or greater than 80% w/w saccharide. At least 5% of the saccharide can comprise the cello-oligosaccharide. The composition can further comprise a fat-based medium. The composition can further comprise an emulsified medium. The medium can comprise at least one of cream or milk. The firmness of the chilled confection can be less than the firmness of ice at 0° C. The springiness of the chilled confection can be greater than the springiness of ice at 0° C. The hardness of the chilled confection can be less than the hardness of ice at 0° C.

The weight ratio of the cello-oligosaccharide to the second oligosaccharide can be 5:95 to 45:55, 7.5:92.5 to 40:60, or 10:90 to 35:65. Greater than 30% of the cello-oligosaccharides can comprise cellobiose. Less than 10% of the cello-oligosaccharides can comprise cellotriose. Greater than 0.1% of the cello-oligosaccharides can comprise cellotriose. Less than 10% of the cello-oligosaccharides can comprise cellotetraose. The second oligosaccharide component can comprise xylo-oligosaccharides. Less than 60% of the xylo-oligosaccharides can comprise xylobiose. Less than 50% of the xylo-oligosaccharides can comprise xylotriose. Less than 40% of the xylo-oligosaccharides can comprise xylotetraose. Less than 40% of the xylo-oligosaccharides can comprise substituted xylo-oligosaccharides. The second oligosaccharide component can comprise manno-oligosaccharides. Less than 60% of the manno-oligosaccharides can comprise disaccharides. Less than 50% of the manno-oligosaccharides can comprise trisaccharides. Less than 40% of the manno-oligosaccharides can comprise tetrasaccharides.

The composition can comprise less than 20% monosaccharides. The composition can comprise less than 20% glucose. The composition can comprise less than 60% disaccharides. The weight ratio of cello-oligosaccharides to xylo-oligosaccharides can be between 1:99 and 50:50. The weight ratio of cello-oligosaccharides to manno-oligosaccharides can be between 1:99 and 50:50. The first oligosaccharide component can comprise a mixture of degrees of polymerization. The second oligosaccharide component can comprise a mixture of degrees of polymerization. The composition can be a sweetener. The composition can be at least partially disposed in an aqueous medium. The composition can be at least partially disposed in a fat-based medium. The composition can be at least partially disposed in an emulsified medium. The medium can comprise at least one of cream or milk. The composition can be at least partially disposed in an emulsion.

In some aspects, described herein are methods of making a composition comprising providing a first oligosaccharide component. The first oligosaccharide component can comprise cello-oligosaccharide having a degree of polymerization (DP) of two to six. The composition can comprise a second oligosaccharide component. The second oligosaccharide component can comprise a second oligosaccharide selected from the group consisting of xylo-oligosaccharide having a DP of two to 12 and mannan-oligosaccharide having a DP of two to 12. The method can further comprise combining the composition with an aqueous, fat or emulsified medium to form a mixture. The method can further comprise cooling the mixture to less than 0° C. to form the chilled confection. The medium can comprise at least one of cream or milk. The firmness of the chilled confection can be less than the firmness of ice at 0° C. The springiness of the chilled confection can be greater than the springiness of ice at 0° C. The hardness of the chilled confection can be less than the hardness of ice at 0° C. The chilled confection can be in a liquid or semi-solid phase at 0° C. The method can further comprise disposing the mixture in a container.

In some aspects, described herein are compositions comprising a saccharide component comprising at least one cello-oligosaccharide having a degree of polymerization (DP) of two to six and/or cellulose polysaccharide. The composition can comprise a fat component. The saccharide component can constitute 1% to 50% of the total weight of the composition. The fat component can constitute 1% to 50% of the total weight of the composition. The composition can be between −20° C. and 10° C. The composition can be semi-solid at between −15° C. and 9° C., −10° C. and 8° C., −5° C. and 7° C., −2.5° C. and 6° C.

The composition can further comprise an emulsion. The composition can comprise a dairy source such as cream, butter, or milk. The composition can be an ice cream, a whipped cream, or other dairy-based confectionery. The composition can comprise an oil. The oil can be a plant oil. The composition can be a vegan ice cream, a vegan whipped cream, or other vegan dairy-based confectionery.

A firmness of the chilled confection can be less than the firmness of a thermodynamically favorable crystal phase of solid water at 0° C. The springiness of the composition can be greater than the springiness of a thermodynamically favorable crystal phase of solid water at 0° C. The hardness of the composition can be less than the hardness of a thermodynamically favorable crystal phase of solid water at 0° C. Disclosed herein is a method of making a chilled confection comprising providing a composition comprising cello-oligosaccharide having degrees of polymerization (DP) of two to six and/or cellulose polysaccharide. The method can comprise combining the composition with a fat-containing medium to form a mixture. The method can comprise cooling the mixture to at least −3° C. to form the chilled confection. The method can comprise disposing the mixture in a container. The method can comprise warming, or allowing the composition to warm, to greater than 0° C.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. The patent of application file contains at least one drawing executed in color. Copies of this patent or patent application publication with color drawing(s) will be provided by the Office upon request and payment of the necessary fee. A better understanding of the features and advantages of the present disclosure will be obtained by reference to the following detailed description that sets forth illustrative embodiments, in which the principles of the disclosure are utilized, and the accompanying drawings of which:

FIG. 1A shows the HPAEC-PAD (high performance anion exchange chromatography, pulsed amperometric detection) analysis of xylo-oligosaccharide used in Examples 1-9.

FIG. 1B shows the HPAEC-PAD (high performance anion exchange chromatography, pulsed amperometric detection) analysis of cello-oligosaccharide used in Examples 1-9.

FIG. 2A shows the effect of different ratios and concentrations of cello-oligosaccharide: xylo-oligosaccharide ratios on the freezing point of aqueous compositions.

FIG. 2B shows the effect of different ratios and concentrations of cello-oligosaccharide: xylo-oligosaccharide ratios on the freezing point of aqueous compositions.

FIG. 3A shows an experimental measurement of the rates of melting of frozen whipped cream containing different ratios of xylo-oligosaccharide and cello-oligosaccharide.

FIG. 3B shows a comparison of the rates of melting of frozen whipped cream containing different ratios of xylo-oligosaccharide and cello-oligosaccharide.

FIG. 4A shows a comparison of the hardness and texture of dairy ice cream samples made with xylo-oligosaccharide, cello-oligosaccharide, a saccharide mixture (75:10:15 mix of xylo-oligosaccharide to cello-oligosaccharide to MCC), and sucrose.

FIG. 4B illustrates the samples tested in FIG. 4A.

FIG. 5A shows the effect of different ratios and concentrations of xylo-oligosaccharide: cello-oligosaccharide ratios on the freezing point of aqueous compositions.

FIG. 5B illustrates the samples tested in FIG. 5A.

FIG. 6 shows the HPAEC-PAD analysis of a further xylo-oligosaccharide and cello-oligosaccharide composition which was also analyzed for impact on freezing point modulation of aqueous compositions.

FIG. 7 shows the HPAEC-PAD analysis of fructo-oligosaccharide (FOS) used in Example 8.

FIG. 8A shows example results of a freezing point depression study for various compositions and concentrations of modulator compositions described herein.

FIG. 8B shows example results of a freezing point depression study for various compositions and concentrations of modulator compositions described herein.

FIG. 8C shows example results of a freezing point depression study for various compositions and concentrations of modulator compositions described herein.

FIG. 8D shows example results of a freezing point depression study for various compositions and concentrations of modulator compositions described herein.

FIG. 8E shows example results of a freezing point depression study for various compositions and concentrations of modulator compositions described herein.

FIG. 8F shows example results of a freezing point depression study for various compositions and concentrations of modulator compositions described herein.

FIG. 9A shows texture analysis results for an example chilled confection (a plant oil based ice cream) comprising a non-colligative freezing point modulator described herein.

FIG. 9B illustrates the samples tested in FIG. 9A.

FIG. 9C illustrates an apparatus used in testing the samples of FIG. 9B.

### DETAILED DESCRIPTION

Described herein are saccharide compositions that can be useful to modulate a freezing point of foodstuff, cosmetic, or nutraceutical products. Some embodiments of the present disclosure additionally offer such foodstuff, cosmetic, or nutraceutical products with novel properties. The saccharide compositions may be consumable compositions including cello-oligosaccharides, xylo-oligosaccharides, mixed-linkage glucan oligosaccharides, manno-oligosaccharides, fructo-oligosaccharides and/or xyloglucan oligosaccharides. Such consumable compositions may be used as sweeteners (e.g., in a foodstuff), binders, and/or fiber content enhancers.

As used herein, “food” and “foodstuff” refer to any item destined for consumption, which may be consumption by a human or by any other animal. It may be food, feed, a beverage, or an ingredient to be used in the production of any of the above.

As used herein, “nutraceutical” refers to any composition introduced into a human or other animal, whether by ingestion, injection, absorption, or any other method, for the purpose of providing nutrition to the human or other animal. Use of such a nutraceutical may take the form of a drink with added dietary fiber, a prebiotic additive, a pill or other capsule, or any other suitable use.

As used herein, “lignocellulose” refers to polysaccharide-comprising aggregates that are, or are derived from, plant cell wall material. For example, they may comprise lignin and/or one or more of the following polysaccharides associated together: cellulose, xylan, mannan, and mixed-linkage glucan.

As used herein “highly branched,” “lightly branched,” and “unbranched” refer to the number of side-chains per stretch of main chain in a saccharide. Highly branched saccharides have on average from 4 to 10 side-chains per 10 main-chain residues, slightly branched saccharides have on average from 1 to 3 side-chains per 10 main-chain residues, and unbranched saccharides have only one main-chain and no side-chains. The average is calculated by dividing the number of side chains in a saccharide by the number of main-chain residues.

As used herein, “saccharide” refers to any polysaccharide and/or oligosaccharide, such as monosaccharide and/or disaccharide.

As used herein, “oligosaccharide” refers to saccharide polymers having chain lengths less than or equal to about 20 saccharide residues. Oligosaccharides may be highly branched, lightly branched, or unbranched, may comprise glycosidic bonds in any combination, any number of a or β linkages, and any combination of monomer types, such as glucose, glucosamine, mannose, xylose, galactose, fucose, fructose, glucuronic acid, arabinose, or derivatives thereof. Suitable derivatives include the above monomers comprising acetyl or other groups.

As used herein, “monosaccharide” and “disaccharide” refer to saccharide compounds consisting respectively of one or two residues. Monosaccharides are compounds such as glucose, glucosamine, xylose, galactose, fucose, fructose, glucuronic acid, arabinose, galacturonic acid; or epimers or other derivatives thereof. Suitable derivatives include acetyl or other groups. Disaccharides are compounds consisting of two monosaccharides joined via any glycosidic bond.

As used herein, “cello-oligosaccharides” refers to oligosaccharides composed of one or more glucose residues linked by β-1,4-glycosidic bonds, and may be chemically related to that by oxidation, reduction, esterification, epimerization, or another chemical modification.

As used herein, “xylo-oligosaccharides” refers to oligosaccharides composed primarily of xylose residues (typically linked by β-1,4-glycosidic bonds) and may also contain glucuronic acid residues and/or arabinose residues and/or acetyl groups and/or any other modification, and may be chemically related to that by oxidation, reduction, esterification, epimerization, or another chemical modification.

As used herein, “mixed-linkage glucan-oligosaccharides” refers to oligosaccharides composed of one or more glucose residues linked by at least one β-1,3-glycosidic bond and at least one β-1,4-glycosidic bond, and may be chemically related to that by oxidation, reduction, esterification, epimerization, or another chemical modification.

As used herein, “manno-oligosaccharides” refers to oligosaccharides composed of one or more mannose residues and optionally containing one or more glucose and/or galactose residues, and may be chemically related to that by oxidation, reduction, esterification, epimerization, or another chemical modification.

As used herein, “chito-oligosaccharides” refers to oligosaccharides composed of one or more glucosamine and/or N-acetyl-glucosamine residues, and may be chemically related to that by oxidation, reduction, esterification, epimerization, or another chemical modification.

As used herein, “fructo-oligosaccharides” (FOS) generally refer to oligosaccharides composed of one or more fructose residues, and may be chemically related to that by oxidation, reduction, esterification, epimerization, or another chemical modification.

As used herein, “cellulose” refers to polysaccharides composed of glucose residues linked by β-1,4-glycosidic bonds, and derivatives thereof. “Xylan” refers to polysaccharides composed of a backbone of xylose residues and may also contain glucuronic acid residues and/or arabinose residues and/or acetyl groups and/or any other modification. “Mixed-linkage glucan” refers to polysaccharides composed of glucose residues linked by β-1,3-glycosidic bonds and β-1,4-glycosidic bonds. “Mannan” refers to polysaccharides composed of greater than 40% mannose residues and optionally containing glucose and/or galactose residues. “Chitin” or “chitosan” refer to polysaccharides composed of glucosamine and/or N-acetyl-glucosamine residues.

As used herein, “non-colligative” refers to a physical property whose behavior with respect to concentration of compound or mixture is dependent on the identity of compound or mixture. Non-colligative is contrasted with colligative properties which are typical of freezing point modulators. Specifically, colligative properties depend only on the ratio of the number of solute particles to the number of solvent particles in a solution (molar concentrations, molal concentration, normal concentrations, etc.), not on the identity of the compound or mixture to which the concentration refers.

The term “about” as used herein can mean within 1 or more than 1 standard deviation. Alternatively, “about” can mean a range of up to 10%, up to 5%, or up to 1% of a given value. For example, about can mean up to +10%, +9%, +8%, +7%, +6%, +5%, +4%, +3%, +2%, or +1% of a given value.

As used in the specification and claims, the singular forms “a,” “an,” and “the” include plural references unless the context clearly dictates otherwise. For example, the term “a sample” includes a plurality of samples, including mixtures thereof.

### Compositions

The polysaccharide components of the composition may comprise one or more of any type of polysaccharide. Preferably they comprise cellulose, xylan, mannan or derivatives of any of the aforementioned polysaccharides.

The composition may comprise various oligosaccharides, and at varying amounts, depending on the desired properties. Suitably, the composition may comprise at least 20% by dry weight, preferably at least 30% by dry weight, cello-oligosaccharides having a degree of polymerization of from two to six and/or the composition may comprise at least 20% by dry weight, preferably at least 30% by dry weight, xylo-oligosaccharides having a degree of polymerization of from two to twelve and/or the composition may comprise at least 20% by dry weight, preferably at least 30% by dry weight, mixed-linkage glucan oligosaccharides having a degree of polymerization of from two to five, and/or the composition may comprise at least 20% by dry weight, preferably at least 30% by dry weight, manno-oligosaccharides having a degree of polymerization of from two to twelve, and/or the composition may comprise at least 20% by dry weight, preferably at least 30% by dry weight, fructo-oligosaccharides having a degree of polymerization of from two to twelve, and/or the composition may comprise at least 20% by dry weight, preferably at least 30% by dry weight, xyloglucan oligosaccharides having a degree of polymerization of from four to twelve, and/or the composition may comprise at least 20% by dry weight, preferably at least 30% by dry weight, chito-oligosaccharides having a degree of polymerization of from two to twelve. The skilled person will understand that the composition can comprise a maximum of 100% by dry weight of the above oligosaccharides, therefore the above embodiment, wherein the oligosaccharides are present in at least 20% by dry weight, does not comprise all seven types of oligosaccharides.

In another aspect, provided herein is the use of an oligosaccharide mixture in the formation of a foodstuff, cosmetic, or nutraceutical, wherein the oligosaccharide mixture comprises two oligosaccharides selected from the list consisting of:
i) cello-oligosaccharides having a degree of polymerization of from two to six;
ii) xylo-oligosaccharides having a degree of polymerization of from two to twelve;
iii) manno-oligosaccharides having a degree of polymerization from two to twelve.
wherein two oligosaccharides may be present in a ratio of from 99:1 to 50:50, preferably 99:1 to 70:30, more preferably from 95:5 to 85:15, in relation to each other. The cello-oligosaccharides can have a mixture of degrees of polymerization. The xylo-oligosaccharides can have a mixture of degrees of polymerization. The manno-oligosaccharides can have a mixture of degrees of polymerization.

The cello-oligosaccharide can comprise greater than 10%, 20%, 30%, 40%, or 50% cellobiose. The cello-oligosaccharide can comprise less than 50%, 40%, 30%, 20%, or 10% cellobiose. The cello-oligosaccharide can comprise less than 10%, less than 9%, less than 8%, less than 7%, less than 6%, less than 5%, less than 4%, less than 3%, less than 2%, less than 1%, less than 0.5%, or less than 0.1% cellotriose. The cello-oligosaccharide can comprise greater than 0.1%, 0.5%, 1%, 2%, 3%, 4%, 5%, 6%, 7%, 8%, 9%, or 10% cellotriose. The cello-oligosaccharide can comprise less than 10%, less than 9%, less than 8%, less than 7%, less than 6%, less than 5%, less than 4%, less than 3%, or less than 1% cellotetraose.

The manno-oligosaccharide can comprise less than 60%, 50%, 40%, 30%, 20%, or 10% disaccharides. The manno-oligosaccharide can comprise less than 50%, 40%, 30%, 20%, or 10% trisaccharides. The manno-oligosaccharide can comprise less than 40%, 30%, 20%, or 10% tetrasaccharides.

The xylo-oligosaccharide can comprise greater than 10%, 20%, 30%, 40%, or 50% xylobiose. The xylo-oligosaccharide can comprise less than 60%, 50%, 40%, 30%, 20%, or 10% xylobiose. The xylo-oligosaccharide can comprise less than 50%, 40%, 30%, 20%, or 10% xylotriose. The xylo-oligosaccharide can comprise less than 40%, 30%, 20%, or 10% xylotetraose.

The amounts of each of the oligosaccharides may be varied depending on the desired properties of the resulting foodstuff, cosmetic, or nutraceutical. Two oligosaccharide components (e.g., cello-oligosaccharide component: xylo-oligosaccharide component or cello-oligosaccharide component: manno-oligosaccharide component or cello-oligosaccharide component: fructo-oligosaccharide component) may be present in a ratio of 1:99 to 70:30, preferably 5:95 to 50:50, more preferably from 10:90 to 45:55, in relation to each other. The two oligosaccharide components (e.g., cello-oligosaccharide component: xylo-oligosaccharide component or cello-oligosaccharide component: manno-oligosaccharide component or cello-oligosaccharide component: fructo-oligosaccharide component) may be present in a ratio of 5:95 to 35:65, 7.5:92.5 to 37.5:62.5, or 10:90 to 40:60. Each oligosaccharide component can comprise a mixture of degrees of polymerization of an oligosaccharide.

A cello-oligosaccharide component can consist essentially of a mixture cello-oligosaccharides with varying degrees of polymerization from two to six. A xylo-oligosaccharide component can consist essentially of a mixture of xylo-oligosaccharide components with varying degrees of polymerization from two to twelve. A manno-oligosaccharide component can consist essentially of a mixture of manno-oligosaccharides with varying degrees of polymerization from two to twelve. A fructo-oligosaccharide component can consist essentially of a mixture of fructo-oligosaccharides with varying degrees of polymerization from two to twelve. Consists essentially of means less than 10%, less than 9%, less than 8%, less than 7%, less than 6%, less than 5% less than 4%, less than 3%, less than 2%, or less than 1% impurity. An impurity can be an oligosaccharide with degrees of polymerization greater than twelve for a manno-oligosaccharide component or a xylo-oligosaccharide component or a fructo-oligosaccharide component. An impurity can be an oligosaccharide with degrees of polymerization greater than six for a cello-oligosaccharide component.

The oligosaccharide mixture may further comprise a third oligosaccharide and a fourth oligosaccharide. The oligosaccharide mixture may comprise a third oligosaccharide, a fourth oligosaccharide, and a fifth oligosaccharide. The oligosaccharide mixture may further comprise a third oligosaccharide, a fourth oligosaccharide, a fifth oligosaccharide, and a sixth oligosaccharide. These oligosaccharides may be selected from the same list as the at least two oligosaccharides as provided above.

Preferred oligosaccharide mixtures of the at least two oligosaccharides may comprise the cello-oligosaccharides, for instance, cello-oligosaccharides in combination with the xylo-oligosaccharides. An alternative preferable composition may comprise cello-oligosaccharides in combination with manno-oligosaccharides. An alternative preferable composition may comprise cello-oligosaccharides in combination with fructo-oligosaccharides.

Optionally, the oligosaccharide mixtures of the at least two oligosaccharides may additionally include a polysaccharide, preferably a cellulosic polysaccharide, such as cellulose, or a polysaccharide derivative, preferably a cellulose derivative, such as carboxymethylcellulose, or a polysaccharide aggregate, preferably a portion of lignocellulosic biomass. Suitably, the ratio in the combination may be from 1:100 to 1:1 polysaccharide/polysaccharide derivative/polysaccharide aggregate: oligosaccharide, preferably from 1:90 to 1:2, preferably from 1:80 to 1:3, preferably from 1:70 to 1:4, and preferably from 1:60 to 1:5. In some embodiments, the ratio in the combination between the polysaccharide and either the first or second oligosaccharide may independently be from 1:100 to 1:1 polysaccharide/polysaccharide derivative/polysaccharide aggregate: oligosaccharide, preferably from 1:90 to 1:2, preferably from 1:80 to 1:3, preferably from 1:70 to 1:4, and preferably from 1:60 to 1:5. As such, the ratio between the first oligosaccharide, the second oligosaccharide, and the polysaccharide may be from 2:2:1 to 30:30:1, preferably about 3:3:1. In some embodiments, the ratio between the first oligosaccharide, the second oligosaccharide, and the polysaccharide may be about 7.5:1:1.5.

### Use of Compositions to Modulate the Freezing Point of a Mixture

In certain embodiments, compositions of this disclosure may be used as non-colligative freezing point modulators. In some embodiments, modulator compositions may comprise oligosaccharides. In some embodiments, modulator compositions may comprise any of the oligosaccharide compositions described herein.

In some embodiments, the non-colligative freezing point modulator composition can be characterized by measuring the freezing point depression of a solution of the modulator composition dissolved in water. In some embodiments, the concentration of the solution that is measured is 10, 20, 40, 60, 70, 80, or 90 weight % of the composition with respect to the water or is a saturated solution. In some embodiments, the freezing point of the measured solution is −1, −2, −3, −4, −5, −6, −7, −8, −9, −10, −15, or −20° C.

In some embodiments, the composition may be used to modulate the freezing point of a product such as a food product (e.g., chilled confection), cosmetic, nutraceutical, etc. A frozen product as used herein can be a product which is solidified under freezing conditions to a hard pack or a soft, semi-fluid consistency. The frozen food products (e.g., chilled confections) include, for example ice cream, sherbet-like variations, sorbet, gelato, granita, ice lollies, or variations of ice cream having non-dairy base components such as rice, soy, coconut or combinations of non-dairy and dairy base components.

A chilled confection can be a food product with a hard pack or a soft semi-fluid consistency at 0° C. The food product can be ice cream, whipped cream, a filling suitable for a baked good, a flavored ice dessert (e.g., sorbet or ice lollie), or a candy.

The composition may have a ratio of cello-oligosaccharide to xylo-oligosaccharide of 1:99 to 70:30, preferably 5:95 to 50:50, more preferably from 10:90 to 45:55, in relation to each other. The two oligosaccharides may be present in a ratio of cello-oligosaccharide to xylo-oligosaccharide from 5:95 to 45:55, 7.5:92.5 to 40:60, or 10:90 to 35:65.

The product can have a melting point at a temperature of less than about −2.5° C., −5° C., −7.5° ° C., −10° C., −12.5° C., −15° C., or −17.5° C. The product can have a melting point at a temperature between −2.5° C. to −17.5° C., for example −2.5° C. to −7.5° C., −5° C. to −10° C., −7.5° C. to −12.5° C., −10° ° C. to −15° C., −12.5° ° C. to −17.5° C., or −15° ° C. to −17.5° C. The composition can be used to reduce a freezing point of a water-based solution by greater than about 1° C., 2° C., 5° ° C., 10° C., 15° C., 20° C., 30° C., or 40° C.

The composition can be at least partially disposed in a base component at a concentration of 1.0 g/mL to 3.0 g/mL (e.g., 52 grams per 25 milliliters, or 2.08 g/mL). The composition can be at least partially disposed in a base component at a concentration greater than about 1.0 g/mL, 1.1 g/mL, 1.2 g/mL, 1.3 g/mL, 1.4 g/mL, 1.5 g/mL, 1.6 g/mL, 1.7 g/mL, 1.8 g/mL, 1.9 g/mL, 2.0 g/mL, 2.1 g/mL, 2.2 g/mL, 2.3 g/mL, 2.4 g/mL, 2.5 g/mL, 2.6 g/mL, 2.7 g/mL, 2.8 g/mL, 2.9 g/mL, or 3.0 g/mL. The composition can be at least partially disposed in a base component at a concentration less than about 3.0 g/mL, 2.9 g/mL, 2.8 g/mL, 2.7 g/mL, 2.6 g/mL, 2.5 g/mL, 2.4 g/mL, 2.3 g/mL, 2.2 g/mL, 2.1 g/mL, 2.0 g/mL, 1.9 g/mL, 1.8 g/mL, 1.7 g/mL, 1.6 g/mL, 1.5 g/mL, 1.4 g/mL, 1.3 g/mL, 1.2 g/mL, 1.1 g/mL, or 1.0 g/mL.

In some embodiments, the composition can be at least partially disposed in a base component at a concentration of about 5 mg/mL to about 900 mg/mL. In some embodiments, the composition can be at least partially disposed in a base component at a concentration of about 5 mg/mL to about 10 mg/mL, about 5 mg/mL to about 50 mg/mL, about 5 mg/mL to about 100 mg/mL, about 5 mg/mL to about 200 mg/mL, about 5 mg/mL to about 300 mg/mL, about 5 mg/mL to about 400 mg/mL, about 5 mg/mL to about 500 mg/mL, about 5 mg/mL to about 600 mg/mL, about 5 mg/mL to about 700 mg/mL, about 5 mg/mL to about 800 mg/mL, about 5 mg/mL to about 900 mg/mL, about 10 mg/mL to about 50 mg/mL, about 10 mg/mL to about 100 mg/mL, about 10 mg/mL to about 200 mg/mL, about 10 mg/mL to about 300 mg/mL, about 10 mg/mL to about 400 mg/mL, about 10 mg/mL to about 500 mg/mL, about 10 mg/mL to about 600 mg/mL, about 10 mg/mL to about 700 mg/mL, about 10 mg/mL to about 800 mg/mL, about 10 mg/mL to about 900 mg/mL, about 50 mg/mL to about 100 mg/mL, about 50 mg/mL to about 200 mg/mL, about 50 mg/mL to about 300 mg/mL, about 50 mg/mL to about 400 mg/mL, about 50 mg/mL to about 500 mg/mL, about 50 mg/mL to about 600 mg/mL, about 50 mg/mL to about 700 mg/mL, about 50 mg/mL to about 800 mg/mL, about 50 mg/mL to about 900 mg/mL, about 100 mg/mL to about 200 mg/mL, about 100 mg/mL to about 300 mg/mL, about 100 mg/mL to about 400 mg/mL, about 100 mg/mL to about 500 mg/mL, about 100 mg/mL to about 600 mg/mL, about 100 mg/mL to about 700 mg/mL, about 100 mg/mL to about 800 mg/mL, about 100 mg/mL to about 900 mg/mL, about 200 mg/mL to about 300 mg/mL, about 200 mg/mL to about 400 mg/mL, about 200 mg/mL to about 500 mg/mL, about 200 mg/mL to about 600 mg/mL, about 200 mg/mL to about 700 mg/mL, about 200 mg/mL to about 800 mg/mL, about 200 mg/mL to about 900 mg/mL, about 300 mg/mL to about 400 mg/mL, about 300 mg/mL to about 500 mg/mL, about 300 mg/mL to about 600 mg/mL, about 300 mg/mL to about 700 mg/mL, about 300 mg/mL to about 800 mg/mL, about 300 mg/mL to about 900 mg/mL, about 400 mg/mL to about 500 mg/mL, about 400 mg/mL to about 600 mg/mL, about 400 mg/mL to about 700 mg/mL, about 400 mg/mL to about 800 mg/mL, about 400 mg/mL to about 900 mg/mL, about 500 mg/mL to about 600 mg/mL, about 500 mg/mL to about 700 mg/mL, about 500 mg/mL to about 800 mg/mL, about 500 mg/mL to about 900 mg/mL, about 600 mg/mL to about 700 mg/mL, about 600 mg/mL to about 800 mg/mL, about 600 mg/mL to about 900 mg/mL, about 700 mg/mL to about 800 mg/mL, about 700 mg/mL to about 900 mg/mL, or about 800 mg/mL to about 900 mg/mL. In some embodiments, the composition can be at least partially disposed in a base component at a concentration of about 5 mg/mL, about 10 mg/mL, about 50 mg/mL, about 100 mg/mL, about 200 mg/mL, about 300 mg/mL, about 400 mg/mL, about 500 mg/mL, about 600 mg/mL, about 700 mg/mL, about 800 mg/mL, or about 900 mg/mL. In some embodiments, the composition can be at least partially disposed in a base component at a concentration of at least about 5 mg/mL, about 10 mg/mL, about 50 mg/mL, about 100 mg/mL, about 200 mg/mL, about 300 mg/mL, about 400 mg/mL, about 500 mg/mL, about 600 mg/mL, about 700 mg/mL, or about 800 mg/mL. In some embodiments, the composition can be at least partially disposed in a base component at a concentration of at most about 10 mg/mL, about 50 mg/mL, about 100 mg/mL, about 200 mg/mL, about 300 mg/mL, about 400 mg/mL, about 500 mg/mL, about 600 mg/mL, about 700 mg/mL, about 800 mg/mL, or about 900 mg/mL.

The base can comprise a fat component. The fat component of the mixture can comprise greater that 1%, greater than 5%, greater than 10%, greater than 15%, greater than 20%, greater than 25%, greater than 30%, greater than 35%, greater than 40%, greater than 45%, greater than 50%, greater than 55%, or greater than 60% of the total weight of the composition. The fat component of the mixture can comprise less than 60%, less than 55%, less than 50%, less than 45%, less than 40%, less than 35%, less than 30%, less than 25%, less than 20%, less than 15%, less than 10%, less than 5%, or less than 1% of the mixture. The fat component can be an oil. The oil can be a plant oil. The plant oil can be coconut oil, palm oil, nut oil (e.g., pistachio, walnut, peanut, cashew, almond, hazelnut oil, pine seed oil etc.), avocado oil, corn oil, canola oil, cottonseed oil, grapeseed oil, pumpkin seed oil, safflower oil, sesame oil, soy oil, sunflower oil, vegetable oil, etc. The fat component can be provided by the base.

The base component may be dairy, non-dairy, vegan and combinations thereof. Dairy based components include, but are not limited to, cream, whole milk, concentrated whole milk, evaporated whole milk, sweetened condensed whole milk, superheated condensed whole milk, dried whole milk, skim milk, concentrated skim milk, evaporated skim milk, condensed skim milk, superheated condensed skim milk, sweetened condensed skim milk, sweetened condensed part skim milk, non-fat dry milk, sweet cream buttermilk, condensed sweet cream buttermilk, dried sweet cream buttermilk, concentrated skim milk from which a portion of the lactose has been removed, casein, modified casein, modified whey, whey protein concentrate, caseinate, and dehydrated milk, whey protein isolates, hydrolyzed milk protein, denatured milk proteins. Non-dairy based components include, but are not limited to legume, seed, and nut derived protein and lipid sources such as soy milk, concentrated liquid soymilk, soymilk powder, soy concentrate, soy isolate, rice milk, rice protein concentrate, oats, almonds, sesame, sunflower, cashews, taro, and lupine. The base component of a frozen food product may be composed of a single dairy or non-dairy base component or a combination of two or more of these components. The base component can be an emulsion.

The method can comprise mixing a base component with the composition (e.g., the sweeteners). The method can comprise whipping the mixture at speeds suitable to entrap air bubbles to produce a smooth semi-solid texture, for example, suitable for use as a whipped cream. The method can comprise mixing a base component with the sweeteners, an acidulant, and optionally emulsifiers, and stabilizers in a mixing tank. The mixture can be an emulsion. The mixture can be pasteurized, homogenized, chilled, and optionally stored with gentle agitation under refrigeration for several hours to a day in a holding tank(s). The entire mixture or a portion of it may then be moved into a flavor vat or tank where optionally a flavor is mixed in. The flavored mixture is checked for taste and color properties and then partially frozen and put into containers or made into confections (e.g., lollies, etc.).

An acidulant as used herein is an acidifying agent that is safe for consumption. Acidulants include, but are not limited to, citric acid, malic acid, adipic acid, phosphoric acid, tartaric acid, ascorbic acid, lactic acid, and lemon juice concentrate.

The frozen food product may include other optional ingredients typically present in conventional frozen desserts such as stabilizers e.g., stabilizing gums, water-binding gums, gelling agents, and insoluble blocking agents. Stabilizers produce a smoothness in the textural properties of the product, retard or reduce ice crystal growth during storage of the product, provide uniformity in the product and resistance to melting. Stabilizers typically function through their ability to form gel structures in the water or their ability to combine with the water by hydration. Stabilizers include but are not limited to sodium alginate, propylene glycol alginate, calcium sulphate, gelatin, gum acacia, guar gum, gum karaya, locust bean gum, gum tragacanth, carrageenan, and salts thereof, xanthan gum, microcrystalline cellulose, cellulose ethers such as methyl cellulose, hydroxypropyl cellulose, hydroxypropylmethyl cellulose, carboxymethyl cellulose and its sodium salt, as well as mixtures of these stabilizers. Preferred stabilizers are carrageenan, xanthan gum, locust bean gum, guar gum, and mixtures thereof. Water-binding gums include, but are not limited to, locust bean gum, guar gum, propylene glycol alginate, tara gum, sodium carboxymethyl cellulose, and other cellulose ethers. Gelling agents include, but are not limited to, gelatin, xanthan gum, carrageenan, sodium alginate, and pectin. The amount of stabilizer included in the frozen dessert is typically in an amount of up to about 1% in a non-fat product and about 0.1-0.5% for other ice cream mixes. In some embodiments the level of stabilizer may exceed 1% by weight.

Emulsifiers are added to improve the dispersal of fat, control agglomeration of fat globules after homogenization, aid in the inclusion of air during freezing, increase resistance to melting and impart dryness to the extruded product. Emulsifiers include, but are not limited to, mono- and diglycerides, distilled mono-glycerides and drying agents such as polysorbate 80, polysorbate 65, and ethoxylated mono- and diglycerides. Emulsifiers are generally present in an amount between 0.05% and 0.2% by weight of the total product. Lecithin is also known to be an effective emulsifier. Lecithin is a phospholipid complex commercially extracted from soybeans and other plant sources. Egg yolk solids, another optional ingredient of the frozen dessert, provide large amounts of lecithin. Custard type ice creams and French Vanilla ice creams have a unique smoothness attributed to the presence of lecithin in the added egg yolk solids. Egg yolk solids may be obtained from, for example, liquid egg yolks, frozen egg yolks, dried egg yolks, liquid whole eggs, frozen whole eggs, sugared frozen egg yolks, salted frozen egg yolks, dried whole eggs, or combinations of the foregoing egg yolk substances.

Preservatives may also be added to extend product shelf life. Preservatives include, but are not limited to, potassium sorbate, sodium sorbate, potassium benzoate, sodium benzoate, and calcium disodium EDTA.

Once the components are mixed in the mixing tank, the mixture can be subjected to pasteurization and homogenization. When the pasteurizer is of the batch type, homogenization follows immediately afterwards. In a continuous flow system, homogenization may be required to occur prior to pasteurization. Homogenization generally occurs in a two-stage homogenizer with a pressure of about 2500-3000 psi in the first stage and a pressure of about 500 psi in the second stage for ice creams with 8% fat or less. As the fat content increases the first stage pressure typically decreases, the second stage pressure usually remains around 500 psi. The homogenized mix is then pasteurized according to FDA thermal processing requirements. Pasteurization is a process in which the mix is heated to a temperature of approximately 175° F. to about 185° F. for 25 seconds to about 30 seconds in a high temperature-short time (HTST) system. Batch pasteurization heats the mix to a lower temperature, approximately 150° F., and a longer time, 30 minutes. Other systems such as higher-heat-short time (HHST) have a shorter processing time and higher processing temperature.

Viscosity of the mixture may be a major determination in specifying pasteurization parameters. A mixture may be so viscous as to cause the flow within the pasteurizer to be affected, less turbulent. This may require extending the tube length of the pasteurizer and/or decreasing the pumping rate or increasing the processing temperature. Also, because of the lack of turbulence within the heating tube, the quality of the mix nearest the wall of the holding tube may be compromised in quality due to the extended heat time. Hence a processor may incur increased processing costs, reduced plant capacity and possibly additional equipment. The composition may allow a formulator to add more solids to a mixture (e.g., an ice cream mix, whipped cream mix, ice cream like mixture, etc.).

After pasteurization and homogenization, the mixture is cooled to about 40° F. or less and stored in a holding tank at that temperature for anywhere between several hours and a day.

After the storage, either part or all of the mixture is transferred to a flavor tank where flavoring is added. As used herein a flavoring agent refers to compounds which impart a flavor or flavors, referred to as flavorings, coloring agents, spices, nuts, candy, cookie crumbs, cookie dough, whole or comminuted food pieces, purees, extracts, concentrates and essences, and can be derived from natural and/or synthetically produced sources. Flavorings can be in the form of flavored extracts, volatile oils, chocolate flavorings, caramel flavorings, peanut butter flavoring, vanilla, or any commercially available flavoring such as strawberry, raspberry, cherry, lemon-lime, cranberry, and blueberry flavorings. Other examples of useful flavorings include but are not limited to pure anise extract, imitation banana extract, imitation cherry extract, chocolate extract, pure lemon extract, pure orange extract, pure peppermint extract, imitation pineapple extract, imitation rum extract, imitation strawberry extract, or pure vanilla extract; or volatile oils, such as balm oil, bay oil, bergamot oil, cedarwood oil, cherry oil, cinnamon oil, clove oil, or peppermint oil; peanut butter, chocolate flavoring, butterscotch or toffee.

The flavoring agents can be fruit or non-fruit flavoring agents and may be natural or synthetic. Examples of suitable natural flavorings include citrus and non-citrus fruit flavors (e.g., whole or comminuted fresh fruit, fruit purees, fruit concentrates, extracts or essences, candied or glazed fruits, and dried fruits), sugar-free versions of such fruit flavorings, flavors derived from botanicals, spices, chocolate, cocoa or chocolate liquor, coffee, natural flavorings obtained from vanilla beans, nuts, including nutmeats and nut extracts from pecans, walnuts, almonds, pistachios, filberts, coconuts and peanuts. Other sources of natural flavorings include liqueur flavorings such as rum, whiskey and other distilled beverages, fruit brandy distillate and brandy flavor essence, and fruit liqueurs. Examples of non-natural or synthetically derived flavorings include aromatic chemicals and imitation flavors. The particular amount of flavoring substance included in the frozen dessert products of the present invention will depend upon the flavor effects desired and the particular flavoring substance used. The flavoring substance can comprise from about 0.5% to about 20% by weight of the product. In some instances, the flavoring substance may comprise less than about 0.5% by weight of the product.

After addition of the flavoring agent, the material is frozen and transferred to containers. The freezing process may be accomplished using any type of standard ice cream freezer equipment. For instance, the mixture may be agitated and extruded at about 20 to 25° F. For example, the homogenized pasteurized mixture of the present invention can be partially frozen or solidified by using a batch freezer, continuous freezer, low temperature continuous freezer, a soft serve-type freezer, or a counter-type freezer. The particular temperature and time conditions for carrying out this partial freezing step can vary greatly depending upon the type of freezer used. For example, the homogenized pasteurized mixtures of the present invention can be partially frozen at temperatures in the typical range of from about 18° F. to about 23° F. over a period of from about 24 seconds (e.g., continuous or low temperature continuous freezer) to about 10 minutes (e.g., batch or counter freezer). During partial freezing, it is often desirable to agitate, aerate and/or whip the mixture to incorporate air to provide the desired amount of overrun and finished product texture. The particular amount of overrun obtained can be any level appropriate for conventional frozen dessert products, in particular ice cream products. However, the incorporation of air compromises the added nutritional value. Some embodiments of the invention utilize an overrun of approximately 200%. Some embodiments of the invention utilize an overrun of approximately 180%. Some embodiments of the invention utilize an overrun of approximately 160%. Some embodiments of the invention utilize an overrun of approximately 140%. Some embodiments of the invention utilize an overrun of approximately 120%. Some embodiments of the invention utilize an overrun of approximately 100%. Some embodiments of the invention utilize an overrun of approximately 80%. Some embodiments of the invention utilize an overrun of approximately 60%. Some embodiments of the invention utilize an overrun of approximately 20%. Preferred embodiments of the invention utilize an overrun of approximately 40%. The resulting weight of a 4 fl oz serving is subsequently and approximately 96 grams.

The extruded material is preferably in a semi-solid state for incorporation into containers or depending upon the application into novelties such as bars, sandwiches, or push-ups. Once in the container or particular novelty format, the frozen dessert may be held in a freezer, e.g., at about −30° F., for about 1 to 2 hours. The above are examples of homogenization, pasteurization, and freezing processes. These methods may be accomplished by any equivalent method for making ice cream known in the art.

### Combinations of Oligosaccharides

A composition may comprise a mixture of one or more oligosaccharides. A mixture of oligosaccharides may comprise two forms of oligosaccharides, for instance, cello-oligosaccharides and xylo-oligosaccharides. A mixture of oligosaccharides may comprise three forms of oligosaccharides, for instance, cello-oligosaccharides, fructo-oligosaccharides and xylo-oligosaccharides. A mixture of oligosaccharides may comprise three forms of oligosaccharides, for instance, cello-oligosaccharides, fructo-oligosaccharides, and xylo-oligosaccharides. A mixture of oligosaccharides may comprise four forms of oligosaccharides, for instance, cello-oligosaccharides, manno-oligosaccharides, mixed-linkage glucan oligosaccharides, and xylo-oligosaccharides. A mixture of oligosaccharides may comprise five forms of oligosaccharides, for instance, cello-oligosaccharides, manno-oligosaccharides, mixed-linkage glucan oligosaccharides, fructo-oligosaccharides, and xylo-oligosaccharides.

An oligosaccharide mixture may comprise two forms of oligosaccharides, for example, a first oligosaccharide and a second oligosaccharide. An oligosaccharide mixture may comprise about 5% of a first oligosaccharide and about 95% of a second oligosaccharide w/w. An oligosaccharide mixture may comprise about 10% of a first oligosaccharide and about 90% of a second oligosaccharide w/w. An oligosaccharide mixture may comprise about 15% of a first oligosaccharide and about 85% of a second oligosaccharide w/w. An oligosaccharide mixture may comprise about 20% of a first oligosaccharide and about 80% of a second oligosaccharide w/w. An oligosaccharide mixture may comprise about 25% of a first oligosaccharide and about 75% of a second oligosaccharide w/w. An oligosaccharide mixture may comprise about 30% of a first oligosaccharide and about 70% of a second oligosaccharide w/w. An oligosaccharide mixture may comprise about 35% of a first oligosaccharide and about 65% of a second oligosaccharide w/w. An oligosaccharide mixture may comprise about 40% of a first oligosaccharide and about 50% of a second oligosaccharide w/w. An oligosaccharide mixture may comprise 45% of a first oligosaccharide and 55% of a second oligosaccharide w/w. An oligosaccharide mixture may comprise 50% of a first oligosaccharide and 50% of a second oligosaccharide w/w. An oligosaccharide mixture may comprise 55% of a first oligosaccharide and 45% of a second oligosaccharide w/w. An oligosaccharide mixture may comprise 60% of a first oligosaccharide and 30% of a second oligosaccharide w/w. An oligosaccharide mixture may comprise 65% of a first oligosaccharide and 35% of a second oligosaccharide w/w. An oligosaccharide mixture may comprise 70% of a first oligosaccharide and 30% of a second oligosaccharide w/w. An oligosaccharide mixture may comprise 75% of a first oligosaccharide and 25% of a second oligosaccharide w/w. An oligosaccharide mixture may comprise 80% of a first oligosaccharide and 20% of a second oligosaccharide w/w. An oligosaccharide mixture may comprise 85% of a first oligosaccharide and 15% of a second oligosaccharide w/w. An oligosaccharide mixture may comprise 90% of a first oligosaccharide and 10% of a second oligosaccharide w/w. An oligosaccharide mixture may comprise 95% of a first oligosaccharide and 5% of a second oligosaccharide w/w. In some examples, a first oligosaccharide may be cello-oligosaccharides and a second oligosaccharide may be xylo-oligosaccharides. In some examples, a first oligosaccharide may be cello-oligosaccharides and a second oligosaccharide may be manno-oligosaccharides. In some examples, a first oligosaccharide may be xylo-oligosaccharides and a second oligosaccharide may be manno-oligosaccharides. Other combinations of a first oligosaccharide and a second oligosaccharide are also within the scope of this disclosure.

An oligosaccharide mixture may comprise three forms of oligosaccharides, for example a first oligosaccharide, a second oligosaccharide, and a third oligosaccharide. An oligosaccharide mixture may comprise about 20% of a first oligosaccharide, 40% of a second oligosaccharide, and 40% of a third oligosaccharide w/w. An oligosaccharide mixture may comprise about 30% of a first oligosaccharide, 30% of a second oligosaccharide, and 40% of a third oligosaccharide w/w. An oligosaccharide mixture may comprise about 10% of a first oligosaccharide, 10% of a second oligosaccharide, and 80% of a third oligosaccharide w/w. An oligosaccharide mixture may comprise about 20% of a first oligosaccharide, 20% of a second oligosaccharide, and 60% of a third oligosaccharide w/w. An oligosaccharide mixture may comprise about 20% of a first oligosaccharide, 30% of a second oligosaccharide, and 50% of a third oligosaccharide w/w. In some examples, a first oligosaccharide may be manno-oligosaccharides, a second oligosaccharide may be xylo-oligosaccharides, and a third oligosaccharide may be cello-oligosaccharides. In some examples, a first oligosaccharide may be xyloglucan-oligosaccharides, a second oligosaccharide may be xylo-oligosaccharides, and a third oligosaccharide may be cello-oligosaccharides. Other combinations of a first oligosaccharide, a second oligosaccharide, and a third oligosaccharide are also within the scope of this disclosure.

An oligosaccharide mixture may comprise two or more oligosaccharides, a first oligosaccharide and a second oligosaccharide which is different than the first oligosaccharide. For instance, the first oligosaccharide may be a xylo-oligosaccharide or a cello-oligosaccharide or a manno-oligosaccharide or other oligosaccharides as provided herein whereas the second oligosaccharide can be a xylo-oligosaccharide or a cello-oligosaccharide or a manno-oligosaccharide or other oligosaccharides not used as the first oligosaccharides. The ratio of a first oligosaccharide to a second oligosaccharide in the mixture may be about 99:1. The ratio of a first oligosaccharide to a second oligosaccharide in the mixture may be about 95:5. The ratio of a first oligosaccharide to a second oligosaccharide in the mixture may be about 90:10. The ratio of a first oligosaccharide to a second oligosaccharide in the mixture may be about 85:15. The ratio of a first oligosaccharide to a second oligosaccharide in the mixture may be about 80:20. The ratio of a first oligosaccharide to a second oligosaccharide in the mixture may be about 75:25.

The oligosaccharides may be cello-oligosaccharides, manno-oligosaccharides, xylo-oligosaccharides, xyloglucan-oligosaccharides, mixed-linkage oligosaccharides, chito-oligosaccharides, fructo-oligosaccharides, or other oligosaccharides as provided herein wherein the first oligosaccharide is selected to be a different oligosaccharide than the second oligosaccharide.

Oligosaccharide Compositions with Varying Degrees of Polymerization

The concentration of xylo-oligosaccharides with a degree of polymerization of two in a xylo-oligosaccharide mixture may be about 2% to about 80% w/w. The concentration of xylo-oligosaccharides with a degree of polymerization of two may be at least 2%, 4%, 6%, 8%, 10%, 12%, 15%, 18%, 20%, 25%, or 30% w/w. The concentration of xylo-oligosaccharides with a degree of polymerization of two may be higher in some cases, for instance, up to 35%, 40%, 45%, 50%, 55%, 60%, 65%, 70%, 75%, or 80% w/w.

The concentration of xylo-oligosaccharides with a degree of polymerization of three in a xylo-oligosaccharide mixture may be about 2% to about 20% w/w. The concentration of xylo-oligosaccharides with a degree of polymerization of three may be at least 2%, 4%, 6%, 8%, 10%, 12%, 15%, 18%, or 20% w/w.

The concentration of xylo-oligosaccharides with a degree of polymerization of four in a xylo-oligosaccharide mixture may be about 5% to about 20% w/w. The concentration of xylo-oligosaccharides with a degree of polymerization of four may be at least 5%, 8%, 10%, 12%, 15%, 18%, or 20% w/w.

The concentration of xylo-oligosaccharides with a degree of polymerization of five in a xylo-oligosaccharide mixture may be about 5% to about 20% w/w. The concentration of xylo-oligosaccharides with a degree of polymerization of five may be at least 5%, 7%, 8%, 10%, 12%, 15%, 18%, or 20% w/w.

The concentration of xylo-oligosaccharides with a degree of polymerization of six in a xylo-oligosaccharide mixture may be about 5% to about 20% w/w. The concentration of xylo-oligosaccharides with a degree of polymerization of six may be at least 5%, 8%, 10%, 12%, 15%, 18%, or 20% w/w.

The concentration of xylo-oligosaccharides with a degree of polymerization of seven in a xylo-oligosaccharide mixture may be about 2% to about 20% w/w. The concentration of xylo-oligosaccharides with a degree of polymerization of seven may be at least 2%, 4%, 6%, 8%, 10%, 12%, 15%, 17%, or 20% w/w.

The concentration of xylo-oligosaccharides with a degree of polymerization of eight in a xylo-oligosaccharide mixture may be about 1% to about 15% w/w. The concentration of xylo-oligosaccharides with a degree of polymerization of eight may be at least 1%, 2%, 3%, 4%, 5%, 6%, 7%, 8%, 9%, 10%, or 15% w/w.

The concentration of xylo-oligosaccharides with a degree of polymerization of nine in a xylo-oligosaccharide mixture may be about 2% to about 15% w/w. The concentration of xylo-oligosaccharides with a degree of polymerization of nine may be at least 1%, 2%, 3%, 4%, 5%, 6%, 7%, 8%, 9%, 10%, or 15% w/w.

The concentration of xylo-oligosaccharides with a degree of polymerization of ten in a xylo-oligosaccharide mixture may be about 2% to about 15% w/w. The concentration of xylo-oligosaccharides with a degree of polymerization of ten may be at least 1%, 2%, 3%, 4%, 5%, 6%, 7%, 8%, 9%, 10%, or 15% w/w.

The concentration of xylo-oligosaccharides with a degree of polymerization of eleven in a xylo-oligosaccharide mixture may be about 2% to about 15% w/w. The concentration of xylo-oligosaccharides with a degree of polymerization of eleven may be at least 1%, 2%, 3%, 4%, 5%, 6%, 7%, 8%, 9%, 10%, or 15% w/w.

The concentration of xylo-oligosaccharides with a degree of polymerization of twelve in a xylo-oligosaccharide mixture may be about 2% to about 15% w/w. The concentration of xylo-oligosaccharides with a degree of polymerization of twelve may be at least 1%, 2%, 3%, 4%, 5%, 6%, 7%, 8%, 9%, 10%, or 15% w/w.

The concentration of cello-oligosaccharides with a degree of polymerization of two in a cello-oligosaccharide mixture may be about 2% to about 80% w/w. The concentration of cello-oligosaccharides with a degree of polymerization of two may be at least 2%, 4%, 6%, 8%, 10%, 12%, 15%, 18%, 20%, 25%, or 30% w/w. The concentration of cello-oligosaccharides with a degree of polymerization of two may be higher in some cases, for instance, at least 35%, 40%, 45%, 50%, 55%, 60%, 65%, 70%, 75%, or 80% w/w.

The concentration of cello-oligosaccharides with a degree of polymerization of three in a cello-oligosaccharide mixture may be about 2% to about 20% w/w. The concentration of cello-oligosaccharides with a degree of polymerization of three may be at least 2%, 4%, 6%, 8%, 10%, 12%, 15%, 18%, or 20% w/w.

The concentration of cello-oligosaccharides with a degree of polymerization of four in a cello-oligosaccharide mixture may be about 5% to about 20% w/w. The concentration of cello-oligosaccharides with a degree of polymerization of four may be at least 5%, 8%, 10%, 12%, 15%, 18%, or 20% w/w.

The concentration of cello-oligosaccharides with a degree of polymerization of five in a cello-oligosaccharide mixture may be about 5% to about 20% w/w. The concentration of cello-oligosaccharides with a degree of polymerization of five may be at least 5%, 7%, 8%, 10%, 12%, 15%, 18%, or 20% w/w.

The concentration of cello-oligosaccharides with a degree of polymerization of six in a cello-oligosaccharide mixture may be about 5% to about 20% w/w. The concentration of cello-oligosaccharides with a degree of polymerization of six may be at least 5%, 8%, 10%, 12%, 15%, 18%, or 20% w/w.

The concentration of manno-oligosaccharides with a degree of polymerization of two in a manno-oligosaccharide mixture may be about 2% to about 30% w/w. The concentration of manno-oligosaccharides with a degree of polymerization of two may be at least 2%, 4%, 6%, 8%, 10%, 12%, 15%, 18%, 20%, 25%, or 30% w/w.

The concentration of manno-oligosaccharides with a degree of polymerization of three in a manno-oligosaccharide mixture may be about 2% to about 20% w/w. The concentration of manno-oligosaccharides with a degree of polymerization of three may be at least 2%, 4%, 6%, 8%, 10%, 12%, 15%, 18%, or 20% w/w.

The concentration of manno-oligosaccharides with a degree of polymerization of four in a manno-oligosaccharide mixture may be about 5% to about 20% w/w. The concentration of manno-oligosaccharides with a degree of polymerization of four may be at least 5%, 8%, 10%, 12%, 15%, 18%, or 20% w/w.

The concentration of manno-oligosaccharides with a degree of polymerization of five in a manno-oligosaccharide mixture may be about 5% to about 20% w/w. The concentration of manno-oligosaccharides with a degree of polymerization of five may be at least 5%, 7%, 8%, 10%, 12%, 15%, 18%, or 20% w/w.

The concentration of manno-oligosaccharides with a degree of polymerization of six in a manno-oligosaccharide mixture may be about 5% to about 20% w/w. The concentration of manno-oligosaccharides with a degree of polymerization of six may be at least 5%, 8%, 10%, 12%, 15%, 18%, or 20% w/w.

The concentration of manno-oligosaccharides with a degree of polymerization of seven in a manno-oligosaccharide mixture may be about 2% to about 20% w/w. The concentration of manno-oligosaccharides with a degree of polymerization of seven may be at least 2%, 4%, 6%, 8%, 10%, 12%, 15%, 17%, or 20% w/w.

The concentration of manno-oligosaccharides with a degree of polymerization of eight in a manno-oligosaccharide mixture may be about 1% to about 15% w/w. The concentration of manno-oligosaccharides with a degree of polymerization of eight may be at least 1%, 2%, 3%, 4%, 5%, 6%, 7%, 8%, 9%, 10%, or 15% w/w.

The concentration of manno-oligosaccharides with a degree of polymerization of nine in a manno-oligosaccharide mixture may be about 2% to about 15% w/w. The concentration of manno-oligosaccharides with a degree of polymerization of nine may be at least 1%, 2%, 3%, 4%, 5%, 6%, 7%, 8%, 9%, 10%, or 15% w/w.

The concentration of manno-oligosaccharides with a degree of polymerization of ten in a manno-oligosaccharide mixture may be about 2% to about 15% w/w. The concentration of manno-oligosaccharides with a degree of polymerization of ten may be at least 1%, 2%, 3%, 4%, 5%, 6%, 7%, 8%, 9%, 10%, or 15% w/w.

The concentration of manno-oligosaccharides with a degree of polymerization of eleven in a manno-oligosaccharide mixture may be about 2% to about 15% w/w. The concentration of manno-oligosaccharides with a degree of polymerization of eleven may be at least 1%, 2%, 3%, 4%, 5%, 6%, 7%, 8%, 9%, 10%, or 15% w/w.

The concentration of manno-oligosaccharides with a degree of polymerization of twelve in a manno-oligosaccharide mixture may be about 2% to about 15% w/w. The concentration of manno-oligosaccharides with a degree of polymerization of twelve may be at least 1%, 2%, 3%, 4%, 5%, 6%, 7%, 8%, 9%, 10%, or 15% w/w.

The concentration of fructo-oligosaccharides with a degree of polymerization of two in a fructo-oligosaccharide mixture may be about 2% to about 30% w/w. The concentration of fructo-oligosaccharides with a degree of polymerization of two may be at least 2%, 4%, 6%, 8%, 10%, 12%, 15%, 18%, 20%, 25%, or 30% w/w.

The concentration of fructo-oligosaccharides with a degree of polymerization of three in a fructo-oligosaccharide mixture may be about 2% to about 20% w/w. The concentration of fructo-oligosaccharides with a degree of polymerization of three may be at least 2%, 4%, 6%, 8%, 10%, 12%, 15%, 18%, or 20% w/w.

The concentration of fructo-oligosaccharides with a degree of polymerization of four in a fructo-oligosaccharide mixture may be about 5% to about 20% w/w. The concentration of fructo-oligosaccharides with a degree of polymerization of four may be at least 5%, 8%, 10%, 12%, 15%, 18%, or 20% w/w.

The concentration of fructo-oligosaccharides with a degree of polymerization of five in a fructo-oligosaccharide mixture may be about 5% to about 20% w/w. The concentration of fructo-oligosaccharide with a degree of polymerization of five may be at least 5%, 7%, 8%, 10%, 12%, 15%, 18%, or 20% w/w.

The concentration of fructo-oligosaccharides with a degree of polymerization of six in a fructo-oligosaccharide mixture may be about 5% to about 20% w/w. The concentration of fructo-oligosaccharides with a degree of polymerization of six may be at least 5%, 8%, 10%, 12%, 15%, 18%, or 20% w/w.

The concentration of fructo-oligosaccharides with a degree of polymerization of seven in a fructo-oligosaccharide mixture may be about 2% to about 20% w/w. The concentration of fructo-oligosaccharides with a degree of polymerization of seven may be at least 2%, 4%, 6%, 8%, 10%, 12%, 15%, 17%, or 20% w/w.

The concentration of fructo-oligosaccharides with a degree of polymerization of eight in a fructo-oligosaccharide mixture may be about 1% to about 15% w/w. The concentration of fructo-oligosaccharides with a degree of polymerization of eight may be at least 1%, 2%, 3%, 4%, 5%, 6%, 7%, 8%, 9%, 10%, or 15% w/w.

The concentration of fructo-oligosaccharides with a degree of polymerization of nine in a fructo-oligosaccharide mixture may be about 2% to about 15% w/w. The concentration of fructo-oligosaccharides with a degree of polymerization of nine may be at least 1%, 2%, 3%, 4%, 5%, 6%, 7%, 8%, 9%, 10%, or 15% w/w.

The concentration of fructo-oligosaccharides with a degree of polymerization of ten in a fructo-oligosaccharide mixture may be about 2% to about 15% w/w. The concentration of fructo-oligosaccharide a degree of polymerization of ten may be at least 1%, 2%, 3%, 4%, 5%, 6%, 7%, 8%, 9%, 10%, or 15% w/w.

The concentration of fructo-oligosaccharides with a degree of polymerization of eleven in a fructo-oligosaccharide mixture may be about 2% to about 15% w/w. The concentration of fructo-oligosaccharides with a degree of polymerization of eleven may be at least 1%, 2%, 3%, 4%, 5%, 6%, 7%, 8%, 9%, 10%, or 15% w/w.

The concentration of fructo-oligosaccharides with a degree of polymerization of twelve in a fructo-oligosaccharide mixture may be about 2% to about 15% w/w. The concentration of fructo-oligosaccharides with a degree of polymerization of twelve may be at least 1%, 2%, 3%, 4%, 5%, 6%, 7%, 8%, 9%, 10%, or 15% w/w.

The concentration of xyloglucan-oligosaccharides with a degree of polymerization of four in a xyloglucan-oligosaccharide mixture may be about 5% to about 20% w/w. The concentration of xyloglucan-oligosaccharides with a degree of polymerization of four may be at least 5%, 8%, 10%, 12%, 15%, 18%, or 20% w/w.

The concentration of xyloglucan-oligosaccharides with a degree of polymerization of five in a xyloglucan-oligosaccharide mixture may be about 5% to about 20% w/w. The concentration of xyloglucan-oligosaccharides with a degree of polymerization of five may be at least 5%, 7%, 8%, 10%, 12%, 15%, 18%, or 20% w/w.

The concentration of xyloglucan-oligosaccharides with a degree of polymerization of six in a xyloglucan-oligosaccharide mixture may be about 5% to about 20% w/w. The concentration of xyloglucan-oligosaccharides with a degree of polymerization of six may be at least 5%, 8%, 10%, 12%, 15%, 18%, or 20% w/w.

The concentration of xyloglucan-oligosaccharides with a degree of polymerization of seven in a xyloglucan-oligosaccharide mixture may be about 2% to about 20% w/w. The concentration of xyloglucan-oligosaccharides with a degree of polymerization of seven may be at least 2%, 4%, 6%, 8%, 10%, 12%, 15%, 17%, or 20% w/w.

The concentration of xyloglucan-oligosaccharides with a degree of polymerization of eight in a xyloglucan-oligosaccharide mixture may be about 1% to about 15% w/w. The concentration of xyloglucan-oligosaccharides with a degree of polymerization of eight may be at least 1%, 2%, 3%, 4%, 5%, 6%, 7%, 8%, 9%, 10%, or 15% w/w.

The concentration of xyloglucan-oligosaccharides with a degree of polymerization of nine in a xyloglucan-oligosaccharide mixture may be about 2% to about 15% w/w. The concentration of xyloglucan-oligosaccharides with a degree of polymerization of nine may be at least 1%, 2%, 3%, 4%, 5%, 6%, 7%, 8%, 9%, 10%, or 15% w/w.

The concentration of xyloglucan-oligosaccharides with a degree of polymerization of ten in a xyloglucan-oligosaccharide mixture may be about 2% to about 15% w/w. The concentration of xyloglucan-oligosaccharides with a degree of polymerization of ten may be at least 1%, 2%, 3%, 4%, 5%, 6%, 7%, 8%, 9%, 10%, or 15% w/w.

Compositions with Combinations of Polysaccharides and Oligosaccharides

A composition may comprise a combination of polysaccharides and oligosaccharides. The source of the polysaccharides in such compositions may contain cellulose, such as plant biomass, for example the undigested component of partially digested plant biomass, such as the partially digested plant biomass from the same reaction as that which produced the oligosaccharides. The polysaccharides in the undigested biomass may comprise lignin, polyphenol, cellulose, lignocellulose, or any other suitable polysaccharides as described herein. Addition of polysaccharides to oligosaccharide mixtures can be done to improve the gastrointestinal tolerance of the oligosaccharide mixtures. Oligosaccharide consumption can cause gastrointestinal distress, including diarrhea, discomfort, and bloating. The compositions described herein may have an improved gastrointestinal tolerance such as, less or no discomfort, bloating, diarrhea, or gastrointestinal distress as compared to a saccharide composition available commercially or a saccharide composition comprising primarily monosaccharides and/or disaccharides.

The concentration of partially digested biomass in a composition may be 1% to 50% w/w. The concentration of partially digested biomass in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of partially digested biomass in a composition may be 1%, 5%, 10%, 15%, 20%, 25%, 30%, 35%, 40%, 45%, or 50% w/w. The concentration of partially digested biomass in a composition may be at least 1%, 5%, 10%, 15%, 20%, 25%, 30%, 35%, 40%, or 45% w/w. The concentration of partially digested biomass in a composition may be at most 5%, 10%, 15%, 20%, 25%, 30%, 35%, 40%, 45%, or 50% w/w.

The concentration of xylo-oligosaccharides in a composition may be 1% to 50% w/w. The concentration of xylo-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of xylo-oligosaccharides in a composition may be 1%, 5%, 10%, 15%, 20%, 25%, 30%, 35%, 40%, 45%, or 50% w/w. The concentration of xylo-oligosaccharides in a composition may be at least 1%, 5%, 10%, 15%, 20%, 25%, 30%, 35%, 40%, or 45% w/w. The concentration of xylo-oligosaccharides in a composition may be at most 5%, 10%, 15%, 20%, 25%, 30%, 35%, 40%, 45%, or 50% w/w.

The concentration of cello-oligosaccharides in a composition may be 1% to 50% w/w. The concentration of cello-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of cello-oligosaccharides in a composition may be 1%, 5%, 10%, 15%, 20%, 25%, 30%, 35%, 40%, 45%, or 50% w/w. The concentration of cello-oligosaccharides in a composition may be at least 1%, 5%, 10%, 15%, 20%, 25%, 30%, 35%, 40%, or 45% w/w. The concentration of cello-oligosaccharides in a composition may be at most 5%, 10%, 15%, 20%, 25%, 30%, 35%, 40%, 45%, or 50% w/w.

The concentration of manno-oligosaccharides in a composition may be 1% to 50% w/w. The concentration of manno-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of manno-oligosaccharides in a composition may be 1%, 5%, 10%, 15%, 20%, 25%, 30%, 35%, 40%, 45%, or 50% w/w. The concentration of manno-oligosaccharides in a composition may be at least 1%, 5%, 10%, 15%, 20%, 25%, 30%, 35%, 40%, or 45% w/w. The concentration of manno-oligosaccharides in a composition may be at most 5%, 10%, 15%, 20%, 25%, 30%, 35%, 40%, 45%, or 50% w/w.

The concentration of chito-oligosaccharides in a composition may be 1% to 50% w/w. The concentration of chito-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of chito-oligosaccharides in a composition may be 1%, 5%, 10%, 15%, 20%, 25%, 30%, 35%, 40%, 45%, or 50% w/w. The concentration of chito-oligosaccharides in a composition may be at least 1%, 5%, 10%, 15%, 20%, 25%, 30%, 35%, 40%, or 45% w/w. The concentration of chito-oligosaccharides in a composition may be at most 5%, 10%, 15%, 20%, 25%, 30%, 35%, 40%, 45%, or 50% w/w.

The concentration of xyloglucan-oligosaccharides in a composition may be 1% to 50% w/w. The concentration of xyloglucan-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of xyloglucan-oligosaccharides in a composition may be 1%, 5%, 10%, 15%, 20%, 25%, 30%, 35%, 40%, 45%, or 50% w/w. The concentration of xyloglucan-oligosaccharides in a composition may be at least 1%, 5%, 10%, 15%, 20%, 25%, 30%, 35%, 40%, or 45% w/w. The concentration of xyloglucan-oligosaccharides in a composition may be at most 5%, 10%, 15%, 20%, 25%, 30%, 35%, 40%, 45%, or 50% w/w.

The concentration of mixed-linkage glucan-oligosaccharides in a composition may be 1% to 50% w/w. The concentration of mixed-linkage glucan-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of mixed-linkage glucan-oligosaccharides in a composition may be 1%, 5%, 10%, 15%, 20%, 25%, 30%, 35%, 40%, 45%, or 50% w/w. The concentration of mixed-linkage glucan-oligosaccharides in a composition may be at least 1%, 5%, 10%, 15%, 20%, 25%, 30%, 35%, 40%, or 45% w/w. The concentration of mixed-linkage glucan-oligosaccharides in a composition may be at most 5%, 10%, 15%, 20%, 25%, 30%, 35%, 40%, 45%, or 50% w/w.

The concentration of fructo-oligosaccharides in a composition may be 1% to 50% w/w. The concentration of fructo-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of fructo-oligosaccharides in a composition may be 1%, 5%, 10%, 15%, 20%, 25%, 30%, 35%, 40%, 45%, or 50% w/w. The concentration of fructo-oligosaccharides in a composition may be at least 1%, 5%, 10%, 15%, 20%, 25%, 30%, 35%, 40%, or 45% w/w. The concentration of fructo-oligosaccharides in a composition may be at most 5%, 10%, 15%, 20%, 25%, 30%, 35%, 40%, 45%, or 50% w/w.

### Use of Compositions as Ingredients

In some embodiments, the composition is an ingredient. As used herein, “ingredient” is any composition suitable for incorporation into a foodstuff, cosmetic, or nutraceutical product, which may include those which are used directly as the product itself.

In some embodiments, the ingredient comprises at least 50%, 60%, 70%, 80%, 90%, 95%, 99%, 99.5% by dry weight of saccharide present. The ingredient may consist essentially of saccharides. As used herein, “consist essentially of” means that the material (for instance the ingredient) has less than 0.5% by dry weight, such as 0.3% by dry weight, for instance 0.1% by dry weight, of other substances.

The ingredient may comprise an oligosaccharide mixture as described elsewhere herein. The ingredient may comprise at least two of the oligosaccharides. For instance, it may comprise three of the oligosaccharides. It may comprise four oligosaccharides. It may comprise five oligosaccharides. It may comprise six oligosaccharides.

In some embodiments, the ingredient comprises cello-oligosaccharides, for instance cello-oligosaccharides in combination with the xylo-oligosaccharides. An alternative ingredient may comprise cello-oligosaccharides in combination with manno-oligosaccharides. An alternative ingredient may comprise cello-oligosaccharides in combination with fructo-oligosaccharides.

Ingredients may be used to prepare finished products. The ingredient may also be treated in some physical or chemical way before or during incorporation into a foodstuff, cosmetic, or nutraceutical. It may be directly incorporated into a product, or it may be incorporated into, for example, a dough, cake mixture, chocolate mixture, or other foodstuff precursor; a cosmetic base composition; or a nutraceutical, and be optionally cooked or otherwise treated in a way which may cause chemical modification, a change of texture a change of color, or other modification.

A foodstuff, cosmetic, or nutraceutical may be produced from an ingredient described herein. For example, in the food industry the saccharide formulations produced by the current method may be used as sweeteners, bulking agents, added dietary fiber, or humectants. The ingredient may be used as a sugar substitute. The ingredient may be incorporated into ice cream, sorbet, or drinks, for example, to provide favorable taste, color, or textural characteristics or to increase dietary fiber content.

Compositions or ingredients as described herein may be used to alter one or more properties of the finished product. Such properties include, but are not limited to, sweetness, texture, mouthfeel, binding, glazing, smoothness, moistness, viscosity, color, hygroscopicity, flavor, bulking, water-retention, caramelization, surface texture, crystallization, structural properties, and dissolution.

In some cases, the compositions and/or ingredients described herein may provide a property to a finished product which is comparable to or better than the same property as provided by a saccharide mixture comprising primarily monosaccharides and/or disaccharides. The control composition may be a saccharide used commonly in consumables, for instance, a monosaccharide composition such as glucose, fructose, etc, a disaccharide composition such as sucrose or an artificial sugar composition. The term “comparable” as used herein may mean that the two compositions may be up to 100%, up to 95%, up to 90%, up to 80% identical. For instance, comparable can mean that the composition is up to 90% identical to the control composition.

In some cases, the compositions described herein may be used as sweetener compositions. Sweetener compositions may be used by themselves or as an ingredient in a finished product. The compositions described herein may provide about the same level of sweetness or greater sweetness than an identical amount of a control composition wherein the control composition comprises primarily monosaccharides and/or disaccharides. The compositions described herein may be used to replace the control composition as the sweetener in a finished product. In some cases, the sweetness of a composition may be 5%, 10%, 15%, 20%, 30%, 40%, 50%, 70%, 80%, 90% or 100% more than an identical amount of the control composition.

The compositions described herein may provide a comparable flavor profile or better flavor profile than an identical amount of a control composition wherein the control composition comprises primarily monosaccharides and/or disaccharides. The compositions described herein may be used to replace the control composition as a flavor enhancer in a finished product. In some cases, the flavor of a composition may be 5%, 10%, 15%, 20%, 30%, 40%, 50%, 70%, 80%, 90% or 100% more than an identical amount of the control composition.

The compositions described herein may provide a comparable texture profile or better texture profile than an identical amount of a control composition wherein the control composition comprises primarily monosaccharides and/or disaccharides. The compositions described herein may be used to replace the control composition as a texture enhancer in a finished product.

The compositions described herein may provide a comparable binding profile or better binding profile than an identical amount of a control composition wherein the control composition comprises primarily monosaccharides and/or disaccharides. The compositions described herein may be used to replace the control composition as a binding enhancer in a finished product.

The compositions described herein may provide a comparable glazing profile or better glazing profile than an identical amount of a control composition wherein the control composition comprises primarily monosaccharides and/or disaccharides. The compositions described herein may be used to replace the control composition as a glazing enhancer in a finished product.

The compositions described herein may provide a comparable moistness or better moistness than an identical amount of a control composition wherein the control composition comprises primarily monosaccharides and/or disaccharides. The compositions described herein may be used to replace the control composition to provide moistness in a finished product.

The compositions described herein may provide a comparable color profile or better color profile than an identical amount of a control composition wherein the control composition comprises primarily monosaccharides and/or disaccharides. The compositions described herein may be used to replace the control composition as a color enhancer in a finished product.

The compositions described herein may provide a comparable dissolution profile or better dissolution profile than an identical amount of a control composition wherein the control composition comprises primarily monosaccharides and/or disaccharides. The compositions described herein may be used to replace the control composition as a dissolution enhancer in a finished product. In some cases, the dissolution of a composition may be 5%, 10%, 15%, 20%, 30%, 40%, 50%, 70%, 80%, 90% or 100% more than an identical amount of the control composition.

The compositions described herein may provide a comparable mouthfeel or better mouthfeel than an identical amount of a control composition wherein the control composition comprises primarily monosaccharides and/or disaccharides.

The compositions described herein may provide a comparable viscosity or better viscosity than an identical amount of a control composition wherein the control composition comprises primarily monosaccharides and/or disaccharides.

The compositions described herein may provide a comparable hygroscopicity or better hygroscopicity than an identical amount of a control composition wherein the control composition comprises primarily monosaccharides and/or disaccharides. In some cases, the hygroscopicity of a composition may be 5%, 10%, 15%, 20%, 30%, 40%, 50%, 70%, 80%, 90% or 100% more than an identical amount of the control composition.

The compositions described herein may provide a comparable water-retention or better water-retention than an identical amount of a control composition wherein the control composition comprises primarily monosaccharides and/or disaccharides. In some cases, the water-retention of a composition may be 5%, 10%, 15%, 20%, 30%, 40%, 50%, 70%, 80%, 90% or 100% more than an identical amount of the control composition.

The compositions described herein may provide a lower calorie composition than an identical amount of a control composition wherein the control composition comprises primarily monosaccharides and/or disaccharides. In some cases, the calorie count of a composition may be 5%, 10%, 15%, 20%, 30%, 40%, 50%, 70%, 80%, 90% or 100% less than an identical amount of the control composition.

The compositions described herein may provide a lower glycemic index than an identical amount of a control composition wherein the control composition comprises primarily monosaccharides and/or disaccharides. In some cases, the glycemic index of a composition may be 5%, 10%, 15%, 20%, 30%, 40%, 50%, 70%, 80%, 90% or 100% less than an identical amount of the control composition.

The compositions described herein may provide a comparable freezing point modulation or better freezing point modulation than an identical amount of a control composition wherein the control composition comprises primarily monosaccharides and/or disaccharides.

The compositions described herein may provide a comparable bulking or better bulking than an identical amount of a control composition wherein the control composition comprises primarily monosaccharides and/or disaccharides.

The compositions described herein may provide a comparable caramelization or better caramelization than an identical amount of a control composition wherein the control composition comprises primarily monosaccharides and/or disaccharides.

The compositions described herein may provide a comparable surface texture or better surface texture than an identical amount of a control composition wherein the control composition comprises primarily monosaccharides and/or disaccharides.

The compositions described herein may provide a comparable crystallization or better crystallization than an identical amount of a control composition wherein the control composition comprises primarily monosaccharides and/or disaccharides.

The compositions described herein may provide comparable structural properties as an identical amount of a control composition wherein the control composition comprises primarily monosaccharides and/or disaccharides.

The compositions described herein may provide less aftertaste compared to an identical amount of a control composition wherein the control composition comprises primarily monosaccharides and/or disaccharides.

Different compositions of oligosaccharides may have improved dissolution profiles, hygroscopicity profiles, and taste profiles compared to the oligosaccharides used alone.

Ingredients may be used to alter the properties of a finished product such as foodstuff or nutraceutical or cosmetic. In order to alter the properties of the finished products, the finished products may additionally comprise a polysaccharide, preferably a cellulosic polysaccharide, such as cellulose, or a polysaccharide derivative, preferably a cellulose derivative, such as carboxymethylcellulose, or a polysaccharide aggregate, preferably a portion of lignocellulosic biomass. Suitably, the finished products can comprise from greater than 0% to 40% by dry weight of polysaccharide, polysaccharide derivative, or polysaccharide aggregate, preferably from greater than 1% to 30% by dry weight of polysaccharide, polysaccharide derivative, or polysaccharide aggregate, preferably from greater than 5% to 25% by dry weight of polysaccharide, polysaccharide derivative, or polysaccharide aggregate, preferably from greater than 10% to 20% by dry weight of polysaccharide, polysaccharide derivative, or polysaccharide aggregate.

The concentration of a composition comprising polysaccharides and a mixture of oligosaccharides in a finished product may be anywhere from 0.1% to 40% w/w. The concentration of a composition comprising polysaccharides and a mixture of oligosaccharides in a finished product may be about 0.1% to about 0.5%, about 0.1% to about 1%, about 0.1% to about 5%, about 0.1% to about 10%, about 0.1% to about 15%, about 0.1% to about 20%, about 0.1% to about 25%, about 0.1% to about 30%, about 0.1% to about 35%, about 0.1% to about 40%, about 0.5% to about 1%, about 0.5% to about 5%, about 0.5% to about 10%, about 0.5% to about 15%, about 0.5% to about 20%, about 0.5% to about 25%, about 0.5% to about 30%, about 0.5% to about 35%, about 0.5% to about 40%, about 1% to about 5%, about 1% to about 10%, about 1% to about 15%, about 1% to about 20%, about 1% to about 25%, about 1% to about 30%, about 1% to about 35%, about 1% to about 40%, about 5% to about 10%, about 5% to about 15%, about 5% to about 20%, about 5% to about 25%, about 5% to about 30%, about 5% to about 35%, about 5% to about 40%, about 10% to about 15%, about 10% to about 20%, about 10% to about 25%, about 10% to about 30%, about 10% to about 35%, about 10% to about 40%, about 15% to about 20%, about 15% to about 25%, about 15% to about 30%, about 15% to about 35%, about 15% to about 40%, about 20% to about 25%, about 20% to about 30%, about 20% to about 35%, about 20% to about 40%, about 25% to about 30%, about 25% to about 35%, about 25% to about 40%, about 30% to about 35%, about 30% to about 40%, or about 35% to about 40% w/w. The concentration of a composition comprising polysaccharides and a mixture of oligosaccharides in a finished product may be about 0.1%, about 0.5%, about 1%, about 5%, about 10%, about 15%, about 20%, about 25%, about 30%, about 35%, or about 40% w/w. The concentration of a composition comprising polysaccharides and a mixture of oligosaccharides in a finished product may be at least 0.1%, 0.5%, 1%, 5%, 10%, 15%, 20%, 25%, 30%, or 35% w/w. The concentration of a composition comprising polysaccharides and a mixture of oligosaccharides in a finished product may be at most 0.5%, 1%, 5%, 10%, 15%, 20%, 25%, 30%, 35%, or 40% w/w.

### Enzymatic Reactions

TABLE 1A
Enzyme Sequences

| | SEQ | |
|---|---|---|
| Name | ID | Sequence |
| LPMO: AA9 LPMO | 1 | MKGLLSVAAL SLAVSEVSAH YIFQQLSTGS TKHGVFQYIR QNTNYNSPVT DLSSNDLRCN |
| from Podospora | | EGGASGANTQ TVTVRAGDSF TFHLDTPVYH QGPVSVYLSK APGSASSYDG SGTWFKIKDW |
| anserine | | GPTFPGGQWT LAGSYTAQLP SCITDGEYLL RIQSLGIHNP YPAGTPQFYI SCAQIKVTGG |
| | | GSVNPSGVAI PGAFKATDPG YTANIYSNFN SYTVPGPSVF SCGSNGGGSS PVEPQPQPTT |
| | | TLVTSTRAPV ATQPAGCAVA KWGQCGGNGW TGCTTCAAGS TCNTQNAYYH QCV |
| Lichenase | 2 | MPYLKRVLLL LVTGLFMSLF AVTATASAQT GGSFFDPFNG YNSGFWQKAD |
| GH16 Lichenase from | | GYSNGNMFNC |
| Bacillus subtilis subsp. | | TWRANNVSMT SLGEMRLALT SPAYNKFDCG ENRSVQTYGY GLYEVRMKPA KNTGIVSSFF |
| subtilis str. 168 | | TYTGPTDGTP WDEIDIEFLG KDTTKVQFNY YTNGAGNHEK IVDLGEDAAN AYHTYAFDWQ |
| | | PNSIKWYVDG QLKHTATNQI PTTPGKIMMN LWNGTGVDEW LGSYNGVNPL |
| | | YAHYDWVRYT KK |
| Xylanase: GH5 | 3 | MGASIKTSIK IRTVAFVSII AIALSILSFI PNRAYASPQR GRPRLNAART TFVGDNGQPL |
| Arabinoxylanase from | | RGPYTSTEWT AAAPYDQIAR VKELGFNAVH LYAECFDPRY PAPGSKAPGY AVNEIDKIVE |
| Ruminiclostridium | | RTRELGLYLV ITIGNGANNG NHNAQWARDF WKFYAPRYAK ETHVLYEIHN EPVAWGPPYS |
| thermocellum | | SSTANPPGAV DMEIDVYRII RTYAPETPVL LFSYAVFGGK GGAAEALKDI RAFNKAVFGN |
| | | ENAVWTNEAV AFHGYAGWQE TTIAVEELLK AGYPCFMTEY AGGAWGSGMG |
| | | GLDVELTYEL |
| | | ERLGVSWLTF QYIPPTGVSD DVTKPEYFSA LVENSGLSWT PDYGNWPAAR GVYGNGGLAR |
| | | ETATWINNFL TGTTRIEAED FDWGGNGVSY YDTDSVNVGG QYRPDEGVDI EKTSDTGGGY |
| | | NVGWISEGEW LEYTIRVRNP GYYNLSLRVA GISGSRVQVS FGNQDKTGVW ELPATGGFQT |
| | | WTTATRQVFL GAGLQKLRIN ALSGGFNLNW IELSPISTGT IPDGTYKFLN RANGKTLQEV |
| | | TGNNSIITAD YKGITEQHWK IQHIGGGQYR ISSAGRGWNW NWWMGFGTVG |
| | | WWGTGSSTCF |
| | | IISPTGDGYY RIVLVGDGTN LQISSGDPSK IEGKAFHGGA NQQWAILPVS APAFPTGLSA |
| | | VLDSSGNTAN LTWNAAPGAN SYNVKRSTKS GGPYTTIATN ITSTNYTDTG VATGTKYYYV |
| | | VSAVSNGVET LNSAEAILQY PKLTGTVIGT QGSWNNIGNT IHKAFDGDLN TFFDGPTANG |
| | | CWLGLDFGEG VRNVITQIKF CPRSGYEQRM IGGIFQGANK EDFSDAVTLF TITSLPGSGT |
| | | LTSVDVDNPT GFRYVRYLSP DGSNGNIAEL QFFGTPAGEE NDDVHLGDIN DDGNINSTDL |
| | | QMLKRHLLRS IRLTEKQLLN ADTNRDGRVD STDLALLKRY ILRVITTL |
| Xylanase: GH5 | 4 | MARLSSLIAL VLAFVAVSAP ALAARGRPRL NGKTFVADSG VPLRGPFTST EWTPAVPAAN |
| Xylanase from | | IANMRNYNFN AIHLYAETFD PNYPAAGSQK PGYAATRVDQ IVAATKAANM |
| Gonapodya prolifera | | YVVIVLANGA |
| | | NNGKFNLNYA KDFWSFYAAR YKNETHVIYE IHNEPVQWGP PYISSTQSPG AVSMNADCYK |
| | | IIRAVAPDTP VLLFTYASIG GGSSAAGAVK DAQSENTAVF GNANAQWTNE AIAIHGYWGA |
| | | QGASDAAKAL NAAGFSVVLT EFAAATSPTS PNGGQDTVLT GFMEQQGVSW LTFLHVPPTG |
| | | VSGDVTDPNQ YTNRMTAAGI GFDRDPGLNA VGGGQAAPVP VPAPAPVPSP VPAPVPAVPA |
| | | VRTTTARPAP SPSPVPAPVP APAPVPAPVP APVPAPVPAP VPAPVPASPA ATTTRRHRTR |
| | | PPRTTTAPAV PAPPPAATPK VCG |
| Xylanase: GH30 | 5 | MNGNVSLWVR HCLHAALFVS ATAGSFSVYA DTVKIDANVN YQIIQGFGGM |
| xylanase from Dickeya | | SGVGWINDLT |
| chrysanthemi | | TEQINTAYGS GVGQIGLSIM RVRIDPDSSK WNIQLPSARQ AVSLGAKIMA TPWSPPAYMK |
| | | SNNSLINGGR LLPANYSAYT SHLLDFSKYM QTNGAPLYAI SIQNEPDWKP DYESCEWSGD |
| | | EFKSYLKSQG SKFGSLKVIV AESLGFNPAL TDPVLKDSDA SKYVSIIGGH LYGTTPKPYP |
| | | LAQNAGKQLW MTEHYVDSKQ SANNWTSAIE VGTELNASMV SNYSAYVWWY |
| | | IRRSYGLLTE |
| | | DGKVSKRGYV MSQYARFVRP GALRIQATEN PQSNVHLTAY KNTDGKMVIV |
| | | AVNTNDSDQM |
| | | LSLNISNANV TKFEKYSTSA SLNVEYGGSS QVDSSGKATV WLNPLSVTTF VSK |
| Xylanase: GH30 | 6 | MIPRIKKTIC VLLVCFTMLS VMLGPGATEV LAASDVTVNV SAEKQVIRGF GGMNHPAWAG |
| xylanase from Bacillus | | DLTAAQRETA FGNGQNQLGF SILRIHVDEN RNNWYKEVET AKSAVKHGAI VFASPWNPPS |
| subtilis subsp. subtilis | | DMVETFNRNG DTSAKRLKYN KYAAYAQHLN DFVTFMKNNG VNLYAISVQN |
| str. 168 | | EPDYAHEWTW |
| | | WTPQEILRFM RENAGSINAR VIAPESFQYL KNLSDPILND PQALANMDIL GTHLYGTQVS |
| | | QFPYPLFKQK GAGKDLWMTE VYYPNSDTNS ADRWPEALDV SQHIHNAMVE |
| | | GDFQAYVWWY |
| | | IRRSYGPMKE DGTISKRGYN MAHFSKFVRP GYVRIDATKN PNANVYVSAY KGDNKVVIVA |
| | | INKSNTGVNQ NFVLQNGSAS NVSRWITSSS SNLQPGTNLT VSGNHFWAHL |
| | | PAQSVTTFVVNR |
| Xylanase: GH30 | 7 | MKNITLLFCL FLANILLGAC SGGEDEKKEM DEGKGAYALF LKKSITVSTG ESQTDVVVEW |
| Xylanase from | | AKTSWEITLG EGDIVKSVTP TSGGSNTGEK QYTKVRVSCG ANSTMKKRTQ TIHLFDKTNE |
| Bacteroides ovatus | | TTVDLLVEQE PPFKSVTLTV DPSVKYQPVV GFGGMYNPKI WCGDNLISAS QLDKMYGAGG |
| | | LGYSILRLMI YPNESDWSAD VEAAKAAQAN GAIIFACPWD CTDALADKIT VNGKEMKHLK |
| | | KENYEAYANH LIRYVTFMKE KGVNLYAISV QNEPDMEFTY WTPSEVVDFV KQYGARIRET |
| | | GVKLMSPEAC GMQPEYTDPI INNAEAFAQT DILAGHLYQG FTDLSSGYVK NRHDYICGVY |
| | | SRIQGKTWWM TEHLFNDGEN SDDSSKWEFL KWQYSLNHLG KEIHMCMEGY |
| | | CSAYIYWYLK |
| | | RFYGLMGDTD KRSPTSEGEI TKNGYIMAHY AQYATETTRI KVVTNNEEVC ATAYWDEKTG |
| | | EVTIVLLNLN GASQWLEIPL AGIKKASAVE TNETKNMEVI DTGLMESAEG ITVLLSANSI |
| | | TSVRLTF |
| Xyloglucanase: GH5 | 8 | MEKQSFSDGL FSPLGIKRVI FMLVLLTTSF ISCSNSDEKG GSLEVAQEYR NLEFDARGSR |
| Xyloglucanase from | | QTIQIDGPAE WHISTSESWC KSSHTIGEGK QYVNITVEAN DTQKERTATV TVSASGAPDI |
| Bacteroides ovatus | | IINVKQSLYS VPAYDEYIAP DNTGMRDLTS MQLSALMKAG VNVGNTFEAV IVGNDGSLSG |
| | | DETCWGNPTP NKVLFEGIKA AGFDVVRIPV AYSHQFEDAA TYKIKSAWMD |
| | | KVEAAVKAAL |
| | | DAGLYVIINI HWEGGWLNHP VDANKEALDE RLEAMWKQIA LRFRDYDDRL |
| | | LFAGTNEVNN |
| | | DDANGAQPTE ENYRVQNGFN QVFVNTVRAT GGRNHYRHLI VQAYNTDVAK |
| | | AVAHFTMPLD |
| | | IVQNRIFLEC HYYDPYDFTI MPNDENFKSQ WGAAFAGGDV SATGQEGDIE ATLSSLNVFI |
| | | NNNVPVIIGE YGPTLRDQLT GEALENHLKS RNDYIEYVVK TCVKNKLVPL YWDAGYTEKL |
| | | FDRTTGQPHN AASIAAIMKG LN |
| Xyloglucanase: GH74 | 9 | MKVSRVLALV LGAVIPAHAA FSWKNVKLGG GGGFVPGIIF HPKTKGVAYA RTDIGGLYRL |
| Xyloglucanase from | | NADDSWTAVT DGIADNAGWH NWGIDAVALD PQDDQKVYAA VGMYTNSWDP |
| Trichoderma reesei | | SNGAIIRSSD |
| | | RGATWSFTNL PFKVGGNMPG RGAGERLAVD PANSNIIYFG ARSGNGLWKS TDGGVTFSKV |
| | | SSFTATGTYI PDPSDSNGYN SDKQGLMWVT FDSTSSTTGG ATSRIFVGTA DNITASVYVS |
| | | TNAGSTWSAV PGQPGKYFPH KAKLQPAEKA LYLTYSDGTG PYDGTLGSVW |
| | | RYDIAGGTWK |
| | | DITPVSGSDL YFGFGGLGLD LQKPGTLVVA SLNSWWPDAQ LFRSTDSGTT WSPIWAWASY |
| | | PTETYYYSIS TPKAPWIKNN FIDVTSESPS DGLIKRLGWM IESLEIDPTD SNHWLYGTGM |
| | | TIFGGHDLTN WDTRHNVSIQ SLADGIEEFS VQDLASAPGG SELLAAVGDD NGFTFASRND |
| | | LGTSPQTVWA TPTWATSTSV DYAGNSVKSV VRVGNTAGTQ QVAISSDGGA TWSIDYAADT |
| | | SMNGGTVAYS ADGDTILWST ASSGVQRSQF QGSFASVSSL PAGAVIASDK KTNSVFYAGS |
| | | GSTFYVSKDT GSSFTRGPKL GSAGTIRDIA AHPTTAGTLY VSTDVGIFRS TDSGTTFGQV |
| | | STALTNTYQI ALGVGSGSNW NLYAFGTGPS GARLYASGDS GASWTDIQGS QGFGSIDSTK |
| | | VAGSGSTAGQ VYVGTNGRGV FYAQGTVGGG TGGTSSSTKQ SSSSTSSASS STTLRSSVVS |
| | | TTRASTVTSS RTSSAAGPTG SGVAGHYAQC GGIGWTGPTQ CVAPYVCQKQ NDYYYQCV |
| Cellobiohydrolase: | 10 | MYRKLAVISA FLATARAQSA CTLQSETHPP LTWQKCSSGG TCTQQTGSVV IDANWRWTHA |
| GH7 Cel7A | | TNSSTNCYDG NTWSSTLCPD NETCAKNCCL DGAAYASTYG VTTSGNSLSI GFVTQSAQKN |
| cellobiohydrolase from | | VGARLYLMAS DTTYQEFTLL GNEFSFDVDV SQLPCGLNGA LYFVSMDADG GVSKYPTNTA |
| Trichoderma reesei | | GAKYGTGYCD SQCPRDLKFI NGQANVEGWE PSSNNANTGI GGHGSCCSEM DIWEANSISE |
| | | ALTPHPCTTV GQEICEGDGC GGTYSDNRYG GTCDPDGCDW NPYRLGNTSF YGPGSSFTLD |
| | | TTKKLTVVTQ FETSGAINRY YVQNGVTFQQ PNAELGSYSG NELNDDYCTA EEAEFGGSSF |
| | | SDKGGLTQFK KATSGGMVLV MSLWDDYYAN MLWLDSTYPT NETSSTPGAV |
| | | RGSCSTSSGV |
| | | PAQVESQSPN AKVTFSNIKF GPIGSTGNPS GGNPPGGNRG TTTTRRPATT TGSSPGPTQS |
| | | HYGQCGGIGY SGPTVCASGT TCQVLNPYYS QCL |
| Cellobiohydrolase: | 11 | MIVGILTTLA TLATLAASVP LEERQACSSV WGQCGGQNWS GPTCCASGST CVYSNDYYSQ |
| GH6 Cel6A | | CLPGAASSSS STRAASTTSR VSPTTSRSSS ATPPPGSTTT RVPPVGSGTA TYSGNPFVGV |
| cellobiohydrolase from | | TPWANAYYAS EVSSLAIPSL TGAMATAAAA VAKVPSFMWL DTLDKTPLME QTLADIRTAN |
| Trichoderma reesei | | KNGGNYAGQF VVYDLPDRDC AALASNGEYS IADGGVAKYK NYIDTIRQIV VEYSDIRTLL |
| | | VIEPDSLANL VTNLGTPKCA NAQSAYLECI NYAVTQLNLP NVAMYLDAGH |
| | | AGWLGWPANQ |
| | | DPAAQLFANV YKNASSPRAL RGLATNVANY NGWNITSPPS YTQGNAVYNE KLYIHAIGPL |
| | | LANHGWSNAF FITDQGRSGK QPTGQQQWGD WCNVIGTGFG IRPSANTGDS LLDSFVWVKP |
| | | GGECDGTSDS SAPRFDSHCA LPDALQPAPQ AGAWFQAYFV QLLTNANPSF L |
| Endoglucanase A eglA- | 12 | MKLPVTLAML AATAMGQTMC SQYDSASSPP YSVNQNLWGE YQGTGSQCVY |
| Aspergillus niger GH12 | | VDKLSSSGAS WHTEWTWSGG EGTVKSYSNS GVTFNKKLVS DVSSIPTSVE WKQDNTNVNA |
| | | DVAYDLFTAA NVDHATSSGD YELMIWLARY GNIQPIGKQI ATATVGGKSW |
| | | EVWYGSTTQA GAEQRTYSFV SESPINSYSG DINAFFSYLT QNQGFPASSQ YLINLQFGTE |
| | | AFTGGPATFT VDNWTASVN |
| Aspergillus niger Endo- | 13 | MRISNLIVAA SAASMVSALP SRQMKKRDSG FKWVGTSESG AEFGSALPGT LGTDYTWPET |
| ß-1,4-glucanase | | SKIQVLRNKG MNIFRIPFLM ERLTPDGLTS SFASTYLSDL KSTVEFVTNS GAYAVLDPHN |
| GH5, CBM1 | | YGRFDGSIIT STSDFKTWWK NVATEFADND KVIFDTNNEY HDMEQSLVLD LNQAAINGIR |
| | | AAGATTQYIF VEGNAYTGAW DWTTYNDNLS GLTDSEDKII YEMHQYLDSD SSGTSETCVS |
| | | STIGQERLEK ATEWLKTNNK QGIVGEFAGG VNSVCEEAVE GMLAYMSENS |
| | | DVWVGASWWS |
| | | AGPWWGTYMY SLEPTDGTAY STYLPILEKY FPSGDASASS SASVSVAAAT STASTTTAAF |
| | | EQTTTPATQG PSATNSAGEV NQYYQCGGIN WTGPTVCASP YTCKVQNDYY YQCVAE |
| Aspergillus niger Endo- | 14 | MKFQSTLLLA AAAGSALAVP HGSGHKKRAS VFEWFGSNES GAEFGTNIPG VWGTDYIFPD |
| ß-1,4-glucanase B GH5 | | PSTISTLIGK GMNFFRVQFM MERLLPDSMT GSYDEEYLAN LTTVVKAVTD GGAHALIDPH |
| | | NYGRYNGEII SSTSDFQTFW QNLAGQYKDN DLVMFDTNNE YYDMDQDLVL NLNQAAINGI |
| | | RAAGASQYIF VEGNSWTGAW TWVDVNDNMK NLTDPEDKIV YEMHQYLDSD |
| | | GSGTSETCVS |
| | | GTIGKERITD ATQWLKDNKK VGFIGEYAGG SNDVCRSAVS GMLEYMANNT |
| | | DVWKGASWWA |
| | | AGPWWGDYIF SLEPPDGTAY TGMLDILETY L |
| GH30 Xylanase from | 15 | MKSSISVVLA LLGHSAAWSY ATKSQYRANI KINARQTYQT MIGGGCSGAF GIACQQFGSS |
| Trichoderma reesei | | GLSPENQQKV TQILFDENIG GLSIVRNDIG SSPGTTILPT CPATPQDKFD YVWDGSDNCQ |
| | | FNLTKTALKY NPNLYVYADA WSAPGCMKTV GTENLGGQIC GVRGTDCKHD |
| | | WRQAYADYLV |
| | | QYVRFYKEEG IDISLLGAWN EPDFNPFTYE SMLSDGYQAK DFLEVLYPTL KKAFPKVDVS |
| | | CCDATGARQE RNILYELQQA GGERYFDIAT WHNYQSNPER PFNAGGKPNI QTEWADGTGP |
| | | WNSTWDYSGQ LAEGLQWALY MHNAFVNSDT SGYTHWWCAQ NTNGDNALIR |
| | | LDRDSYEVSA |
| | | RLWAFAQYFR FARPGSVRIG ATSDVENVYV TAYVNKNGTV AIPVINAAHF PYDLTIDLEG |
| | | IKKRKLSEYL TDNSHNVTLQ SRYKVSGSSL KVTVEPRAMK TFWLE |
| Aspergillus niger Endo- | 16 | MKVTAAFAGL LVTAFAAPVP EPVLVSRSAG INYVQNYNGN LGDFTYDESA |
| ß-1,4-xylanase 1 GH11 | | GTFSMYWEDG |
| | | VSSDFVVGLG WTTGSSKAIT YSAEYSASGS SSYLAVYGWV NYPQAEYYIV EDYGDYNPCS |
| | | SATSLGTVYS DGSTYQVCTD TRTNEPSITG TSTFTQYFSV RESTRTSGTV TVANHFNFWA |
| | | QHGFGNSDFN YQVMAVEAWS GAGSASVTIS S |
| GH5 mannanase from | 17 | MMMLSKSLLS AATAASALAA VLQPVPRASS FVTISGTQFN IDGKVGYFAG TNCYWCSFLT |
| Trichoderma reesei | | NHADVDSTFS HISSSGLKVV RVWGFNDVNT QPSPGQIWFQ KLSATGSTIN TGADGLQTLD |
| | | YVVQSAEQHN LKLIIPFVNN WSDYGGINAY VNAFGGNATT WYTNTAAQTQ |
| | | YRKYVQAVVS |
| | | RYANSTAIFA WELGNEPRCN GCSTDVIVQW ATSVSQYVKS LDSNHLVTLG DEGLGLSTGD |
| | | GAYPYTYGEG TDFAKNVQIK SLDFGTFHLY PDSWGTNYTW GNGWIQTHAA |
| | | ACLAAGKPCV |
| | | FEEYGAQQNP CTNEAPWQTT SLTTRGMGGD MFWQWGDTFA NGAQSNSDPY |
| | | TVWYNSSNWQ |
| | | CLVKNHVDAI NGGTTTPPPV SSTTTTSSRT SSTPPPPGGS CSPLYGQCGG SGYTGPTCCA |
| | | QGTCIYSNYW YSQCLNT |
| Aspergillus niger Endo- | 18 | MFAKLSLLSL LFSSAALGAS NQTLSYGNID KSATPEARAL LKYIQLQYGS HYISGQQDID |
| β-1,4-mannanase GH26 | | SWNWVEKNIG VAPAILGSDF TYYSPSAVAH GGKSHAVEDV IQHAGRNGIN |
| | | ALVWHWYAPT |
| | | CLLDTAKEPW YKGFYTEATC FNVSEAVNDH GNGTNYKLLL RDIDAIAAQI KRLDQAKVPI |
| | | LFRPLHEPEG GWFWWGAQGP APFKKLWDIL YDRITRYHNL HNMVWVCNTA |
| | | DPAWYPGNDK |
| | | CDIATIDHYP AVGDHGVAAD QYKKLQTVTN NERVLAMAEV GPIPDPDKQA |
| | | RENVNWAYWM |
| | | VWSGDFIEDG KQNPNQFLHK VYNDTRVVAL NWEGA |
| Aspergillus niger ß- | 19 | MKLSNALLTL ASLALANVST ALPKASPAPS TSSSAASTSF ASTSGLQFTI DGETGYFAGT |
| mannanase GH5 | | NSYWIGFLTD NADVDLVMGH LKSSGLKILR VWGFNDVTSQ PSSGTVWYQL HQDGKSTINT |
| | | GADGLQRLDY VVSSAEQHDI KLIINFVNYW TDYGGMSAYV SAYGGSGETD FYTSDTMQSA |
| | | YQTYIKTVVE RYSNSSAVFA WELANEPRCP SCDTSVLYNW IEKTSKFIKG LDADRMVCIG |
| | | DEGFGLNIDS DGSYPYQFSE GLNFTMNLGI DTIDFGTLHL YPDSWGTSDD WGNGWITAHG |
| | | AACKAAGKPC LLEEYGVTSN HCSVEGSWQK TALSTTGVGA DLFWQYGDDL |
| | | STGKSPDDGN |
| | | TIYYGTSDYQ CLVTDHVAAI GSA |
| Aspergillus niger | 20 | MHQRALLFSA LLTAVRAQQA GTLTEEVHPS LTWQKCTSEG SCTEQSGSVV IDSNWRWTHS |
| Cellobiohydrolase A | | VNDSTNCYTG NTWDATLCPD DETCAANCAL DGADYESTYG VTTDGDSLTL |
| GH7 | | KFVTGSNVGS |
| | | RLYLMDTSDE GYQTFNLLDA EFTFDVDVSN LPCGLNGALY FTAMDADGGV |
| | | SKYPANKAGA |
| | | KYGTGYCDSQ CPRDLKFIDG QANVDGWEPS SNNDNTGIGN HGSCCPEMDI WEANKISTAL |
| | | TPHPCDSSEQ TMCEGNDCGG TYSDDRYGGT CDPDGCDFNP YRMGNDSFYG PGKTIDTGSK |
| | | MTVVTQFITD GSGSLSEIKR YYVQNGNVIA NADSNISGVT GNSITTDFCT AQKKAFGDED |
| | | IFAEHNGLAG ISDAMSSMVL ILSLWDDYYA SMEWLDSDYP ENATATDPGV ARGTCDSESG |
| | | VPATVEGAHP DSSVTFSNIK FGPINSTFSA SA |
| Aspergillus niger | 21 | MSSFQIYRAA LLLSILATAN AQQVGTYTTE THPSLTWQTC TSDGSCTTND GEVVIDANWR |
| Cellobiohydrolase B | | WVHSTSSATN CYTGNEWDTS ICTDDVTCAA NCALDGATYE ATYGVTTSGS ELRLNFVTQG |
| GH7, CBM1 | | SSKNIGSRLY LMSDDSNYEL FKLLGQEFTF DVDVSNLPCG LNGALYFVAM DADGGTSEYS |
| | | GNKAGAKYGT GYCDSQCPRD LKFINGEANC DGWEPSSNNV NTGVGDHGSC |
| | | CAEMDVWEAN |
| | | SISNAFTAHP CDSVSQTMCD GDSCGGTYSA SGDRYSGTCD PDGCDYNPYR LGNTDFYGPG |
| | | LTVDTNSPFT VVTQFITDDG TSSGTLTEIK RLYVQNGEVI ANGASTYSSV NGSSITSAFC |
| | | ESEKTLFGDE NVFDKHGGLE GMGEAMAKGM VLVLSLWDDY AADMLWLDSD |
| | | YPVNSSASTP |
| | | GVARGTCSTD SGVPATVEAE SPNAYVTYSN IKFGPIGSTY SSGSSSGSGS SSSSSSTTTK |
| | | ATSTTLKTTS TTSSGSSSTS AAQAYGQCGG QGWTGPTTCV SGYTCTYENA YYSQCL |
| GH3 beta-glucosidase | 22 | MRYRTAAALA LATGPFARAD SHSTSGASAE AVVPPAGTPW GTAYDKAKAA |
| from Trichoderma | | LAKLNLQDKV |
| reesei | | GIVSGVGWNG GPCVGNTSPA SKISYPSLCL QDGPLGVRYS TGSTAFTPGV QAASTWDVNL |
| | | IRERGQFIGE EVKASGIHVI LGPVAGPLGK TPQGGRNWEG FGVDPYLTGI AMGQTINGIQ |
| | | SVGVQATAKH YILNEQELNR ETISSNPDDR TLHELYTWPF ADAVQANVAS VMCSYNKVNT |
| | | TWACEDQYTL QTVLKDQLGF PGYVMTDWNA QHTTVQSANS GLDMSMPGTD |
| | | FNGNNRLWGP |
| | | ALTNAVNSNQ VPTSRVDDMV TRILAAWYLT GQDQAGYPSF NISRNVQGNH |
| | | KTNVRAIARD |
| | | GIVLLKNDAN ILPLKKPASI AVVGSAAIIG NHARNSPSCN DKGCDDGALG MGWGSGAVNY |
| | | PYFVAPYDAI NTRASSQGTQ VTLSNTDNTS SGASAARGKD VAIVFITADS GEGYITVEGN |
| | | AGDRNNLDPW HNGNALVQAV AGANSNVIVV VHSVGAIILE QILALPQVKA VVWAGLPSQE |
| | | SGNALVDVLW GDVSPSGKLV YTIAKSPNDY NTRIVSGGSD SFSEGLFIDY KHFDDANITP |
| | | RYEFGYGLSY TKFNYSRLSV LSTAKSGPAT GAVVPGGPSD LFQNVATVTV DIANSGQVTG |
| | | AEVAQLYITY PSSAPRTPPK QLRGFAKLNL TPGQSGTATF NIRRRDLSYW DTASQKWVVP |
| | | SGSFGISVGA SSRDIRLTST LSVA |
| Beta-xylosidase from | 23 | MVNNAALLAA LSALLPTALA QNNQTYANYS AQGQPDLYPE TLATLTLSFP DCEHGPLKNN |
| Trichoderma reesei | | LVCDSSAGYV ERAQALISLF TLEELILNTQ NSGPGVPRLG LPNYQVWNEA LHGLDRANFA |
| | | TKGGQFEWAT SFPMPILTTA ALNRTLIHQI ADIISTQARA FSNSGRYGLD VYAPNVNGFR |
| | | SPLWGRGQET PGEDAFFLSS AYTYEYITGI QGGVDPEHLK VAATVKHFAG YDLENWNNQS |
| | | RLGFDAIITQ QDLSEYYTPQ FLAAARYAKS RSLMCAYNSV NGVPSCANSF FLQTLLRESW |
| | | GFPEWGYVSS DCDAVYNVFN PHDYASNQSS AAASSLRAGT DIDCGQTYPW |
| | | HLNESFVAGE |
| | | VSRGEIERSV TRLYANLVRL GYFDKKNQYR SLGWKDVVKT DAWNISYEAA |
| | | VEGIVLLKND |
| | | GTLPLSKKVR SIALIGPWAN ATTQMQGNYY GPAPYLISPL EAAKKAGYHV NFELGTEIAG |
| | | NSTTGFAKAI AAAKKSDAII YLGGIDNTIE QEGADRTDIA WPGNQLDLIK QLSEVGKPLV |
| | | VLQMGGGQVD SSSLKSNKKV NSLVWGGYPG QSGGVALFDI LSGKRAPAGR |
| | | LVTTQYPAEY |
| | | VHQFPQNDMN LRPDGKSNPG QTYIWYTGKP VYEFGSGLFY TTFKETLASH PKSLKFNTSS |
| | | ILSAPHPGYT YSEQIPVFTF EANIKNSGKT ESPYTAMLFV RTSNAGPAPY PNKWLVGFDR |
| | | LADIKPGHSS KLSIPIPVSA LARVDSHGNR IVYPGKYELA LNTDESVKLE FELVGEEVTI |
| | | ENWPLEEQQI KDATPDA |
| Beta-mannosidase from | 24 | MARHSIQLDK GWTFRQHQGS SPEWLPVEKV PTQVHMDLLA NKQIPDPFVD |
| Trichoderma reesei | | LNERAVQWIG |
| | | YKDWEYQVTF TPEAAQVEDA TRDLVFNGLD TFATVYLNEA KILEAENMFV SYRVNVTDRI |
| | | KASSENTLRI VFHSAIVRGE ELIKEHPEHN FLVRQTERSR VPVRKAQYNW GWDWGPILMT |
| | | AGPWKPVALE TYVARIDDVW AQSDVSQDLK TVSGIIFARV AGRPSQDDQV SLTLSLDGKA |
| | | VFQQTVDVAS AKDGLIKVPF KLEDPKLWYP RGYGSQPRYQ LNADLARKAS DASQIDSLSK |
| | | LVGFRRAELV QEPDAFGKSF YFRINNVDVF AGGSCWIPAD SYLAGVPPER YHAWAKLIAD |
| | | GNQVMLRVWG GGVYEEDALI EACDELGILV FHDFQFACAS YPAYPSYLEN LEVEARQQIR |
| | | RLRTHPSVII WAGNNEDYQV QERYKLDYEF ENKDPESWLK SSFPARYIYE HFLPKLVEEE |
| | | DPGKIYHPSS PWGDGKPTAD PTVGDIHQWN XPPPPISTQI THTQHPTDHP LHTVWHGTMN |
| | | KYQEAVNMGG RFVSEFGMEA YPHLSTTRRM ASDPAQLYPG SMVLDAHNKA |
| | | IGHERRMMSY |
| | | VVDNFRPRHD LGGYTHLTQV VQSETMRAAY KAWRRQWGKP GARRCGGALV |
| | | WQLNDCWPTM |
| | | SWAVVDYRLV KKPAYYAIAR ALRRVDVGVC RTWHDWTQTG AWVDENSGLV |
| | | TGQVDHTLAA |
| | | REGTFDVWVV SSDTQPVALD LVVRFISVRT GRDVVDPILH SRVVAAANSA TDILQGKTLP |
| | | PSIPNPEDIT KPFPLAEYDP YVVHATITDA ATGTVIAADT AWPEPIKYLD LSDRGIAFEV |
| | | SSAGDEVVVS AEKPVKGFVF EEVEGLELSD NGFDVVPGEK QLVKVGGALK AGELLWTCIG |
| | | ADSASLKIEA SSSLAPR |
| AA9 LPMO from | 25 | MIQKLSNLLV TALAVATGVV GHGHINDIVI NGVWYQAYDP TTFPYESNPP IVVGWTAADL |
| Trichoderma reesei | | DNGFVSPDAY QNPDIICHKN ATNAKGHASV KAGDTILFQW VPVPWPHPGP IVDYLANCNG |
| | | DCETVDKTTL EFFKIDGVGL LSGGDPGTWA SDVLISNNNT WVVKIPDNLA PGNYVLRHEI |
| | | IALHSAGQAN GAQNYPQCFN IAVSGSGSLQ PSGVLGTDLY HATDPGVLIN IYTSPLNYII |
| | | PGPTVVSGLP TSVAQGSSAA TATASATVPG GGSGPTSRTT TTARTTQASS RPSSTPPATT |
| | | SAPAGGPTQT LYGQCGGSGY SGPTRCAPPA TCSTLNPYYA QCLN |

One step of the method of forming or manufacturing the composition may be an enzymatic reaction, in which one or more enzymes are placed in a suitable reaction vessel together with one or more feedstocks, which may be soluble or insoluble in water, and a suitable solvent.

A variety of enzymes may be suitable for use in the enzymatic reaction. Any enzyme which produces oligosaccharides when acting on a polysaccharide-containing feedstock may be appropriate, and it is within the ability of the skilled person to select suitable enzymes. Preferably, the enzymatic reaction comprises a cellulase, an endo-glucanase, a cellobiohydrolase, a lytic polysaccharide monooxygenase (LPMO), a lichenase, a xyloglucan endoglucanase (XEG), a mannanase, a chitinase, and/or a xylanase.

More preferably, the enzymatic reaction comprises a cellulolytic preparation from a species, such as Trichoderma reesei, which may be purified and/or pre-treated and/or may be supplemented with one or more additional enzymes, for example, adding a beta-glucanase (SEQ ID NO: 14), a beta-xylanase (SEQ ID NO: 16) and a cellobiohydrolase, or a beta-glucanase, a beta-xylanase, an LPMO and a cellobiohydrolase, or an LPMO and a xylanase, or an LPMO, a xylanase, and a lichenase. Each enzyme may be provided to the enzymatic reaction as a purified enzyme, a semi-purified mixture derived from some natural source or lab-grown culture, in the form of a microbial strain engineered to produce the enzyme, or in any other manner. Fusions of these enzymes, either with other enzymes or with non-enzymatic modules such as carbohydrate-binding modules (CBMs), are also envisaged within each respective term, for example, an LPMO fused to a CBM, a xylanase fused to a CBM, or a xylanase fused to an LPMO.

As used herein, “cellulase” refers to an enzyme that has, or a group of enzymes that collectively have, hydrolytic activity against cellulose, for example, an enzyme preparation containing endo-1,4-beta-glucanase, cellobiohydrolase, and/or beta-glucosidase activities. Such enzymes may be able to cleave glycosidic bonds in one or more forms of cellulose, including cellulose found in plant biomass. In doing so, they can produce products including glucose and cello-oligosaccharides.

As used herein, “cellobiohydrolase” refers to an enzyme that has hydrolytic activity against cellulose and produces mainly cellobiose as a product. Cellobiose is a disaccharide and is a cello-oligosaccharide. Such enzymes are able to cleave glycosidic bonds in one or more forms of cellulose, including cellulose found in plant biomass. Preferable cellobiohydrolases are from the GH6 and GH7 enzyme families, such as cellobiohydrolase 12 and 13 from Aspergillus niger (SEQ ID NO:20 and 21) more preferably, Cel6A or Cel7A enzymes derived from Trichoderma reesei (SEQ ID NOs:10 and 11).

As used herein, “beta-glucosidase” refers to an enzyme that has hydrolytic activity against cellobiose and produces mainly glucose as a product. Such enzymes are able to cleave glycosidic bonds in one or more forms of cellobiose, including cellobiose derived from plant biomass. Preferred beta-glucosidases include GH3 beta-glucosidases from Trichoderma reesei (SEQ ID NO:22).

As used herein, “lytic polysaccharide monooxygenase” and “LPMO” refer to a class of enzymes able to oxidatively cleave polysaccharides using a copper comprising moiety and using an oxygen source, such as a molecule of dioxygen, peroxide, or any other oxygen source; and a suitable reducing agent. As such, when an LPMO is used, the enzymatic reaction may be carried out under aerobic conditions. Suitable reducing agents are not particularly limited, but examples include ascorbic acid, gallic acid, cysteine, NADH, NADPH, pyrogallol, dithiothreitol, cyanoborohydrides, borohydrides, photosynthetic pigments, lignin, lignols, and a combination of cellobiose and cellobiose dehydrogenase. While the skilled person knows a wide variety of photosynthetic pigments which may be used, thylakoids and purified fractions, or chlorophyllin, are preferred, and light may be supplied. Preferably, LPMOs are selected from the following families: AA9, AA10, AA11, AA13, AA14, and AA15. More preferably, the LPMO is PaLPMO9E (SEQ ID NO:1), an AA9 LPMO originally isolated from the ascomycete fungus Podospora anserina. More preferably still, the LPMO is an AA9 LPMO from Trichoderma reesei (SEQ ID NO:25).

Aerobic conditions may comprise the addition of oxygen, which may be provided by aeration of the substrate mixture with an oxygen-comprising gas, such as air. Aeration may be conducted by the introduction of oxygen-comprising air bubbles into the aqueous substrate mixtures by various systems, such as an air-injector, an aeration frit, a membrane system, or an internal-loop airlift reactor. Preferably, the concentration of molecular oxygen in the enzymatic reaction is from about 4 mg/L to about 14 mg/L.

Another exemplary enzyme is a lichenase, which may be selected from the GH5, GH7, GH8, GH9, GH12, GH16, GH17, or GH26 families, preferably a GH16 enzyme, more preferably a GH16 enzyme derived from Bacillus subtilis (SEQ ID NO:2). The enzyme may be able to act on, for example, mixed-linkage glucans, which are glucans comprising a mixture of β-1,3 and β-1,4 linkages, and may cleave them at β-1,4 glycosidic bonds. In the preferable case in which the lichenase acts on a mixed-linkage glucan, the β-glucans produced may fall largely within the size range of from 3 to about 7 residues, so they are particularly useful in the food, cosmetics, and nutraceutical industries. Mixed-linkage glucans are abundant in members of the grass and horsetail families, and as such, grass-based feedstocks such as straw have high levels of mixed-linkage glucans and may be acted upon usefully with lichenases. Preferred lichenases include GH5 lichenase from Bacillus subtilis (SEQ ID NO:2).

Another alternative enzyme is a xylanase, which may act on, for example, feedstocks comprising a xylan backbone. The xylanase may be, for example, a glucuronoxylanase, an arabinoxylanase, or a glucuronoarabinoxylanase. The enzyme may be active on a variety of polymers having a xylan backbone, such as glucuronoxylan, arabinoxylan, and glucuronoarabinoxylan. These polymers are abundant in various plant-derived feedstocks, for example, both hardwood and softwood may comprise appropriate polysaccharides, with hardwood often comprising glucuronoxylan and softwood often comprising arabinoglucuronoxylan. Preferred xylanases include GH5 xylanases from Ruminiclostridium thermocellum (SEQ ID NO:3) and Gonapodya prolifera (SEQ ID NO:4), and GH30 xylanases from Dickeya chrysanthemi (SEQ ID NO:5), Bacillus subtilis (SEQ ID NO:6) and Bacteroides ovatus (SEQ ID NO:7) and Trichoderma reesei (SEQ ID NO: 15 and 16).

Another alternative enzyme is a mannanase, which may act on, for example, feedstocks comprising a mannan backbone. The mannanase may be, for example, a mannanase, an glucomannanase, a galactomannanase or a galactoglucomannanase. The enzyme may be active on a variety of polymers having a mannan backbone, such as mannan, glucomannan, galactomannan or galactoglucomannan. These polymers are abundant in various plant-derived feedstocks, for example both hardwood and softwood may comprise appropriate polysaccharides. Preferred mannanases include GH5 mannanases from Trichoderma reesei (SEQ ID NO:17) and Aspergillus niger (SEQ ID NO:19) and a GH26 mannanase from Aspergillus niger (SEQ ID NO:18).

Other enzymes include xyloglucanases and xyloglucan endoglucanases (XEGs), which are produced by numerous organisms, including plant-pathogenic microbes. Xyloglucanases and XEGs may be able to act on xyloglucan, a hemicellulosic β-1,4 glucan chain abundant in the primary cell wall of higher plants, which is decorated with xylose, some of the xylose residues being further decorated with other residues, such as galactose. When appropriate xyloglucanases or XEGs act on xyloglucan, the products may comprise xyloglucan oligosaccharides having a main chain of a length useful in the foodstuff, cosmetics, and nutraceutical industries. Preferred xyloglucanases include is a GH5 xyloglucanase from Bacteroides ovatus (SEQ ID NO:8), and a GH74 xyloglucanase from Trichoderma reesei (SEQ ID NO:9).

Enzymes used in such enzymatic reactions may have a sequence which has at least 70%, 75%, 80%, 85%, 90%, 95%, or 100% identity to a sequence of SEQ ID Nos: 1-25. Enzymes used herein may be functional equivalents of enzymes described herein or functional equivalents of SEQ ID Nos: 1-25.

The enzymatic reaction may take place in solution and/or suspension or in a suitable reaction vessel. At a temperature or temperature protocol appropriate for the particular combination of enzyme and feedstock, the reaction may be allowed to progress for a certain amount of time (e.g., a predetermined amount of time), until the products have reached a desired concentration, or until some other requirement has been met.

As used herein, “suspension” refers to a composition comprising at least two immiscible phases, for example, a solid and a liquid phase, wherein the weight of the solid phase may be, as a percentage of the weight of the composition, in the range of from 0.5% to 30%, preferably from 1% to 20%, more preferably from 2% to 15%, yet more preferably from 3% to 10%. The suspension may comprise a suitable solvent, which is preferably water.

In order to ensure optimal contact between the enzymes and feedstock, the reaction mixture may be agitated, either constantly or at intervals. The agitation may take the form of (i) rhythmically moving the entire reaction vessel, (ii) a fan or other stirring device, (iii) bubble sparging, or any other suitable method of agitation.

The enzymatic reaction may be a microbial fermentation. The temperature and reaction time may be suitable for the growth of the microbial organism used. The microbial organism may be genetically altered to produce an enzyme suitable for the production of an oligosaccharide composition. The microbe may be, for example, a bacterium, for example Escherichia coli, or a fungus, such as Saccharomyces cerevisiae or Trichoderma reesei.

In some embodiments, an expression vector suitable for modifying the subject microorganism may be used such that it produces an enzyme or mixture of enzymes as described elsewhere herein. Where desired, the expression vector, which may be a plasmid or any other nucleic acid able to induce production of the enzyme, may comprise one or more of the following regulatory sequences so as to control the expression of the exogenous enzyme: regulatory sequences of a heat shock gene, regulatory sequences of a toxicity gene, regulatory sequences of a spore formation gene, or any other suitable regulatory sequence.

The enzymatic reaction can be carried out at a temperature or temperature protocol appropriate to the enzymes and substrates used. For example, the enzymatic reaction may be carried out at a constant temperature in the range of from 10° C. to 100° C., preferably from 20° C. to 80° C., more preferably from 40° C. to 60° C. If the enzymatic reaction takes the form of a microbial fermentation the temperature may be appropriate for such, for example, the enzymatic reaction may comprise the growth of E. coli and/or the temperature may be substantially constant and about 37° C.

The pH of the solution or suspension may affect the activity of the enzymes. Control of pH may aid in assuring that an enzymatic reaction proceeds at a suitable rate. The enzymatic reaction may take place at a pH in the range of from 2 to 10, preferably 3 to 8, more preferably 4 to 6.

The enzymatic reaction may be allowed to continue for a certain time period before optionally being quenched and the products isolated or otherwise collected. This time period may be from 1 minute to 6 days, and is preferably from 1 hour to 5 days, and is preferably from 2 hours days to 3 days more preferably from 6 hours to 20 hours. The reaction may alternatively be allowed to proceed until no further catalysis occurs.

The one or more feedstocks added to the enzymatic reaction may comprise polysaccharides. Such polysaccharides may have been produced by a separate reaction proceeding simultaneously or substantially simultaneously in the reaction vessel. The polysaccharides present in the enzymatic reaction may be partially cleaved by enzymes into useful oligosaccharides, leaving partially cleaved or uncleaved polysaccharides, which may include, but are not limited to, cellulose, xylan (such as glucuronoxylan, arabinoxylan, or glucuronoarabinoxylan), mannan (such as glucomannan, galactomannan, or galactoglucomannan), mixed-linkage glucan, xyloglucan chitin, chitosan, or lignocellulose.

The enzymatic reaction may be allowed to continue to run until there is from 5% to 75% undigested polysaccharide-containing feedstocks remaining, preferably 5% to 70%, preferably 5% to 65%, more preferably 5% to 55%, or more preferably 10% to 50%. This can be monitored or checked by reducing end assays, such as the anthrone assay and/or by chromatographic methods such as thin-layer chromatography and/or high-performance anion exchange chromatography.

Any substance which comprises appropriate polysaccharides may form part of the feedstock. As the foodstuff, cosmetic, and nutraceutical industries generally use a broad variety of oligosaccharides, the polysaccharides appropriate for taking part in the enzymatic reaction are not particularly limited. Feedstocks suitable for producing the oligosaccharide profile may comprise, for example, cellulose, lignocellulose, chitin, chitosan, xylan (such as glucuronoxylan, arabinoxylan, and glucuronoarabinoxylan) and/or mannan (such as glucomannan, galactomannan, or galactoglucomannan), however, any feedstock which can be suitably acted upon is envisaged. Preferably the feedstocks comprise sugar cane, corn stover, corn cob, wheat bran, wheat straw, oat hull, oat husk, hardwood, or softwood.

The feedstocks comprising such polysaccharides are also not particularly limited, as most plant matter is rich in such polymers. As such, the feedstock may comprise plant biomass such as grain, grain chaff, bean pods, seed coats, and/or other seed materials; seaweeds; corn cob, corn stover, oat husk, oat hull, straw, bagasse, miscanthus, sorghum residue, switch grass, bamboo, and/or other monocotyledonous tissue; water hyacinth, leaf tissue, roots, and/or other vegetative matter; hardwood, hardwood chips, hardwood pulp, softwood, softwood chips, softwood pulp, paper, paper pulp, cardboard, and/or other wood-based feedstocks; crab shells, squid biomass, shrimp shells, and/or other marine biomass, and/or any combination of appropriate feedstocks. Preferably, the feedstock comprises wheat straw or wood. As any given natural feedstock is likely to comprise a mixture of different polysaccharides, it will sometimes be the case that a mixture of different enzymes is beneficial. Such a mixture may comprise one or more of any other enzymes. For example, such a mixture might comprise an LPMO with an endo-glucanase, a xylanase with a lichenase, a cellobiohydrolase with a mannanase, or an endo-glucanase with a cellobiohydrolase, in which the enzyme partners are present in molar ratios preferably from 1:100 to 100:1. In addition, as many appropriate feedstocks are recalcitrant, pre-treatment of the feedstock is envisaged.

As used herein, “pre-treatment” is any process which makes a feedstock more easily acted upon by the enzymes inherent in the enzymatic reaction step. The pre-treatment can occur before the enzymatic reaction, and may comprise acid treatment by, for example, sulphuric acid, phosphoric acid, or trifluoroacetic acid; alkali treatment by, for example, potassium hydroxide, sodium hydroxide, or ammonia fiber expansion; heat treatment by, for example, hot water, hot steam, or hot acid; ionic liquid treatment, and related technologies; Alcell pulping, and related technologies; supercritical solvent, such as supercritical water treatment; and/or enzyme treatment by, for example, a hydrolase, lyase, or LPMO, or any mixture of the above processes.

After the enzymatic reaction has progressed to a desired point, the one or more oligosaccharides and the one or more polysaccharides from the enzymatic reaction mixture are separated. This process can be performed in a variety of ways depending on the composition of the biomass used and the specificity of the enzymes used. As the reaction mixture will often comprise a mixture of soluble oligosaccharides and insoluble polysaccharides, the reaction mixture may be filtered to remove insoluble matter and prepare the soluble oligosaccharide obtained for further processing.

When used herein and otherwise unqualified, “soluble,” “solubility,” and grammatical variants refer to solubility in water.

The oligosaccharides may also be separated from the polysaccharides in a number of ways. They may be isolated based on solubility, so that a composition of soluble saccharides only is extracted for further processing, and/or isolated chromatographically to produce a composition with a narrower band of oligosaccharide chain lengths. Isolation may, for example, be based on precipitation, size-exclusion chromatography, ion-exchange chromatography, or filtration, ultrafiltration, or nanofiltration. In the case that isolation based on solubility is carried out, the profile of saccharides present in the isolated composition will depend on the original enzymatic reaction, as different polysaccharides decrease in solubility with length at different rates.

Also envisaged is the further treatment of all or part of the produced oligosaccharides to produce further products before incorporation into a foodstuff, cosmetic, or nutraceutical. This further treatment may comprise any chemical, physical, or enzymatic step, such as reduction, preferably reductive amination where appropriate; oxidation, caramelization, modification with a Schiff base, or via the Maillard reaction, or by any combination of such steps, and may provide different products having properties which are improved for the desired purpose. For example, the caramelization properties, calorific value, flavor, and color may be modified. The oligosaccharides may also be purified, for example, through precipitation, size-exclusion chromatography, ion-exchange chromatography, or filtration, ultrafiltration, or nanofiltration.

Also envisaged is the further treatment of all or part of the produced polysaccharide fraction to produce products with improved properties before incorporation into a foodstuff, cosmetic, or nutraceutical. This further treatment may comprise any chemical, physical, or enzymatic step, such as alkylation or acid-treatment. The polysaccharides may also be purified, for example, through precipitation, size-exclusion chromatography, ion-exchange chromatography, or filtration, ultrafiltration, or nanofiltration.

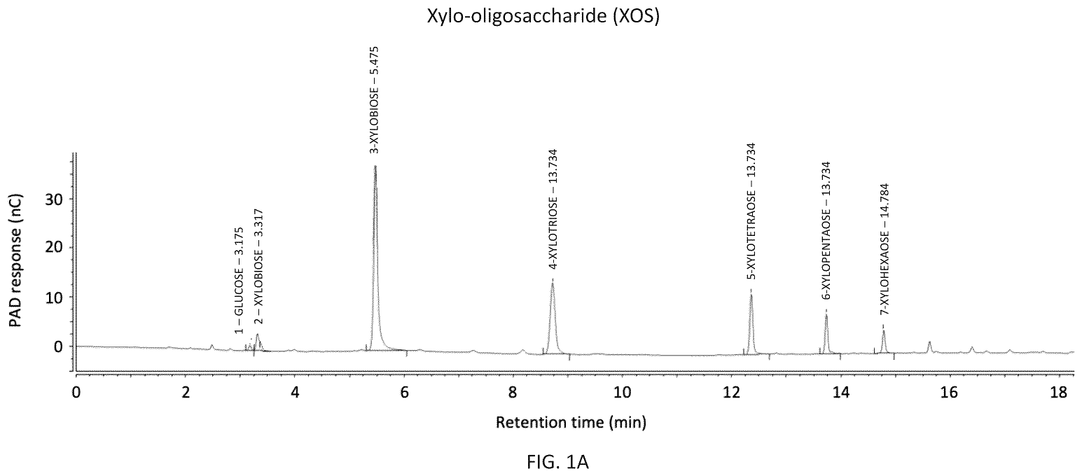

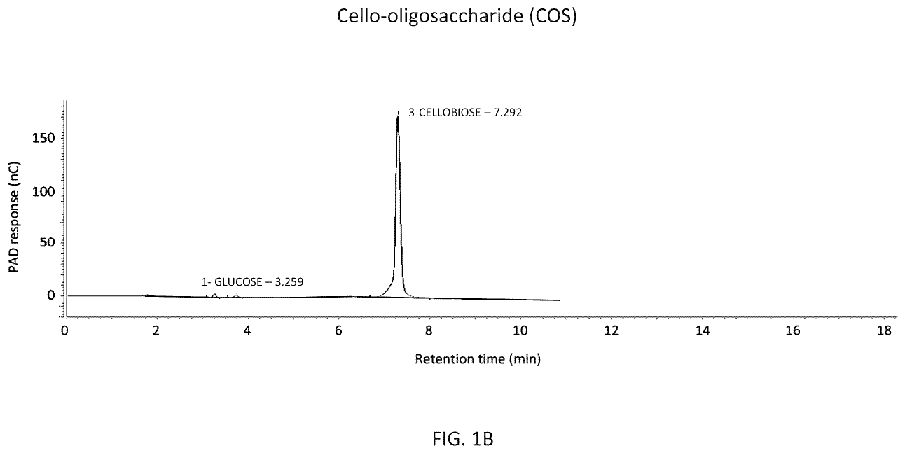

Following optional modification and/or purification of the oligosaccharide and polysaccharide fractions, all or part of the fractions are then recombined at a ratio of from 1:100 to 1:1 polysaccharide: oligosaccharide, preferably from 1:10 to 1:1, preferably from 1:90 to 1:2, preferably from 1:80 to 1:3, preferably from 1:70 to 1:4, or preferably from 1:60 to 1:5. The specific ratio may depend on the desired properties of the final ingredient as well as the modifications and purifications that have been applied to the fractions. It may not be required to recombine all of the oligosaccharide and polysaccharide isolated from the enzymatic reaction. An example of a composition that can be generated is shown in FIG. 1. As shown in FIG. 1, the composition can have one or more oligosaccharides, wherein each type of oligosaccharide may have oligosaccharides with varying degrees of polymerization.

The fractions can be recombined in a variety of ways, for example, by mixing a solution comprising all or part of the oligosaccharide fraction and a solution and/or suspension comprising all or part of the polysaccharide fraction, which may further be spray-dried, lyophilized or condensed in some other way. The fractions may also be recombined by mixing a dry form comprising all or part of the oligosaccharide fraction produced by spray-drying, lyophilization, or condensation in some other way, with a dry form comprising all or part of the polysaccharide fraction, produced by spray-drying, lyophilization, or condensation in some other way.

The oligosaccharide components of the final composition may comprise one or more of any type of oligosaccharide. Preferably they comprise cello-oligosaccharides, xylo-oligosaccharides, mixed-linkage glucan oligosaccharides, manno-oligosaccharides, xyloglucan oligosaccharides, fructo-oligosaccharides or chito-oligosaccharides, or derivatives of any of the aforementioned oligosaccharides.

Any such dry or liquid composition may be deemed an ingredient suitable for incorporation into a foodstuff, cosmetic, or nutraceutical at any stage of this process. This includes compositions that may be deemed to be an intermediate during the method, such as a composition formed after the recombining of the oligosaccharide and polysaccharide fractions prior to any further purification, optimization, drying, dissolving, or any other such steps, as well as including the final composition obtained from the method.

As described herein, dry compositions may be formed by well-known methods in the art such as spray-drying and/or lyophilization. The dry compositions can be dissolved into a solution of various liquids including water, syrups, pastes, solvents, alcohols, etc. to form the liquid composition ingredient suitable for incorporation into a foodstuff, cosmetic, or nutraceutical. Liquid compositions may be particularly useful in foods that require a smooth texture such as candy, chocolate, ice cream, cream fillings and yoghurts.

Once a composition of the oligosaccharide products suitable for the application being considered is obtained, and further treatment and/or isolation is optionally carried out, the derivation of a foodstuff, cosmetic, or nutraceutical from the composition can furnish a very broad array of potential uses. The ingredients as described herein, can be useful in applications in which oligosaccharides, sugar, bulking sweeteners, low-intensity sweeteners, or other related food ingredients are conventionally used.

In some embodiments, a method for producing a foodstuff, cosmetic, or nutraceutical ingredient is described. The ingredient may comprise one or more oligosaccharides and one or more polysaccharides. The method may comprise the steps of:
a) forming the one or more oligosaccharides and the one or more polysaccharides by an enzymatic reaction, said enzymatic reaction comprising the step of contacting, in a solution or suspension, one or more polysaccharide-cleaving enzymes and one or more feedstocks, wherein the one or more feedstocks comprise sugar cane, sugar cane bagasse, corn stover, corn cob, oat husk, oat hull, wheat bran, wheat straw, hardwood, softwood, cellulose, chitin, chitosan, xylan, xyloglucan, mixed-linkage glucan, mannan or lignocellulose;
b) separating the one or more oligosaccharides and the one or more polysaccharides from the enzymatic reaction mixture; and then
c) recombining the one or more oligosaccharides and the one or more polysaccharides to form the ingredient.

The one or more oligosaccharides may comprise cello-oligosaccharides, xylo-oligosaccharides, mixed-linkage glucan oligosaccharides, manno-oligosaccharides, xyloglucan oligosaccharides, fructo-oligosaccharides or chito-oligosaccharides, or derivatives of any of the aforementioned oligosaccharides.

The polysaccharide-cleaving enzymes may be one of cellulase, xylanase, xyloglucanase, endo-glucanase, cellobiohydrolase, mannanase, lichenase or a lytic polysaccharide monooxygenase (LPMO), preferably selected from the group consisting of AA9, AA10, AA11, AA13, AA14 and AA15. The polysaccharide-cleaving enzyme may be prepared from T. reesei fungi and/or the enzymatic reaction runs until there is 5-75% undigested polysaccharide-containing feedstocks remaining, preferably 5-65%, more preferably 5-50%.

The one or more polysaccharides may comprise cellulose, xylan, mannan, mixed-linkage glucan, chitin, chitosan or lignocellulose. The polysaccharide-containing feedstock may be pre-treated by acid, alkali, heat, pressure, and/or enzyme treatment. The polysaccharide-cleaving enzyme(s) may be operably linked to a catalytic or non-catalytic module, preferably wherein the polysaccharide-cleaving enzyme may be operably linked to a non-catalytic module and the non-catalytic module is a carbohydrate-binding module.

In this embodiment, after the separating of the one or more oligosaccharides and one or more polysaccharides, the one or more oligosaccharides and one or more polysaccharides may be: purified; and/or undergo chemical, physical, or enzymatic treatment, such as reduction, oxidation, caramelization, or Maillard reaction; and/or may be recombined by combining a spray-dried powder of oligosaccharides with a dried polysaccharide powder.

In some embodiments, the ingredient comprises three or more oligosaccharides of different molecular weights, wherein the method may comprise forming the three or more oligosaccharides by an enzymatic reaction, said enzymatic reaction comprising the step of contacting, in a solution or suspension, one or more polysaccharide-cleaving enzymes and one or more feedstocks.

At least one of the polysaccharide-cleaving enzymes may comprise one of cellulase, xylanase, xyloglucanase, endo-glucanase, cellobiohydrolase, mannanase, lichenase or a lytic polysaccharide monooxygenase (LPMO) and the polysaccharide-cleaving enzyme may be prepared from T. reesei fungi.

The composition may comprise monosaccharides at <5% w/w of total oligosaccharide component (comprising glucose, xylose and/or mannose), disaccharides at >20% w/w of total oligosaccharide component (comprising cello-, xylo- and/or manno-oligosaccharides), trisaccharides at >5% w/w of total oligosaccharide component (comprising cello-, xylo- and/or manno-oligosaccharides) and tetrasaccharides at >2% w/w of total oligosaccharide component (comprising cello-, xylo- and/or manno-oligosaccharides).

The oligosaccharides may be purified; and/or undergo chemical, physical, or enzymatic treatment, such as reduction, oxidation, caramelization, or Maillard reaction; and/or are recombined by combining a spray-dried powder of oligosaccharides with a dried polysaccharide powder.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### EXAMPLES

The following illustrative examples are representative of embodiments of the compositions and methods described herein and are not meant to be limiting in any way.

### Example 1—Analysis of the Oligosaccharide Compositions Used in Examples 2-4

Xylo-oligosaccharide (XOS) and cello-oligosaccharide (COS) compositions used in Examples 2-4 were analyzed by high performance anion exchange chromatography (HPAEC—PAD) with pulsed amperometric detection. Results are shown in FIG. 1A and FIG. 1B.

### Example 2—Optimizing the Ratio of Cello-Oligosaccharide to Xylo-Oligosaccharide to Promote Freezing Point Depression

Compositions comprising 18 g saccharides (XOS:COS ratios of 100:0, 95:5, 90:10, 85:15, 80:20, 75:25, 70:30) in water at final volume of approximately 20 mL were created by dissolving saccharides in water in test tubes and heating to dissolve where necessary. Compositions had final concentrations between 61% w/w and 71% w/w (e.g., 100:0 at 61% w/w, 95:5 at 68% w/w, 80:20 at 71% w/w, 70:30 at 78% w/w)

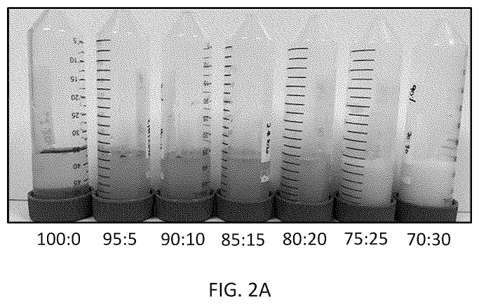

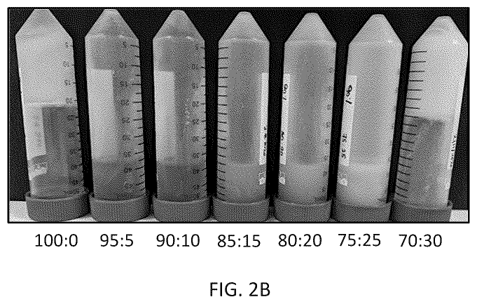

Once the compositions were at the correct volume the test tubes were turned on their heads, showing that all of the solutions/suspensions were free flowing liquids (FIG. 2A). The higher COS-containing compositions, especially 75:25 and 70:30, were clearly suspensions at this point, whereas the higher XOS compositions were dissolved solutions.

The test tubes were then placed upright and incubated at −15° C. for 2 days.

The test tubes were then turned on their heads, showing that compositions 95:5, 90:10, 85:15, 80:20 and 75:25 had not frozen, while 100:0 and 70:30 had (FIG. 2B).

Results indicate that there is an optimum to freezing point suppression. Interactions between COS and XOS may be important for the effect.

### Example 3: Frozen Whipped Cream Using a Xylo/Cello Oligosaccharide Mixture

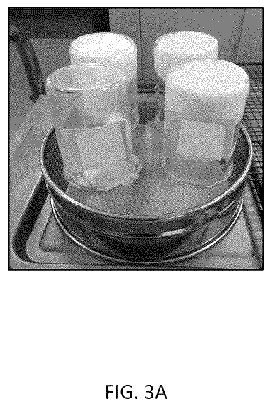

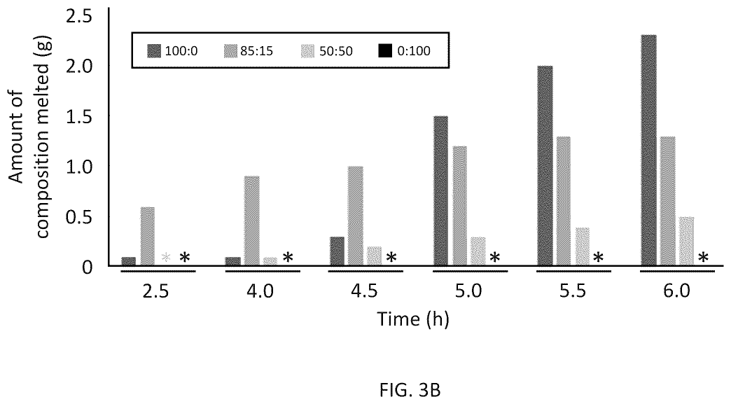

50 g saccharide mix (XOS: Cellobiose (CB)—100:0, 85:15, 70:30, 50:50, 30:70, 0:100; icing sugar as control) was whipped with 150 g of double cream for 45 sec at speed 5 using a Kenwood mixer. After whipping, 50 g was piped into a glass beaker as can be seen in FIG. 3A. Samples were frozen immediately after piping and left at −16° C. for 16 hours. All samples were taken out of the freezer at the same time. Beakers with frozen cream were placed upside-down on the sieve with small pore size (FIG. 3A). Pre-weighed weighing boats were put under the rack to collect the melting sample. Samples were incubated at 30° C. Amounts of melted sample were recorded after 2.5, 4, 4.5, 5, 5.5 and 6 hours of incubation (FIG. 3B)

The 85:15 composition was quickest to melt. The 100:0 composition took longer to melt, but once it did, it produced more liquid than the 85:15 compositions after 5 hours. The 50:50 composition was next slowest to melt. The 0:100 composition did not produce any liquid during the experiment.

### Example 4: Textural Attributes of Ice Cream Using a Xylo/Cello Oligosaccharide Mixture

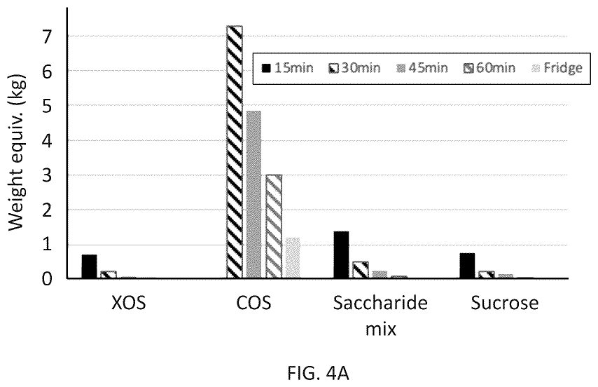

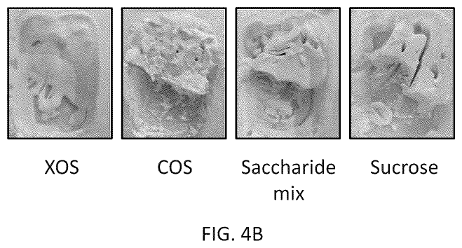

Three egg yolks, 52 g saccharides (XOS, COS, a 75:10:15 mix of XOS:COS:MCC, sucrose) & 25 mL milk were whisked together before being left for 15 minutes to hydrate. 79 mL milk, 200 g double cream & 15 g vanilla bean paste were heated until almost boiling. The egg yolk-containing mixture was then whisked into the double cream-containing mixture, before 1 g cornflour was further added. The mixture was then whisked until smooth and frothy. The total mixture was then transferred into a saucepan and heated without boiling until thickened. The mixture was then cooled for 2 hours before churning to age. The mixture was churned in an ice cream maker for 15 minutes until it resembled thick cream, after which it was transferred to a plastic container and frozen in a freezer. Above-described ice-creams were taken out of the freezer and firmness of the ice-creams was analyzed using a Stable Micro Systems texture analyzer controlled using Exponent Connect software. Samples were taken out of the freezer and kept at room temperature. Texture was analyzed after 15, 30, 45 and 60 minutes—30 g of sample was scooped out of the container into a texture analyzer back extrusion sample container (FIG. 4B). At each time point, temperature of the sample was recorded. Additionally, 40 g of sample was scooped into a beaker after 15 minutes at room temperature and refrigerated for 1.5 hours. After 1.5 hours of refrigeration, temperature was recorded, and texture of each sample was analyzed as can be seen in FIG. 4B. Those results are shown as “Fridge” in FIG. 4A. Details of texture analysis method are shown in Table 1B. The COS sample after 15 min at room temp was still too hard to be scooped out of the container (therefore time point missing).

Results show similar comparable firmness for sucrose, XOS and saccharide (75:10:15 mix of XOS:COS:MCC) composition ice creams. COS ice-cream was the firmest at all time points and did not completely melt even after 60 minutes at room temperature.

TABLE 1B
Settings of texture analysis

| Mode: | Measure Force in Compression | |
|---|---|---|
| Option: | Return to Start | |
| Pre-Test Speed: | 2.0 | mm/s |
| Test Speed: | 1.0 | mm/s |
| Post-Test Speed: | 10.0 | mm/s |
| Distance: | 10 | mm |
| Trigger Type: | Auto - 10 g | |
| Tare Mode: | Auto | |
| Data Acquisition Rate: | 400 | pp |
| Accessory: | Back Extrusion Cell (A/BE) with 35 mm disc | |
| Height calibrated to: | 90 | mm |

### Example 5—Freezing Point Depression

Compositions comprising 20% w/w, 40% w/w, 60% w/w, 70% w/w, 80% w/w saccharides (XOS:COS ratios of 100:0, 80:20, 50:50, 0:100) in water were created by dissolving and concentrating saccharides in water with heat and stirring, to the desired final concentration.

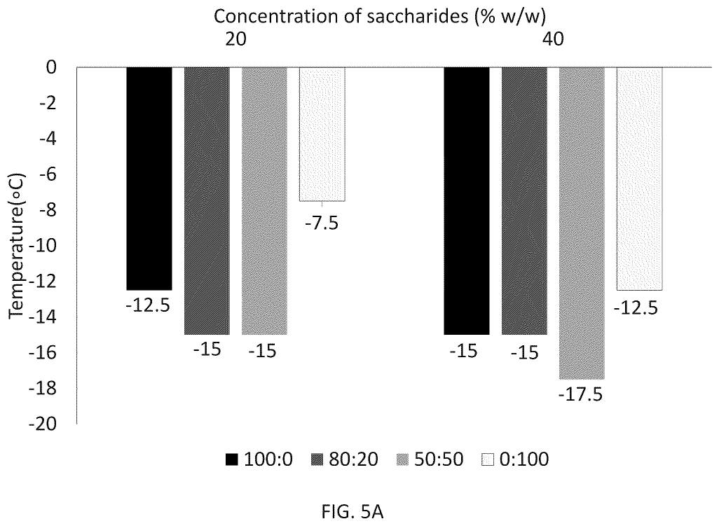

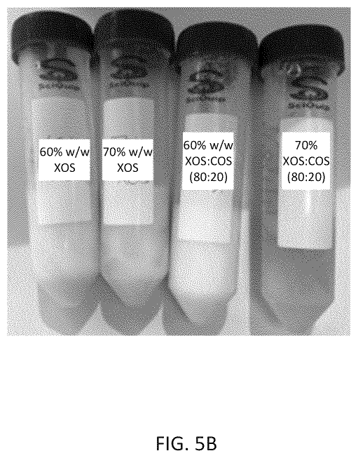

The test tubes were placed upright and incubated at decreasing temperatures. The freezing temperature of the solution was measured using a thermometer placed in the solution, and temperature taken as the temperature when an ice lattice was formed (FIG. 5A). Results indicate that mixtures of XOS:COS depress freezing point at 20% w/w and 40% w/w saccharides. At 60% and 70% w/w saccharides XOS:COS ratios of 100:0 and 80:20 showed freezing point suppression below −22.5° C. At 60%, 70% and 80% w/w saccharides XOS:COS ratios of 50:50 and 0:100 was supersaturated, and COS had not fully dissolved. At 80% w/w saccharides, XOS:COS ratios of 100:0 and 80:20 were supersaturated. This measurement process took approximately 2 hours to reach −22.5° C. After 2 days incubation at −22.5° C. the 60% w/w and 70% w/w compositions had all frozen except the 70% w/w 80:20 XOS:COS composition in which only small ice crystals formed at the top but for which the majority of the composition remained unfrozen (FIG. 5B).

### Example 6—Testing Freezing Point Depression with a Different XOS:COS Composition

Compositions comprising 70% w/w and 90% w/w of a different XOS:COS mixture in water were created by dissolving and concentrating this different XOS:COS mixture in water with heat and stirring, to the desired final concentration.

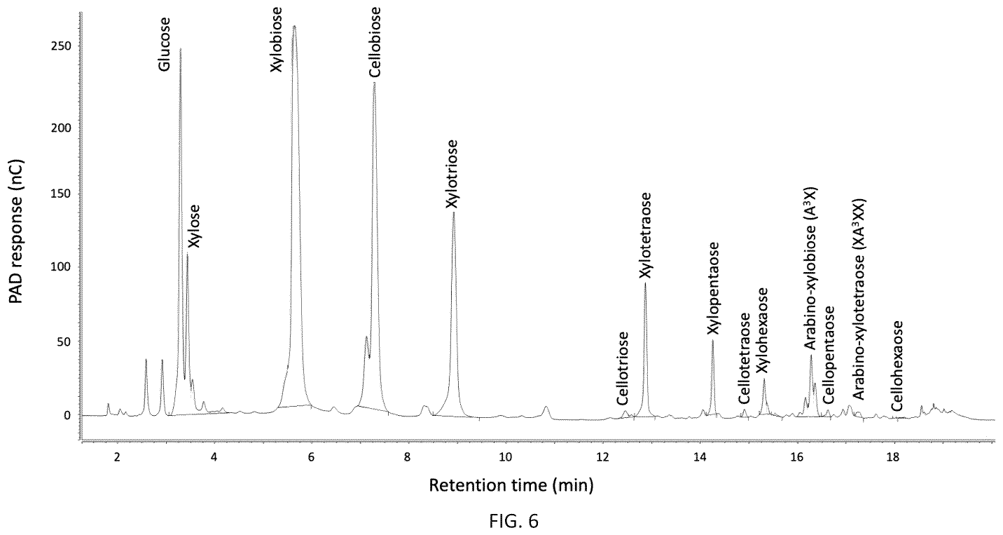

The composition was analyzed by high performance anion exchange chromatography with pulsed amperometric detection (HPAEC-PAD). Results are shown in FIG. 6 and quantitation of identified oligosaccharides is shown in Table 2. The compositions contained more large xylo-oligosaccharides (e.g. arabino-xylotetraose (XA3XX), arabino-xylotriose (A2XX)) and cello-oligosaccharides (e.g. cellotriose, cellotetraose, cellopentaose, cellohexaose).

Both compositions were incubated at −15° C. for approximately 2 hours, after which the 90% w/w composition froze, but after which the 70% w/w composition didn't.

TABLE 2
Amounts of saccharides in a XOS:COS composition

| | Relative amount |
|---|---|
| | (percentage of total |
| Saccharide | identified saccharides) |
| Xylose | 3.18% |
| Xylobiose | 34.05% |
| Xylotriose | 17.53% |
| Xylotetraose | 8.98% |
| Xylopentaose | 3.80% |
| Xylohexaose | 2.72% |
| Arabino-xylobiose (A³X) | 1.21% |
| Arabino-xylotetraose (XA³XX) | 0.28% |
| Glucose | 7.13% |
| Cellobiose | 20.64% |
| Cellotriose | 0.08% |
| Cellotetraose | 0.31% |
| Cellopentaose | 0.01% |
| Cellohexaose | 0.07% |

### Example 7—Analysis of the Fructo-Oligosaccharides (FOS) Used in Example 8

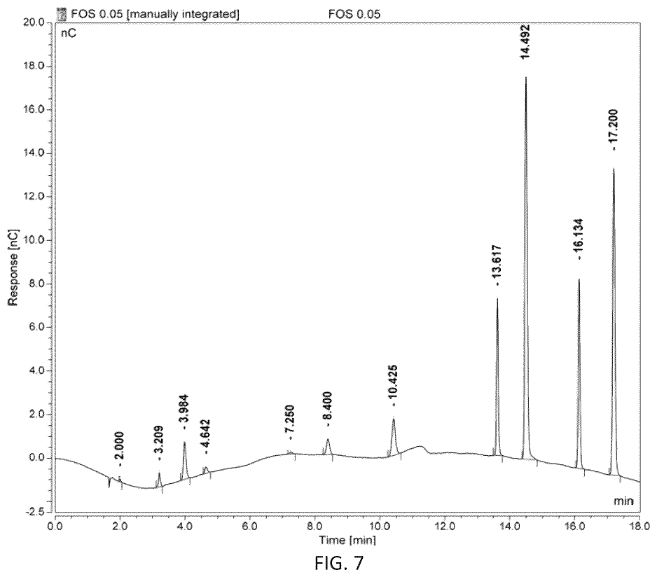

Fructo-oligosaccharide (FOS) used in Examples 8 was analyzed by high performance anion exchange chromatography with pulsed amperometric detection (HPAEC-PAD). Results are shown in FIG. 7.

### Example 8—Freezing Point Depression Different Concentrations for Fructo-Oligosaccharides with Cello-Oligosaccharides (FOS:COS)

Compositions comprising 20% w/w, 40% w/w, 60% w/w, 70% w/w, 80% w/w saccharides (FOS:COS ratios of 100:0, 80:20, 50:50, 0:100) in water were created by dissolving and concentrating saccharides in water with heat and stirring, to the desired final concentration.

The test tubes were placed upright and incubated at decreasing temperatures. The freezing temperature of the solution was measured using a thermometer placed in the solution, and temperature taken as the temperature when ice crystals were first observed and when an ice lattice formed.

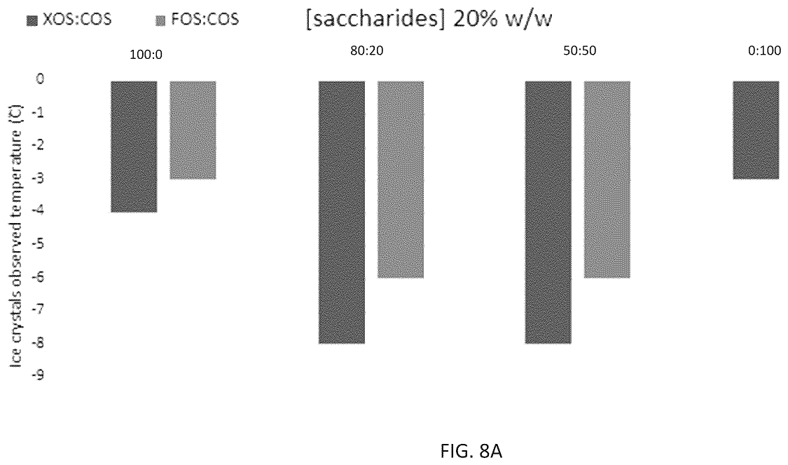

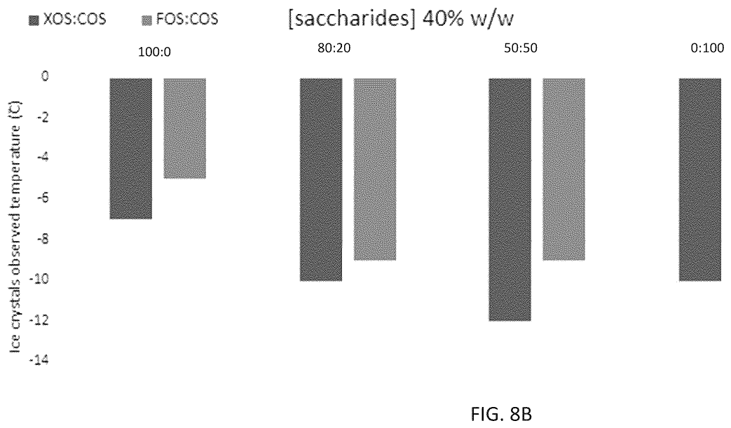

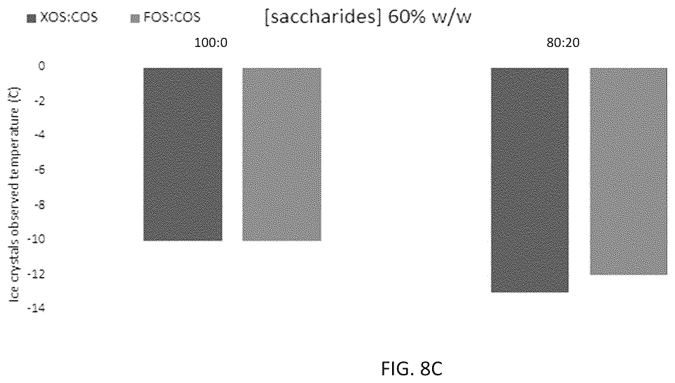

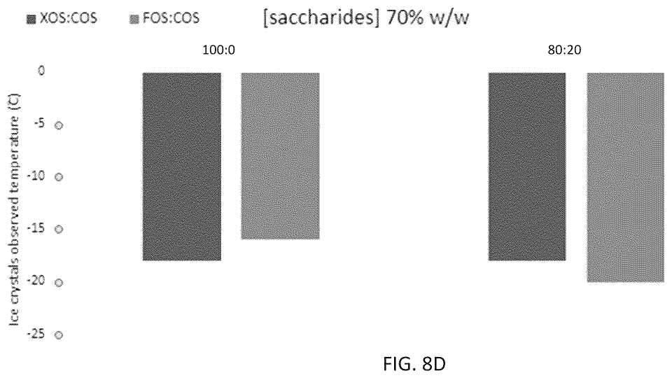

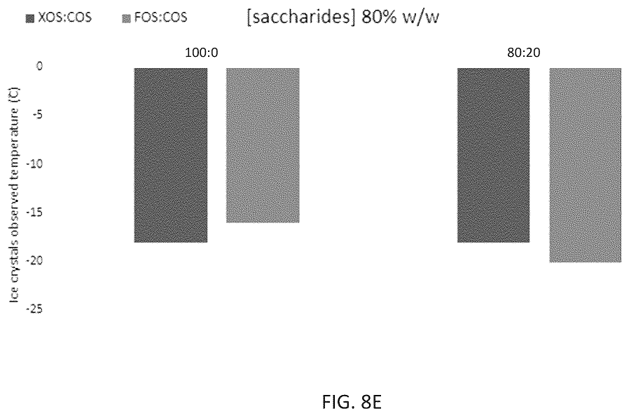

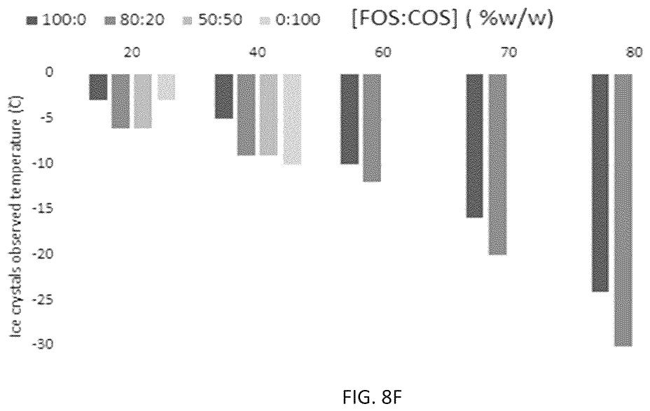

Results are shown in Tables 3A and 3B and in FIGS. 8A-F. Note that the left to right ordering of the bars on each graph of FIGS. 8A-F are presented in the same order as the figure legends above each graph.

Results indicate that freezing point depression (temperature of ice crystal observation) of mixtures of FOS:COS increase with the increase of the saccharides concentration.

At 60% and 70% w/w saccharides FOS:COS ratios of 100:0 and 80:20 showed freezing point suppression below −10° C. At 60%, 70% and 80% w/w saccharides FOS:COS ratios of 50:50 and 0:100 were supersaturated, and COS had not fully dissolved. Concentrations lower than 60% w/w saccharides show a lower freezing temperature for XOS:COS mixtures compared to FOS:COS, as demonstrated by the data in Tables 3A and 3B.

TABLE 3A
Non-colligative freezing point modulation by example
modulator compositions comprising a xylo-oligosaccharide
and a cello-oligosaccharide

| Saccharide solution | | Ice crystals | Freezing |
|---|---|---|---|
| concentration | | observed | temperature |
| (% w/w) | XOS:CB | (° C.) | (° C.) |
| 20 | 100:0 | −4 | −10 |
| | 80:20 | −8 | −13 |
| | 50:50 | −8 | −12 |
| | 0:100 | −3 | −8 |
| 40 | 100:0 | −7 | −15 |
| | 80:20 | −10 | −17 |
| | 50:50 | −12 | −18 |
| | 0:100 | −10 | −13 |
| 60 | 100:0 | −10 | −18 |
| | 80:20 | −13 | −22 |
| | 50:50 | | |
| | 0:100 | | |
| 70 | 100:0 | −18 | −24 |
| | 80:20 | −18 | −28 |
| | 50:50 | | |
| | 0:100 | | |
| 80 | 100:0 | −22 | −30 |
| | 80:20 | −30 | −30 |
| | 50:50 | | |
| | 0:100 | | |

TABLE 3B
Non-colligative freezing point modulation by example
modulator compositions comprising a fructo-oligosaccharide
and a cello-oligosaccharide

| Saccharide solution | | Ice crystals | Freezing |
|---|---|---|---|
| concentration | | observed | temperature |
| (% w/w) | FOS:CB | (° C.) | (° C.) |
| 20 | 100:0 | −3 | −10 |
| | 80:20 | −6 | −14 |
| | 50:50 | −6 | −12 |
| | 0:100 | −3 | −8 |
| 40 | 100:0 | −5 | −14 |
| | 80:20 | −9 | −16 |
| | 50:50 | −9 | −15 |
| | 0:100 | −10 | −13 |
| 60 | 100:0 | −10 | −16 |
| | 80:20 | −12 | −20 |
| | 50:50 | | |
| | 0:100 | | |
| 70 | 100:0 | −16 | −22 |
| | 80:20 | −20 | −28 |
| | 50:50 | | |
| | 0:100 | | |
| 80 | 100:0 | −24 | −30 |
| | 80:20 | −30 | −30 |
| | 50:50 | | |
| | 0:100 | | |

### Example 9—Textural Attributes of Vegan Ice Cream Using a Xylo/Cello Oligosaccharide Mixture

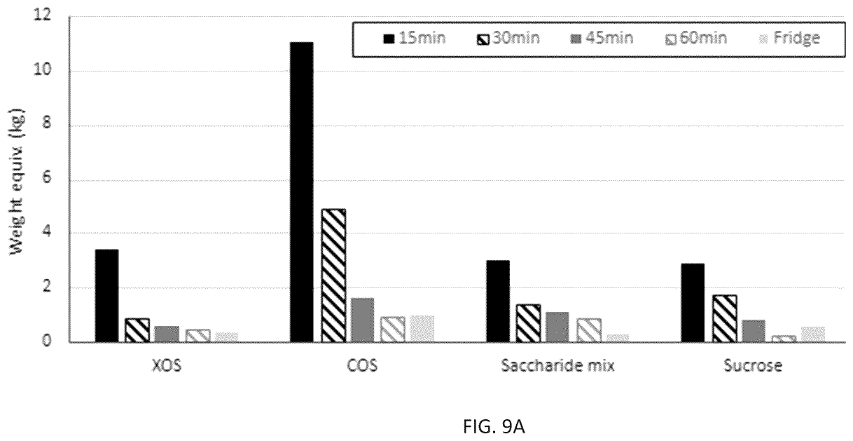

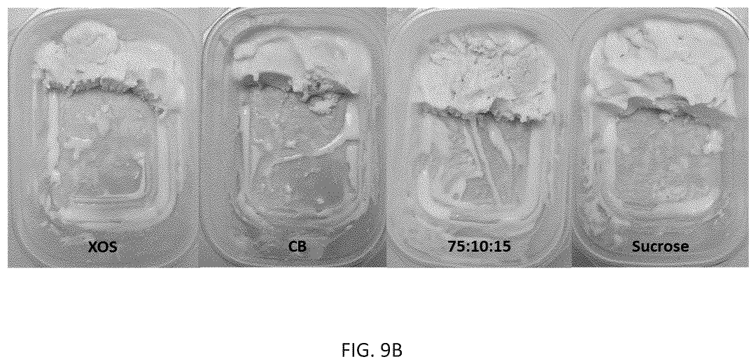

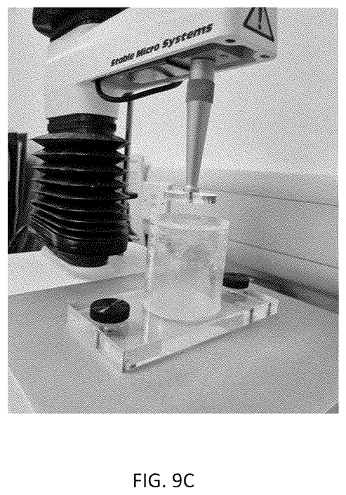

XOS:COS—88.25/11.75 (together with MCC—microcrystalline cellulose) had similar texture properties as the sucrose control in a vegan ice cream formulation. 250 g of canned coconut milk and 4.4 g of vanilla were added to a thermomix and were mixed at 90° C. for 2 min on speed level 2. Separately in a mixing bowl, 250 g of non-dairy coconut milk, 18.8 g of corn flour and 57.5 g saccharides (XOS; COS; a 75:10:15 mix of XOS:COS:MCC; sucrose) were whisked until smooth. The whisked mixture was added to the mixture in the thermomix, and everything was mixed at 80° ° C. for 2 min on speed level 2. The obtained mixture was then cooled to refrigerator temperature (4-6° C.) for 1.5 hours before churning. The mixture was churned in an ice cream maker for 20 minutes until it resembled thick cream, after which it was transferred to a plastic container and frozen in a freezer. Above ice-creams were taken out of the freezer and analyzed with texture analyzer for firmness using a Stable Micro Systems texture analyzer (FIG. 9C) controlled using Exponent Connect software. The texture analyzer settings were as described in Example 4, Table 1B, Samples were taken out of the freezer and kept at room temperature. Texture was analyzed after 15, 30, 45 and 60 minutes—30 g of sample was scooped out of the box into a texture analyzer sample container (FIG. 9B). At each time point, temperature of the sample was recorded. Additionally, 40 g of sample was scooped into a beaker after 15 minutes at room temperature and refrigerated for 1.5 hours. After 1.5 hours of refrigeration, temperature was recorded, and texture of each sample was analyzed as can be seen in FIG. 9B. Those results are shown as “Fridge” in FIG. 9A.

Results show very similar firmness values for sucrose and saccharide mix ice-creams at all time points. Similar results as Example 4 were observed, including COS samples showing higher firmness values. XOS samples without COS or MCC had a higher firmness value initially, then were less firm after storing at room temperature for 30 minutes.

1-73. (canceled)

74. A non-colligative freezing point modulator comprising an oligosaccharide component, the oligosaccharide component comprising:
5-50% cello-oligosaccharides with a degree of polymerization of from 2-6, by dry w/w of the oligosaccharide component, and
50-95% one or more oligosaccharide(s) by dry w/w of the oligosaccharide component, the one or more oligosaccharide(s) independently selected from the group of:
i. xylo-oligosaccharides;
ii. mannan-oligosaccharides;
iii. mixed-linkage glucan oligosaccharides;
iv. galacto-oligosaccharides;
v. malto-oligosaccharides; and
vi. fructo-oligosaccharides;
wherein the one or more oligosaccharide(s) have a degree of polymerization of from 2-12, and a 20% w/w solution of the oligosaccharide component in water has a freezing point of lower than −4° C.

75. The non-colligative freezing point modulator of claim 74, wherein the ratio of the one or more oligosaccharide(s) to the cello-oligosaccharides is 80:20 to 50:50 w/w.

76. The non-colligative freezing point modulator of claim 74, wherein the one or more oligosaccharide(s) comprise xylo-oligosaccharides and/or fructo-oligosaccharides.

77. The non-colligative freezing point modulator of claim 74, wherein a 20% w/w solution of the non-colligative freezing point modulator in water has a freezing point lower than −5° C.

78. The non-colligative freezing point modulator of claim 74, wherein greater than 1% by dry w/w of the cello-oligosaccharides have a degree of polymerization of 3 or more.

79. The non-colligative freezing point modulator of claim 74, wherein the non-colligative freezing point modulator further comprises one or more insoluble polysaccharide(s).

80. The non-colligative freezing point modulator of claim 79, wherein the freezing point modulator comprises a mixture of xylo-oligosaccharides, cello-oligosaccharides, and insoluble polysaccharides, in a ratio of 75:10:15 w/w.

81. The non-colligative freezing point modulator of claim 74, wherein the one or more oligosaccharide(s) comprise at least 10% by dry w/w oligosaccharides with a degree of polymerization of between 3-12.

82. A chilled confection comprising a homogeneous, a colloidal, or an emulsified mixture, the homogenous, colloidal, or emulsified mixture comprising:
a) a base medium component comprising an aqueous based composition, a fat-based composition or an emulsified composition, wherein the base medium component is in a liquid or a semi-solid phase at 0° C.,
b) a non-colligative freezing point modulator comprising an oligosaccharide component, comprising:
I) 5-50% cello-oligosaccharides with a degree of polymerization of from 2-6, by dry w/w of the oligosaccharide component, and
II) 50-95% one or more oligosaccharide(s) by dry w/w of the oligosaccharide component, the one or more oligosaccharide(s) independently selected from the group of:
i. xylo-oligosaccharides;
ii. mannan-oligosaccharides;
iii. mixed-linkage glucan oligosaccharides;
iv. galacto-oligosaccharides;
v. malto-oligosaccharides; and
vi. fructo-oligosaccharides;
wherein the one or more oligosaccharide(s) have a degree of polymerization of from 2-12, and a 20% w/w solution of the oligosaccharide component in water has a freezing point of lower than −4° C.

83. The chilled confection of claim 82, wherein the confection is a frozen whipped cream or an ice cream.

84. The chilled confection of claim 82, wherein the confection has a texture that is substantially indistinguishable from a reference confection wherein the non-colligative freezing point modulator is substituted for sucrose.

85. The chilled confection of claim 82, wherein the chilled confection is substantially free of antifreeze proteins.

86. The chilled confection of claim 82, wherein the chilled confection comprises 1% to 80% saccharides by w/w of the chilled confection.

87. The chilled confection of claim 82, wherein the saccharides comprise at least 5% cello-oligosaccharides by dry w/w of the saccharides.

88. The chilled confection of claim 82, wherein the base medium component comprises at least one of a cream or a milk.

89. The chilled confection of claim 82, wherein the firmness of the chilled confection being less than the firmness of ice at 0° C., and/or the springiness of the chilled confection being greater than the springiness of ice at 0° C.

90. The chilled confection of claim 82, wherein greater than 30% by dry w/w of the cello-oligosaccharides comprise cellobiose.

91. The chilled confection of claim 82, wherein less than 60% by dry w/w of the one or more oligosaccharide(s) of the non-colligative freezing point modulator comprise xylobiose.

92. The chilled confection of claim 82, wherein the chilled confection comprises less than 20% monosaccharides by w/w of the chilled confection.

93. The chilled confection of claim 82, wherein the chilled confection comprises less than 60% disaccharides by w/w of the chilled confection.

94. A method of making a chilled confection comprising:
(a) combining one or more ingredient(s) of a non-colligative freezing point modulator with an aqueous-based, fat-based, or emulsified medium to form a homogenous, colloidal or emulsified mixture comprising a non-colligative freezing point modulator; and
(b) cooling the mixture to a temperature lower than 0° ° C. to form the chilled confection;
wherein the combining comprises mechanical mixing and the non-colligative freezing point modulator comprises an oligosaccharide component comprising:
I) 5-50% cello-oligosaccharides with a degree of polymerization of from 2-6, by dry w/w of the oligosaccharide component; and
II) 50-95% one or more oligosaccharide(s) by dry w/w of the oligosaccharide component, the one or more oligosaccharide(s) having a degree of polymerization of from 2-12 and each independently being selected from the group of:
i. xylo-oligosaccharides;
ii. mannan-oligosaccharides;
iii. mixed-linkage glucan oligosaccharides;
iv. galacto-oligosaccharides;
v. malto-oligosaccharides; and
vi. fructo-oligosaccharides.

95. The method of claim 94, wherein the chilled confection is a semi-solid at 0° C.

96. The method of claim 94, wherein a plurality of the one or more ingredient(s) of a non-colligative freezing point modulator are combined prior to the combining of (a).


SEQUENCE LISTING (25 sequences)

SEQ ID NO: 1 - protein, 293 aa, Podospora anserine
MKGLLSVAALSLAVSEVSAHYIFQQLSTGSTKHGVFQYIRQNTNYNSPVTDLSSNDLRCNEGGASGANTQTVTVRAGDSFTFHLDTPVYHQGPVSVYLSKAPGSASSYDGSGTWFKIKDWGPTFPGGQWTLAGSYTAQLPSCITDGEYLLRIQSLGIHNPYPAGTPQFYISCAQIKVTGGGSVNPSGVAIPGAFKATDPGYTANIYSNFNSYTVPGPSVFSCGSNGGGSSPVEPQPQPTTTLVTSTRAPVATQPAGCAVAKWGQCGGNGWTGCTTCAAGSTCNTQNAYYHQCV

SEQ ID NO: 2 - protein, 242 aa, Bacillus subtilis
MPYLKRVLLLLVTGLFMSLFAVTATASAQTGGSFFDPFNGYNSGFWQKADGYSNGNMFNCTWRANNVSMTSLGEMRLALTSPAYNKFDCGENRSVQTYGYGLYEVRMKPAKNTGIVSSFFTYTGPTDGTPWDEIDIEFLGKDTTKVQFNYYTNGAGNHEKIVDLGFDAANAYHTYAFDWQPNSIKWYVDGQLKHTATNQIPTTPGKIMMNLWNGTGVDEWLGSYNGVNPLYAHYDWVRYTKK

SEQ ID NO: 3 - protein, 948 aa, Ruminiclostridium thermocellum
MGASIKTSIKIRTVAFVSIIAIALSILSFIPNRAYASPQRGRPRLNAARTTFVGDNGQPLRGPYTSTEWTAAAPYDQIARVKELGFNAVHLYAECFDPRYPAPGSKAPGYAVNEIDKIVERTRELGLYLVITIGNGANNGNHNAQWARDFWKFYAPRYAKETHVLYEIHNEPVAWGPPYSSSTANPPGAVDMEIDVYRIIRTYAPETPVLLFSYAVFGGKGGAAEALKDIRAFNKAVFGNENAVWTNEAVAFHGYAGWQETTIAVEELLKAGYPCFMTEYAGGAWGSGMGGLDVELTYELERLGVSWLTFQYIPPTGVSDDVTKPEYFSALVENSGLSWTPDYGNWPAARGVYGNGGLARETATWINNFLTGTTRIEAEDFDWGGNGVSYYDTDSVNVGGQYRPDEGVDIEKTSDTGGGYNVGWISEGEWLEYTIRVRNPGYYNLSLRVAGISGSRVQVSFGNQDKTGVWELPATGGFQTWTTATRQVFLGAGLQKLRINALSGGFNLNWIELSPISTGTIPDGTYKFLNRANGKTLQEVTGNNSIITADYKGITEQHWKIQHIGGGQYRISSAGRGWNWNWWMGFGTVGWWGTGSSTCFIISPTGDGYYRIVLVGDGTNLQISSGDPSKIEGKAFHGGANQQWAILPVSAPAFPTGLSAVLDSSGNTANLTWNAAPGANSYNVKRSTKSGGPYTTIATNITSTNYTDTGVATGTKYYYVVSAVSNGVETLNSAEAILQYPKLTGTVIGTQGSWNNIGNTIHKAFDGDLNTFFDGPTANGCWLGLDFGEGVRNVITQIKFCPRSGYEQRMIGGIFQGANKEDFSDAVTLFTITSLPGSGTLTSVDVDNPTGFRYVRYLSPDGSNGNIAELQFFGTPAGEENDDVHLGDINDDGNINSTDLQMLKRHLLRSIRLTEKQLLNADTNRDGRVDSTDLALLKRYILRVITTL

SEQ ID NO: 4 - protein, 443 aa, Gonapodya prolifera
MARLSSLIALVLAFVAVSAPALAARGRPRLNGKTFVADSGVPLRGPFTSTEWTPAVPAANIANMRNYNFNAIHLYAETFDPNYPAAGSQKPGYAATRVDQIVAATKAANMYVVIVLANGANNGKFNLNYAKDFWSFYAARYKNETHVIYEIHNEPVQWGPPYISSTQSPGAVSMNADCYKIIRAVAPDTPVLLFTYASIGGGSSAAGAVKDAQSFNTAVFGNANAQWTNEAIAIHGYWGAQGASDAAKALNAAGFSVVLTEFAAATSPTSPNGGQDTVLTGFMEQQGVSWLTFLHVPPTGVSGDVTDPNQYTNRMTAAGIGFDRDPGLNAVGGGQAAPVPVPAPAPVPSPVPAPVPAVPAVRTTTARPAPSPSPVPAPVPAPAPVPAPVPAPVPAPVPAPVPAPVPASPAATTTRRHRTRPPRTTTAPAVPAPPPAATPKVCG

SEQ ID NO: 5 - protein, 413 aa, Dickeya chrysanthemi
MNGNVSLWVRHCLHAALFVSATAGSFSVYADTVKIDANVNYQIIQGFGGMSGVGWINDLTTEQINTAYGSGVGQIGLSIMRVRIDPDSSKWNIQLPSARQAVSLGAKIMATPWSPPAYMKSNNSLINGGRLLPANYSAYTSHLLDFSKYMQTNGAPLYAISIQNEPDWKPDYESCEWSGDEFKSYLKSQGSKFGSLKVIVAESLGFNPALTDPVLKDSDASKYVSIIGGHLYGTTPKPYPLAQNAGKQLWMTEHYVDSKQSANNWTSAIEVGTELNASMVSNYSAYVWWYIRRSYGLLTEDGKVSKRGYVMSQYARFVRPGALRIQATENPQSNVHLTAYKNTDGKMVIVAVNTNDSDQMLSLNISNANVTKFEKYSTSASLNVEYGGSSQVDSSGKATVWLNPLSVTTFVSK

SEQ ID NO: 6 - protein, 422 aa, Bacillus subtilis
MIPRIKKTICVLLVCFTMLSVMLGPGATEVLAASDVTVNVSAEKQVIRGFGGMNHPAWAGDLTAAQRETAFGNGQNQLGFSILRIHVDENRNNWYKEVETAKSAVKHGAIVFASPWNPPSDMVETFNRNGDTSAKRLKYNKYAAYAQHLNDFVTFMKNNGVNLYAISVQNEPDYAHEWTWWTPQEILRFMRENAGSINARVIAPESFQYLKNLSDPILNDPQALANMDILGTHLYGTQVSQFPYPLFKQKGAGKDLWMTEVYYPNSDTNSADRWPEALDVSQHIHNAMVEGDFQAYVWWYIRRSYGPMKEDGTISKRGYNMAHFSKFVRPGYVRIDATKNPNANVYVSAYKGDNKVVIVAINKSNTGVNQNFVLQNGSASNVSRWITSSSSNLQPGTNLTVSGNHFWAHLPAQSVTTFVVNR

SEQ ID NO: 7 - protein, 547 aa, Bacteroides ovatus
MKNITLLFCLFLANILLGACSGGEDEKKEMDEGKGAYALFLKKSITVSTGESQTDVVVEWAKTSWEITLGEGDIVKSVTPTSGGSNTGEKQYTKVRVSCGANSTMKKRTQTIHLFDKTNETTVDLLVEQEPPFKSVTLTVDPSVKYQPVVGFGGMYNPKIWCGDNLISASQLDKMYGAGGLGYSILRLMIYPNESDWSADVEAAKAAQANGAIIFACPWDCTDALADKITVNGKEMKHLKKENYEAYANHLIRYVTFMKEKGVNLYAISVQNEPDMEFTYWTPSEVVDFVKQYGARIRETGVKLMSPEACGMQPEYTDPIINNAEAFAQTDILAGHLYQGFTDLSSGYVKNRHDYICGVYSRIQGKTWWMTEHLFNDGENSDDSSKWEFLKWQYSLNHLGKEIHMCMEGYCSAYIYWYLKRFYGLMGDTDKRSPTSEGEITKNGYIMAHYAQYATETTRIKVVTNNEEVCATAYWDEKTGEVTIVLLNLNGASQWLEIPLAGIKKASAVETNETKNMEVIDTGLMESAEGITVLLSANSITSVRLTF

SEQ ID NO: 8 - protein, 502 aa, Bacteroides ovatus
MEKQSFSDGLFSPLGIKRVIFMLVLLTTSFISCSNSDEKGGSLEVAQEYRNLEFDARGSRQTIQIDGPAEWHISTSESWCKSSHTIGEGKQYVNITVEANDTQKERTATVTVSASGAPDIIINVKQSLYSVPAYDEYIAPDNTGMRDLTSMQLSALMKAGVNVGNTFEAVIVGNDGSLSGDETCWGNPTPNKVLFEGIKAAGFDVVRIPVAYSHQFEDAATYKIKSAWMDKVEAAVKAALDAGLYVIINIHWEGGWLNHPVDANKEALDERLEAMWKQIALRFRDYDDRLLFAGTNEVNNDDANGAQPTEENYRVQNGFNQVFVNTVRATGGRNHYRHLIVQAYNTDVAKAVAHFTMPLDIVQNRIFLECHYYDPYDFTIMPNDENFKSQWGAAFAGGDVSATGQEGDIEATLSSLNVFINNNVPVIIGEYGPTLRDQLTGEALENHLKSRNDYIEYVVKTCVKNKLVPLYWDAGYTEKLFDRTTGQPHNAASIAAIMKGLN

SEQ ID NO: 9 - protein, 838 aa, Trichoderma reesei
MKVSRVLALVLGAVIPAHAAFSWKNVKLGGGGGFVPGIIFHPKTKGVAYARTDIGGLYRLNADDSWTAVTDGIADNAGWHNWGIDAVALDPQDDQKVYAAVGMYTNSWDPSNGAIIRSSDRGATWSFTNLPFKVGGNMPGRGAGERLAVDPANSNIIYFGARSGNGLWKSTDGGVTFSKVSSFTATGTYIPDPSDSNGYNSDKQGLMWVTFDSTSSTTGGATSRIFVGTADNITASVYVSTNAGSTWSAVPGQPGKYFPHKAKLQPAEKALYLTYSDGTGPYDGTLGSVWRYDIAGGTWKDITPVSGSDLYFGFGGLGLDLQKPGTLVVASLNSWWPDAQLFRSTDSGTTWSPIWAWASYPTETYYYSISTPKAPWIKNNFIDVTSESPSDGLIKRLGWMIESLEIDPTDSNHWLYGTGMTIFGGHDLTNWDTRHNVSIQSLADGIEEFSVQDLASAPGGSELLAAVGDDNGFTFASRNDLGTSPQTVWATPTWATSTSVDYAGNSVKSVVRVGNTAGTQQVAISSDGGATWSIDYAADTSMNGGTVAYSADGDTILWSTASSGVQRSQFQGSFASVSSLPAGAVIASDKKTNSVFYAGSGSTFYVSKDTGSSFTRGPKLGSAGTIRDIAAHPTTAGTLYVSTDVGIFRSTDSGTTFGQVSTALTNTYQIALGVGSGSNWNLYAFGTGPSGARLYASGDSGASWTDIQGSQGFGSIDSTKVAGSGSTAGQVYVGTNGRGVFYAQGTVGGGTGGTSSSTKQSSSSTSSASSSTTLRSSVVSTTRASTVTSSRTSSAAGPTGSGVAGHYAQCGGIGWTGPTQCVAPYVCQKQNDYYYQCV

SEQ ID NO: 10 - protein, 513 aa, Trichoderma reesei
MYRKLAVISAFLATARAQSACTLQSETHPPLTWQKCSSGGTCTQQTGSVVIDANWRWTHATNSSTNCYDGNTWSSTLCPDNETCAKNCCLDGAAYASTYGVTTSGNSLSIGFVTQSAQKNVGARLYLMASDTTYQEFTLLGNEFSFDVDVSQLPCGLNGALYFVSMDADGGVSKYPTNTAGAKYGTGYCDSQCPRDLKFINGQANVEGWEPSSNNANTGIGGHGSCCSEMDIWEANSISEALTPHPCTTVGQEICEGDGCGGTYSDNRYGGTCDPDGCDWNPYRLGNTSFYGPGSSFTLDTTKKLTVVTQFETSGAINRYYVQNGVTFQQPNAELGSYSGNELNDDYCTAEEAEFGGSSFSDKGGLTQFKKATSGGMVLVMSLWDDYYANMLWLDSTYPTNETSSTPGAVRGSCSTSSGVPAQVESQSPNAKVTFSNIKFGPIGSTGNPSGGNPPGGNRGTTTTRRPATTTGSSPGPTQSHYGQCGGIGYSGPTVCASGTTCQVLNPYYSQCL

SEQ ID NO: 11 - protein, 471 aa, Trichoderma reesei
MIVGILTTLATLATLAASVPLEERQACSSVWGQCGGQNWSGPTCCASGSTCVYSNDYYSQCLPGAASSSSSTRAASTTSRVSPTTSRSSSATPPPGSTTTRVPPVGSGTATYSGNPFVGVTPWANAYYASEVSSLAIPSLTGAMATAAAAVAKVPSFMWLDTLDKTPLMEQTLADIRTANKNGGNYAGQFVVYDLPDRDCAALASNGEYSIADGGVAKYKNYIDTIRQIVVEYSDIRTLLVIEPDSLANLVTNLGTPKCANAQSAYLECINYAVTQLNLPNVAMYLDAGHAGWLGWPANQDPAAQLFANVYKNASSPRALRGLATNVANYNGWNITSPPSYTQGNAVYNEKLYIHAIGPLLANHGWSNAFFITDQGRSGKQPTGQQQWGDWCNVIGTGFGIRPSANTGDSLLDSFVWVKPGGECDGTSDSSAPRFDSHCALPDALQPAPQAGAWFQAYFVQLLTNANPSFL

SEQ ID NO: 12 - protein, 239 aa, Aspergillus niger
MKLPVTLAMLAATAMGQTMCSQYDSASSPPYSVNQNLWGEYQGTGSQCVYVDKLSSSGASWHTEWTWSGGEGTVKSYSNSGVTFNKKLVSDVSSIPTSVEWKQDNTNVNADVAYDLFTAANVDHATSSGDYELMIWLARYGNIQPIGKQIATATVGGKSWEVWYGSTTQAGAEQRTYSFVSESPINSYSGDINAFFSYLTQNQGFPASSQYLINLQFGTEAFTGGPATFTVDNWTASVN

SEQ ID NO: 13 - protein, 416 aa, Aspergillus niger
MRISNLIVAASAASMVSALPSRQMKKRDSGFKWVGTSESGAEFGSALPGTLGTDYTWPETSKIQVLRNKGMNIFRIPFLMERLTPDGLTSSFASTYLSDLKSTVEFVTNSGAYAVLDPHNYGRFDGSIITSTSDFKTWWKNVATEFADNDKVIFDTNNEYHDMEQSLVLDLNQAAINGIRAAGATTQYIFVEGNAYTGAWDWTTYNDNLSGLTDSEDKIIYEMHQYLDSDSSGTSETCVSSTIGQERLEKATEWLKTNNKQGIVGEFAGGVNSVCEEAVEGMLAYMSENSDVWVGASWWSAGPWWGTYMYSLEPTDGTAYSTYLPILEKYFPSGDASASSSASVSVAAATSTASTTTAAFEQTTTPATQGPSATNSAGEVNQYYQCGGINWTGPTVCASPYTCKVQNDYYYQCVAE

SEQ ID NO: 14 - protein, 331 aa, Aspergillus niger
MKFQSTLLLAAAAGSALAVPHGSGHKKRASVFEWFGSNESGAEFGTNIPGVWGTDYIFPDPSTISTLIGKGMNFFRVQFMMERLLPDSMTGSYDEEYLANLTTVVKAVTDGGAHALIDPHNYGRYNGEIISSTSDFQTFWQNLAGQYKDNDLVMFDTNNEYYDMDQDLVLNLNQAAINGIRAAGASQYIFVEGNSWTGAWTWVDVNDNMKNLTDPEDKIVYEMHQYLDSDGSGTSETCVSGTIGKERITDATQWLKDNKKVGFIGEYAGGSNDVCRSAVSGMLEYMANNTDVWKGASWWAAGPWWGDYIFSLEPPDGTAYTGMLDILETYL

SEQ ID NO: 15 - protein, 465 aa, Trichoderma reesei
MKSSISVVLALLGHSAAWSYATKSQYRANIKINARQTYQTMIGGGCSGAFGIACQQFGSSGLSPENQQKVTQILFDENIGGLSIVRNDIGSSPGTTILPTCPATPQDKFDYVWDGSDNCQFNLTKTALKYNPNLYVYADAWSAPGCMKTVGTENLGGQICGVRGTDCKHDWRQAYADYLVQYVRFYKEEGIDISLLGAWNEPDFNPFTYESMLSDGYQAKDFLEVLYPTLKKAFPKVDVSCCDATGARQERNILYELQQAGGERYFDIATWHNYQSNPERPFNAGGKPNIQTEWADGTGPWNSTWDYSGQLAEGLQWALYMHNAFVNSDTSGYTHWWCAQNTNGDNALIRLDRDSYEVSARLWAFAQYFRFARPGSVRIGATSDVENVYVTAYVNKNGTVAIPVINAAHFPYDLTIDLEGIKKRKLSEYLTDNSHNVTLQSRYKVSGSSLKVTVEPRAMKTFWLE

SEQ ID NO: 16 - protein, 211 aa, Aspergillus niger
MKVTAAFAGLLVTAFAAPVPEPVLVSRSAGINYVQNYNGNLGDFTYDESAGTFSMYWEDGVSSDFVVGLGWTTGSSKAITYSAEYSASGSSSYLAVYGWVNYPQAEYYIVEDYGDYNPCSSATSLGTVYSDGSTYQVCTDTRTNEPSITGTSTFTQYFSVRESTRTSGTVTVANHFNFWAQHGFGNSDFNYQVMAVEAWSGAGSASVTISS

SEQ ID NO: 17 - protein, 437 aa, Trichoderma reesei
MMMLSKSLLSAATAASALAAVLQPVPRASSFVTISGTQFNIDGKVGYFAGTNCYWCSFLTNHADVDSTFSHISSSGLKVVRVWGFNDVNTQPSPGQIWFQKLSATGSTINTGADGLQTLDYVVQSAEQHNLKLIIPFVNNWSDYGGINAYVNAFGGNATTWYTNTAAQTQYRKYVQAVVSRYANSTAIFAWELGNEPRCNGCSTDVIVQWATSVSQYVKSLDSNHLVTLGDEGLGLSTGDGAYPYTYGEGTDFAKNVQIKSLDFGTFHLYPDSWGTNYTWGNGWIQTHAAACLAAGKPCVFEEYGAQQNPCTNEAPWQTTSLTTRGMGGDMFWQWGDTFANGAQSNSDPYTVWYNSSNWQCLVKNHVDAINGGTTTPPPVSSTTTTSSRTSSTPPPPGGSCSPLYGQCGGSGYTGPTCCAQGTCIYSNYWYSQCLNT

SEQ ID NO: 18 - protein, 335 aa, Aspergillus niger
MFAKLSLLSLLFSSAALGASNQTLSYGNIDKSATPEARALLKYIQLQYGSHYISGQQDIDSWNWVEKNIGVAPAILGSDFTYYSPSAVAHGGKSHAVEDVIQHAGRNGINALVWHWYAPTCLLDTAKEPWYKGFYTEATCFNVSEAVNDHGNGTNYKLLLRDIDAIAAQIKRLDQAKVPILFRPLHEPEGGWFWWGAQGPAPFKKLWDILYDRITRYHNLHNMVWVCNTADPAWYPGNDKCDIATIDHYPAVGDHGVAADQYKKLQTVTNNERVLAMAEVGPIPDPDKQARENVNWAYWMVWSGDFIEDGKQNPNQFLHKVYNDTRVVALNWEGA

SEQ ID NO: 19 - protein, 383 aa, Aspergillus niger
MKLSNALLTLASLALANVSTALPKASPAPSTSSSAASTSFASTSGLQFTIDGETGYFAGTNSYWIGFLTDNADVDLVMGHLKSSGLKILRVWGFNDVTSQPSSGTVWYQLHQDGKSTINTGADGLQRLDYVVSSAEQHDIKLIINFVNYWTDYGGMSAYVSAYGGSGETDFYTSDTMQSAYQTYIKTVVERYSNSSAVFAWELANEPRCPSCDTSVLYNWIEKTSKFIKGLDADRMVCIGDEGFGLNIDSDGSYPYQFSEGLNFTMNLGIDTIDFGTLHLYPDSWGTSDDWGNGWITAHGAACKAAGKPCLLEEYGVTSNHCSVEGSWQKTALSTTGVGADLFWQYGDDLSTGKSPDDGNTIYYGTSDYQCLVTDHVAAIGSA

SEQ ID NO: 20 - protein, 452 aa, Aspergillus niger
MHQRALLFSALLTAVRAQQAGTLTEEVHPSLTWQKCTSEGSCTEQSGSVVIDSNWRWTHSVNDSTNCYTGNTWDATLCPDDETCAANCALDGADYESTYGVTTDGDSLTLKFVTGSNVGSRLYLMDTSDEGYQTFNLLDAEFTFDVDVSNLPCGLNGALYFTAMDADGGVSKYPANKAGAKYGTGYCDSQCPRDLKFIDGQANVDGWEPSSNNDNTGIGNHGSCCPEMDIWEANKISTALTPHPCDSSEQTMCEGNDCGGTYSDDRYGGTCDPDGCDFNPYRMGNDSFYGPGKTIDTGSKMTVVTQFITDGSGSLSEIKRYYVQNGNVIANADSNISGVTGNSITTDFCTAQKKAFGDEDIFAEHNGLAGISDAMSSMVLILSLWDDYYASMEWLDSDYPENATATDPGVARGTCDSESGVPATVEGAHPDSSVTFSNIKFGPINSTFSASA

SEQ ID NO: 21 - protein, 536 aa, Aspergillus niger
MSSFQIYRAALLLSILATANAQQVGTYTTETHPSLTWQTCTSDGSCTTNDGEVVIDANWRWVHSTSSATNCYTGNEWDTSICTDDVTCAANCALDGATYEATYGVTTSGSELRLNFVTQGSSKNIGSRLYLMSDDSNYELFKLLGQEFTFDVDVSNLPCGLNGALYFVAMDADGGTSEYSGNKAGAKYGTGYCDSQCPRDLKFINGEANCDGWEPSSNNVNTGVGDHGSCCAEMDVWEANSISNAFTAHPCDSVSQTMCDGDSCGGTYSASGDRYSGTCDPDGCDYNPYRLGNTDFYGPGLTVDTNSPFTVVTQFITDDGTSSGTLTEIKRLYVQNGEVIANGASTYSSVNGSSITSAFCESEKTLFGDENVFDKHGGLEGMGEAMAKGMVLVLSLWDDYAADMLWLDSDYPVNSSASTPGVARGTCSTDSGVPATVEAESPNAYVTYSNIKFGPIGSTYSSGSSSGSGSSSSSSSTTTKATSTTLKTTSTTSSGSSSTSAAQAYGQCGGQGWTGPTTCVSGYTCTYENAYYSQCL

SEQ ID NO: 22 - protein, 744 aa, Trichoderma reesei
MRYRTAAALALATGPFARADSHSTSGASAEAVVPPAGTPWGTAYDKAKAALAKLNLQDKVGIVSGVGWNGGPCVGNTSPASKISYPSLCLQDGPLGVRYSTGSTAFTPGVQAASTWDVNLIRERGQFIGEEVKASGIHVILGPVAGPLGKTPQGGRNWEGFGVDPYLTGIAMGQTINGIQSVGVQATAKHYILNEQELNRETISSNPDDRTLHELYTWPFADAVQANVASVMCSYNKVNTTWACEDQYTLQTVLKDQLGFPGYVMTDWNAQHTTVQSANSGLDMSMPGTDFNGNNRLWGPALTNAVNSNQVPTSRVDDMVTRILAAWYLTGQDQAGYPSFNISRNVQGNHKTNVRAIARDGIVLLKNDANILPLKKPASIAVVGSAAIIGNHARNSPSCNDKGCDDGALGMGWGSGAVNYPYFVAPYDAINTRASSQGTQVTLSNTDNTSSGASAARGKDVAIVFITADSGEGYITVEGNAGDRNNLDPWHNGNALVQAVAGANSNVIVVVHSVGAIILEQILALPQVKAVVWAGLPSQESGNALVDVLWGDVSPSGKLVYTIAKSPNDYNTRIVSGGSDSFSEGLFIDYKHFDDANITPRYEFGYGLSYTKFNYSRLSVLSTAKSGPATGAVVPGGPSDLFQNVATVTVDIANSGQVTGAEVAQLYITYPSSAPRTPPKQLRGFAKLNLTPGQSGTATFNIRRRDLSYWDTASQKWVVPSGSFGISVGASSRDIRLTSTLSVA

SEQ ID NO: 23 - protein, 797 aa, Trichoderma reesei
MVNNAALLAALSALLPTALAQNNQTYANYSAQGQPDLYPETLATLTLSFPDCEHGPLKNNLVCDSSAGYVERAQALISLFTLEELILNTQNSGPGVPRLGLPNYQVWNEALHGLDRANFATKGGQFEWATSFPMPILTTAALNRTLIHQIADIISTQARAFSNSGRYGLDVYAPNVNGFRSPLWGRGQETPGEDAFFLSSAYTYEYITGIQGGVDPEHLKVAATVKHFAGYDLENWNNQSRLGFDAIITQQDLSEYYTPQFLAAARYAKSRSLMCAYNSVNGVPSCANSFFLQTLLRESWGFPEWGYVSSDCDAVYNVFNPHDYASNQSSAAASSLRAGTDIDCGQTYPWHLNESFVAGEVSRGEIERSVTRLYANLVRLGYFDKKNQYRSLGWKDVVKTDAWNISYEAAVEGIVLLKNDGTLPLSKKVRSIALIGPWANATTQMQGNYYGPAPYLISPLEAAKKAGYHVNFELGTEIAGNSTTGFAKAIAAAKKSDAIIYLGGIDNTIEQEGADRTDIAWPGNQLDLIKQLSEVGKPLVVLQMGGGQVDSSSLKSNKKVNSLVWGGYPGQSGGVALFDILSGKRAPAGRLVTTQYPAEYVHQFPQNDMNLRPDGKSNPGQTYIWYTGKPVYEFGSGLFYTTFKETLASHPKSLKFNTSSILSAPHPGYTYSEQIPVFTFEANIKNSGKTESPYTAMLFVRTSNAGPAPYPNKWLVGFDRLADIKPGHSSKLSIPIPVSALARVDSHGNRIVYPGKYELALNTDESVKLEFELVGEEVTIENWPLEEQQIKDATPDA

SEQ ID NO: 24 - protein, 917 aa, Trichoderma reesei
  VAR_SEQ 511: note = any amino acid
MARHSIQLDKGWTFRQHQGSSPEWLPVEKVPTQVHMDLLANKQIPDPFVDLNERAVQWIGYKDWEYQVTFTPEAAQVEDATRDLVFNGLDTFATVYLNEAKILEAENMFVSYRVNVTDRIKASSENTLRIVFHSAIVRGEELIKEHPEHNFLVRQTERSRVPVRKAQYNWGWDWGPILMTAGPWKPVALETYVARIDDVWAQSDVSQDLKTVSGIIFARVAGRPSQDDQVSLTLSLDGKAVFQQTVDVASAKDGLIKVPFKLEDPKLWYPRGYGSQPRYQLNADLARKASDASQIDSLSKLVGFRRAELVQEPDAFGKSFYFRINNVDVFAGGSCWIPADSYLAGVPPERYHAWAKLIADGNQVMLRVWGGGVYEEDALIEACDELGILVFHDFQFACASYPAYPSYLENLEVEARQQIRRLRTHPSVIIWAGNNEDYQVQERYKLDYEFENKDPESWLKSSFPARYIYEHFLPKLVEEEDPGKIYHPSSPWGDGKPTADPTVGDIHQWNXPPPPISTQITHTQHPTDHPLHTVWHGTMNKYQEAVNMGGRFVSEFGMEAYPHLSTTRRMASDPAQLYPGSMVLDAHNKAIGHERRMMSYVVDNFRPRHDLGGYTHLTQVVQSETMRAAYKAWRRQWGKPGARRCGGALVWQLNDCWPTMSWAVVDYRLVKKPAYYAIARALRRVDVGVCRTWHDWTQTGAWVDENSGLVTGQVDHTLAAREGTFDVWVVSSDTQPVALDLVVRFISVRTGRDVVDPILHSRVVAAANSATDILQGKTLPPSIPNPEDITKPFPLAEYDPYVVHATITDAATGTVIAADTAWPEPIKYLDLSDRGIAFEVSSAGDEVVVSAEKPVKGFVFEEVEGLELSDNGFDVVPGEKQLVKVGGALKAGELLWTCIGADSASLKIEASSSLAPR

SEQ ID NO: 25 - protein, 344 aa, Trichoderma reesei
MIQKLSNLLVTALAVATGVVGHGHINDIVINGVWYQAYDPTTFPYESNPPIVVGWTAADLDNGFVSPDAYQNPDIICHKNATNAKGHASVKAGDTILFQWVPVPWPHPGPIVDYLANCNGDCETVDKTTLEFFKIDGVGLLSGGDPGTWASDVLISNNNTWVVKIPDNLAPGNYVLRHEIIALHSAGQANGAQNYPQCFNIAVSGSGSLQPSGVLGTDLYHATDPGVLINIYTSPLNYIIPGPTVVSGLPTSVAQGSSAATATASATVPGGGSGPTSRTTTTARTTQASSRPSSTPPATTSAPAGGPTQTLYGQCGGSGYSGPTRCAPPATCSTLNPYYAQCLN